(19) United States
(12) Patent Application Publication
(10) Pub. No.: US 2023/0356459 A1
(43) Pub. Date: Nov. 9, 2023

(54) ADDITIVE MANUFACTURING APPARATUS, SYSTEM, AND METHOD

(71) Applicant: Paxis, LLC, Crystal Lake, IL (US)

(72) Inventors: Frederick Knecht, Woodstock, IL (US); Michael G. Littrell, Crystal Lake, IL (US)

(21) Appl. No.: 18/143,837

(22) Filed: May 5, 2023

Related U.S. Application Data
(60) Provisional application No. 63/364,240, filed on May 5, 2022.

(51) Int. Cl. B29C 64/129; B29C 64/264; B29C 64/218; B33Y 30/00

(52) U.S. Cl. CPC B29C 64/129; B29C 64/264; B29C 64/218; B33Y 30/00

(57) ABSTRACT

A deposition mechanism is usable for producing a three-dimensional object on a build platform using a resin in a layer-by-layer technique. The deposition mechanism includes a carriage moveable through the build area, a supply of the resin in flowable form mounted on the carriage, and a carrying surface configured for moving to carry the resin from the supply to an application site within the build area for application to produce the object. A flexible screen is configured for emitting electromagnetic waves to solidify the resin. In one configuration, the flexible screen is positioned below the carrying surface, such that the carrying surface overlays the flexible screen and the flexible screen and the carrying surface have conforming shapes, and the carrying surface is permeable to the electromagnetic waves. In another configuration, the carrying surface includes the flexible screen, and an outer surface of the flexible screen carries the resin.

### CROSS-REFERENCE TO RELATED APPLICATIONS

This application is a non-provisional of, and claims priority to, U.S. Provisional Application No. 63/364,240, filed May 5, 2022, which prior application is incorporated herein by reference in its entirety.

### TECHNICAL FIELD

The present disclosure generally relates to an apparatus and system for producing a three-dimensional object in an additive manufacturing technique and method for operating the apparatus and system, and more specifically, to an apparatus, system, and method that uses a roller in contact with a flowable resin or other precursor material in building each layer of the object.

### BACKGROUND

Current techniques for additive manufacturing of three-dimensional objects (e.g., stereolithography, 3-D printing, etc.) can produce excellent quality products with high fidelity, but such techniques have significant limitations. Typically, such techniques work in one of three ways: (a) continually polymerizing layers at or near the surface of liquid resin contained in a stationary vat, (b) continually polymerizing layers of resin at or near the bottom of a stationary vat of resin, or (c) continually polymerizing layers of resin that has been jetted downward by one or more single-nozzle or multi-nozzle print heads. Such techniques are generally limited to small sizes, with maximum sizes for various machines being only a few feet in width or length or even smaller. This limits the size of objects that can be produced. Jet-based processes have significant size limitations and waste a great deal of resin material during production.

Vat-based techniques require that the object is partially or fully submerged during manufacturing, thus requiring the vat of resin to be maintained at a significant volume. This can be costly, as such resins are typically very expensive, and maintenance of resin vats in a collection of machines can be extremely costly. The size of the vat also limits the size of the object that can be produced, as noted above. Additionally, submersion of the object during production often results in cavities within the object being filled with uncured liquid resin, which must be drained, often requiring drilling a drainage hole and subsequent repair. Further, the vat generally only contains a single resin, so manufacture of multi-material parts is not possible. Vat-based techniques have production speed limitations as well, due to wait times for new resin to flow over or under the areas to be polymerized.

The present disclosure seeks to overcome certain of these limitations and other drawbacks of existing apparatuses, systems, and methods, and to provide new features not heretofore available.

### BRIEF SUMMARY

Aspects of the disclosure relate to a deposition mechanism configured for producing a three-dimensional object on a build platform using a resin in a layer-by-layer technique, with a build area defined adjacent to the build platform. The deposition mechanism includes a carriage configured for movement through the build area, a supply of the resin in flowable form mounted on the carriage, a carrying surface configured for moving to carry the resin from the supply to an application site within the build area for application to produce the three-dimensional object as the carriage passes through the build area, and a flexible screen positioned below the carrying surface, such that the carrying surface overlays the flexible screen. The flexible screen and the carrying surface have conforming shapes, and the flexible screen is configured for emitting electromagnetic waves. The carrying surface is permeable to the electromagnetic waves to permit the electromagnetic waves to at least partially solidify the resin applied by the carrying surface to produce the three-dimensional object.

According to one aspect, the carrying surface is a roller having a circular outer surface and configured to rotate to carry the resin from the supply to the application site. In one configuration, the flexible screen is positioned within the roller and extends around a portion of an inner circumference of the roller.

According to another aspect, the flexible screen is configured for emitting the electromagnetic waves to form an image that travels along the flexible screen at a speed of movement of the carrying surface, to continuously expose a portion of the resin on the carrying surface for at least part of a distance between the supply and the application site. In one configuration, the flexible screen is configured for continuously exposing the portion of the resin on the carrying surface for an entirety of the distance between the supply and the application site. In another configuration, the flexible screen is configured for varying a power of the electromagnetic waves forming the image as the image approaches the application site.

According to a further aspect, the carrying surface is a film configured to move along a loop through the build area. The flexible screen is positioned on a static surface located adjacent to the application site, and the film passes over the flexible screen at the application site.

Additional aspects of the disclosure relate to a deposition mechanism configured for producing a three-dimensional object on a build platform using a resin in a layer-by-layer technique, with a build area defined adjacent to the build platform. The deposition mechanism includes a carriage configured for movement through the build area, a supply of the resin in flowable form mounted on the carriage, and a carrying surface including a flexible screen configured for moving to carry the resin on an outer surface of the flexible screen from the supply to an application site within the build area for application to produce the three-dimensional object as the carriage passes through the build area. The flexible screen is configured for emitting electromagnetic waves to at least partially solidify the resin applied by the carrying surface to produce the three-dimensional object.

According to one aspect, the carrying surface is a roller having a cylindrical shape and configured to rotate to carry the resin from the supply to the application site. In one configuration, the carrying surface further includes a plurality of flexible screens, including the flexible screen, positioned around a circumference of the roller. The outer surfaces of the plurality of flexible screens combine to form the carrying surface, and each of the flexible screens is configured for emitting electromagnetic waves to at least partially solidify the resin applied by the carrying surface to produce the three-dimensional object. The flexible screens may be arranged end-to-end around the carrying surface in this configuration. In another configuration, the mechanism also includes a rotatable cylinder, and the flexible screen is mounted on the rotatable cylinder and conforms to an external shape of the rotatable cylinder.

According to another aspect, the flexible screen is configured for emitting the electromagnetic waves to form an image that is static on the flexible screen as the outer surface of the flexible screen carries the resin to the application site, to continuously expose a portion of the resin on the outer surface for at least part of a distance between the supply and the application site. In one configuration, the flexible screen is configured for continuously exposing the portion of the resin on the carrying surface for an entirety of the distance between the supply and the application site. In another configuration, the flexible screen is configured for varying a power of the electromagnetic waves forming the image as the image approaches the application site.

According to a further aspect, the carrying surface is a belt configured to move along a loop through the build area.

According to yet another aspect, the carrying surface is a roller having a polygonal shape with at least three substantially flat sides, and the roller is configured to rotate to carry the resin from the supply to the application site.

According to a still further aspect, the flexible screen has a thin coating on the outer surface thereof, the thin coating adding a functional property to the carrying surface.

Further aspects of the disclosure relate to an applicator configured for applying a resin to produce a three-dimensional object on a build platform in a layer-by-layer technique, with a build area defined adjacent to the build platform. The applicator includes a carrying surface configured to be in communication with a supply of the resin, the carrying surface including a flexible screen configured for moving to carry the resin on an outer surface of the flexible screen from the supply to an application site within the build area for application to produce the three-dimensional object. The flexible screen is configured for emitting electromagnetic waves to at least partially solidify the resin applied by the carrying surface to produce the three-dimensional object. The applicator may further include a rotatable support, where the flexible screen is mounted on the rotatable support and is configured to rotate with the rotatable support to carry the resin from the supply to the application site.

Still further aspects of the disclosure relate to an applicator configured for applying a resin to produce a three-dimensional object on a build platform in a layer-by-layer technique, with a build area defined adjacent to the build platform. The applicator includes a carrying surface configured to be in communication with a supply of the resin and configured for moving to carry the resin from the supply to an application site within the build area for application to produce the three-dimensional object, and a flexible screen positioned below the carrying surface, such that the carrying surface overlays the flexible screen, and the flexible screen and the carrying surface have conforming shapes. The flexible screen is configured for emitting electromagnetic waves, and the carrying surface is permeable to the electromagnetic waves to permit the electromagnetic waves to at least partially solidify the resin applied by the carrying surface to produce the three-dimensional object.

Other aspects of the disclosure relate to a method of using a deposition mechanism or an applicator as described above to produce a three-dimensional object in a layer-by-layer technique. Such a method includes moving the carrying surface to apply the resin and solidifying the resin by emitting electromagnetic waves from the flexible screen.

Other features and advantages of the disclosure will be apparent from the following description taken in conjunction with the attached drawings.

### BRIEF DESCRIPTION OF THE DRAWINGS

To understand the present invention, it will now be described by way of example, with reference to the accompanying drawings in which:

FIG. 1 is a side schematic view of one embodiment of a system and apparatus for producing a three-dimensional object in operation, according to aspects of the disclosure;

FIGS. 2A and 2B are top schematic views of the system and apparatus of FIG. 1 in operation, according to aspects of the present disclosure;

FIGS. 3A and 3B are side schematic views of the system and apparatus of FIG. 1 in operation, according to aspects of the present disclosure;

FIG. 4 is a side schematic view of the apparatus of FIG. 1, further including a secondary exposure device;

FIG. 5 is a schematic view of a controller according to aspects of the disclosure;

FIG. 6 is a perspective view of another embodiment of an apparatus for producing a three-dimensional object in operation, according to aspects of the disclosure;

FIG. 7 is a perspective view illustrating removal of a resin application module from the apparatus of FIG. 6;

FIG. 8 is a perspective view of the apparatus of FIG. 6, showing vertical adjustment of a deposition mechanism of the apparatus to a new vertical application location;

FIG. 9 is a perspective view of a support assembly of the apparatus of FIG. 6, showing movement of a build platform from a build position to a tending position;

FIG. 10 is a perspective view of a support assembly of the apparatus of FIG. 6, showing the build platform in the tending position;

FIG. 11 is a perspective view of the apparatus of FIG. 6 illustrating performance of a tending operation when the build platform is in the tending position;

FIG. 12 is a perspective view of the apparatus of FIG. 6 illustrating further production of objects when the build platform is in the build position, after performance of the tending operation in FIG. 36;

FIG. 13 is a side view of the apparatus of FIG. 6 with multiple deposition mechanisms operating simultaneously;

FIG. 14 is a plan schematic view of one embodiment of an exposure device for use in connection with an apparatus for producing a three-dimensional object in operation, according to aspects of the disclosure;

FIG. 15 is a plan schematic view of another embodiment of an exposure device for use in connection with an apparatus for producing a three-dimensional object in operation, according to aspects of the disclosure;

FIG. 16 is a plan schematic view of another embodiment of an exposure device for use in connection with an apparatus for producing a three-dimensional object in operation, according to aspects of the disclosure;

FIG. 17 is a plan schematic view of another embodiment of an exposure device for use in connection with an apparatus for producing a three-dimensional object in operation, according to aspects of the disclosure;

FIG. 18 is a side schematic view of another embodiment of an exposure device and an applicator for use in connection with an apparatus for producing a three-dimensional object in operation, according to aspects of the disclosure;

FIG. 19 is a side schematic view illustrating one embodiment of operation of the exposure device and applicator of FIG. 18 in connection with an apparatus for producing a three-dimensional object in operation, according to aspects of the disclosure;

FIG. 20 is a side schematic view illustrating another embodiment of operation of the exposure device and applicator of FIG. 18 in connection with an apparatus for producing a three-dimensional object in operation, according to aspects of the disclosure;

FIG. 21 is a side schematic view of another embodiment of a system and apparatus for producing a three-dimensional object in operation, according to aspects of the disclosure;

FIG. 22 is a side schematic view of a portion of the system and apparatus of FIG. 21 including temperature regulation elements, according to aspects of the disclosure;

FIG. 23 is a side schematic view of another embodiment of a system and apparatus for producing a three-dimensional object in operation, according to aspects of the disclosure;

FIG. 24 is a side schematic view of another embodiment of a system and apparatus for producing a three-dimensional object in operation, according to aspects of the disclosure;

FIG. 25 is a side schematic view of another embodiment of a system and apparatus for producing a three-dimensional object in operation, according to aspects of the disclosure;

FIG. 26 is a side schematic view of a portion of the system and apparatus of FIG. 25 including temperature regulation elements, according to aspects of the disclosure;

FIG. 27 is a perspective view of the apparatus of FIG. 26, showing vertical adjustment of the support assembly of the apparatus to a new vertical application location and operation of the deposition mechanism to produce the three-dimensional object;

FIG. 28 is a side schematic view of another embodiment of a system and apparatus for producing a three-dimensional object in operation, according to aspects of the disclosure;

FIG. 29 is a side schematic view of another embodiment of an apparatus for producing a three-dimensional object, according to aspects of the disclosure;

FIG. 30 is a side schematic view of the apparatus of FIG. 29 shown in operation;

FIG. 31 is a partially broken away perspective view of a portion of one embodiment of the apparatus of FIGS. 29-30, according to aspects of the disclosure;

FIG. 32 is a partially broken away perspective view of a portion of the apparatus of FIG. 31;

FIG. 32A is a schematic cross-section view of a portion of one embodiment of a plurality of circuit boards and a supporting structure for use in the apparatus of FIGS. 31-32, according to aspects of the disclosure;

FIG. 32B is a schematic cross-section view of a portion of another embodiment of a plurality of circuit boards and a supporting structure for use in the apparatus of FIGS. 31-32, according to aspects of the disclosure;

FIG. 33 is a schematic cross-section view of one embodiment of a body of a lens mounting structure, a plurality of ball lenses, and a plurality of optical fibers of the apparatus of FIGS. 31-32, according to aspects of the disclosure;

FIG. 34 is a schematic cross-section view of one embodiment of a ball lens and a plurality of optical fibers emitting waves that are focused by the ball lens of the apparatus of FIGS. 31-32, according to aspects of the disclosure;

FIG. 35 is a plan view of a portion of another embodiment of a plurality ball lenses and optical fibers connected to arrays of LEDs, for use with the apparatus of FIGS. 29-30, according to aspects of the disclosure;

FIG. 36 is a partially schematic perspective view of the optical fibers, ball lenses, and LED arrays of FIG. 35, with the ball lenses focusing waves emitted by the LEDs via the optical fibers, positioned inside a roller of an apparatus for producing a three-dimensional object, according to aspects of the disclosure;

FIG. 37 is a partially schematic perspective view of the optical fibers, ball lenses, and roller of FIG. 36, with the ball lenses focusing waves emitted from the optical fibers;

FIG. 38 is a side schematic view of another embodiment of an apparatus for producing a three-dimensional object, according to aspects of the disclosure;

FIG. 39 is a side schematic view of the apparatus of FIG. 38 shown in operation;

FIG. 40 is a perspective view of a portion of a deposition mechanism of one embodiment of the apparatus of FIGS. 38-39, according to aspects of the disclosure;

FIG. 41 is a perspective view of the deposition mechanism of FIG. 40, with a portion of the deposition mechanism removed to reveal internal detail;

FIG. 42 is a partially broken away perspective view of an exposure assembly and a roller of the deposition mechanism of FIG. 40, with some internal components removed to reveal detail;

FIG. 43 is a partially broken away perspective view of the exposure assembly of FIG. 42;

FIG. 44 is a cross-sectional view of the roller and the exposure assembly of the deposition mechanism of FIG. 40;

FIG. 45 is a schematic cross-section view of another embodiment of a body of a lens mounting structure, a plurality of ball lenses, and a mirror array, configured for use with an apparatus for producing a three-dimensional object, according to aspects of the disclosure;

FIG. 46 is a schematic cross-section view of another embodiment of a body of a lens mounting structure, a plurality of ball lenses, and an exposure device, configured for use with an apparatus for producing a three-dimensional object, according to aspects of the disclosure;

FIG. 47 is a side schematic view of another embodiment of a system and apparatus for producing a three-dimensional object, according to aspects of the disclosure;

FIG. 48 is a side schematic view of the system and apparatus of FIG. 47, showing interchanging of a reservoir;

FIG. 49 is a side schematic view of another embodiment of a system and apparatus for producing a three-dimensional object, according to aspects of the disclosure;

FIG. 49A is a photograph of a reservoir usable in connection with a system and apparatus as shown in FIGS. 47-49;

FIG. 50A is a side schematic view of another embodiment of a system and apparatus for producing a three-dimensional object, according to aspects of the disclosure;

FIG. 50B is a side schematic view of another embodiment of a system and apparatus for producing a three-dimensional object, according to aspects of the disclosure;

FIG. 51 is a plan schematic view of an applicator and an exposure device of the system and apparatus of FIG. 50A or FIG. 50B in operation, according to aspects of the disclosure;

FIG. 52A is a plan schematic view of an applicator and an exposure device of the system and apparatus of FIG. 50A or FIG. 50B, with an aperture in a first configuration;

FIG. 52B is a plan schematic view of the applicator and the exposure device of FIG. 52A, with the aperture in a second configuration;

FIG. 53 is a side schematic view of another embodiment of a system and apparatus for producing a three-dimensional object, according to aspects of the disclosure;

FIG. 54 is a side schematic view of another embodiment of a system and apparatus for producing a three-dimensional object, according to aspects of the disclosure;

FIG. 55 is a front schematic view of another embodiment of a system and apparatus for producing a three-dimensional object in a first stage of operation, according to aspects of the disclosure;

FIG. 56 is a front schematic view of the system and apparatus of FIG. 55 in a second stage of operation;

FIG. 57 is a side schematic view of another embodiment of an applicator and an exposure device for an apparatus for producing a three-dimensional object, according to aspects of the disclosure;

FIG. 58 is a partially broken-away perspective view of the applicator and the exposure device of FIG. 57 in operation;

FIG. 59 is a partially broken-away perspective view of the applicator and the exposure device of FIG. 57 in operation;

FIG. 60A is a side schematic view of another embodiment of an applicator and an exposure device for an apparatus for producing a three-dimensional object, according to aspects of the disclosure;

FIG. 60B is a side schematic view of another embodiment of an applicator and an exposure device for an apparatus for producing a three-dimensional object, according to aspects of the disclosure;

FIG. 60C is a side schematic view of another embodiment of an applicator and an exposure device for an apparatus for producing a three-dimensional object, according to aspects of the disclosure;

FIG. 60D is a side schematic view of another embodiment of an applicator and an exposure device for an apparatus for producing a three-dimensional object, according to aspects of the disclosure;

FIG. 61 is a side schematic view of another embodiment of a system and apparatus for producing a three-dimensional object, according to aspects of the disclosure;

FIG. 62 is a perspective view of the system and apparatus of FIG. 61 in operation;

FIG. 63 is a perspective view of the system and apparatus of FIG. 61 in operation;

FIG. 64 is a perspective view of the system and apparatus of FIG. 61 in operation;

FIG. 65 is a side schematic view of another embodiment of a system and apparatus for producing a three-dimensional object, according to aspects of the disclosure;

FIG. 66 is a perspective view of the system and apparatus of FIG. 65 in operation;

FIG. 67 is a perspective view of the system and apparatus of FIG. 65 in operation;

FIG. 68 is a side schematic view of another embodiment of a system and apparatus for producing a three-dimensional object, according to aspects of the disclosure;

FIG. 69 is a perspective view of the system and apparatus of FIG. 68 in operation;

FIG. 70 is a perspective view of the system and apparatus of FIG. 68 in operation;

FIG. 71 is a bottom perspective view of the system and apparatus of FIG. 68 in operation;

FIG. 72 is a side schematic view of another embodiment of a system and apparatus for producing a three-dimensional object, according to aspects of the disclosure;

FIG. 73 is a flowchart illustrating one embodiment of a method of producing an object using a deposition mechanism according to aspects of the disclosure; and

FIG. 74 is a schematic view of the system and apparatus of FIG. 1 in one embodiment of a method of operation, according to aspects of the present disclosure.

### DETAILED DESCRIPTION

While this invention is capable of embodiment in many different forms, there are shown in the drawings, and will herein be described in detail, certain embodiments of the invention with the understanding that the present disclosure is to be considered as an example of the principles of the invention and is not intended to limit the broad aspects of the invention to the embodiments illustrated and described.

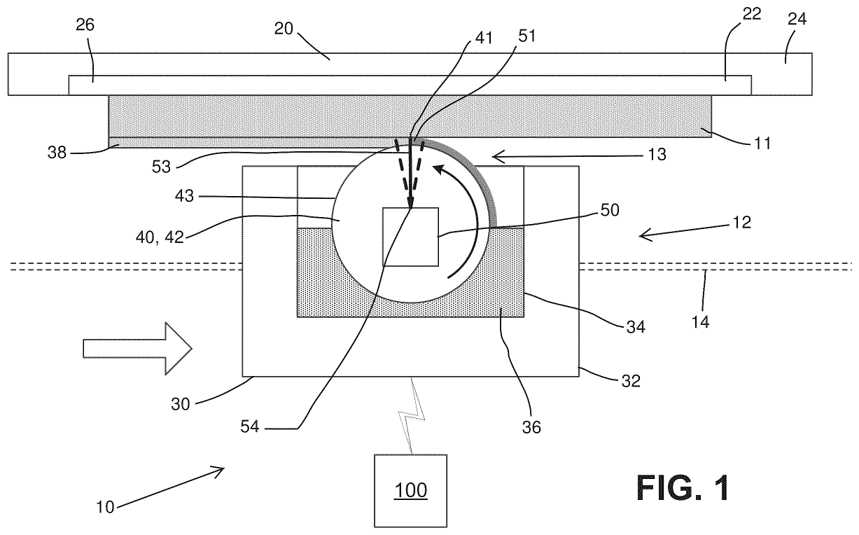

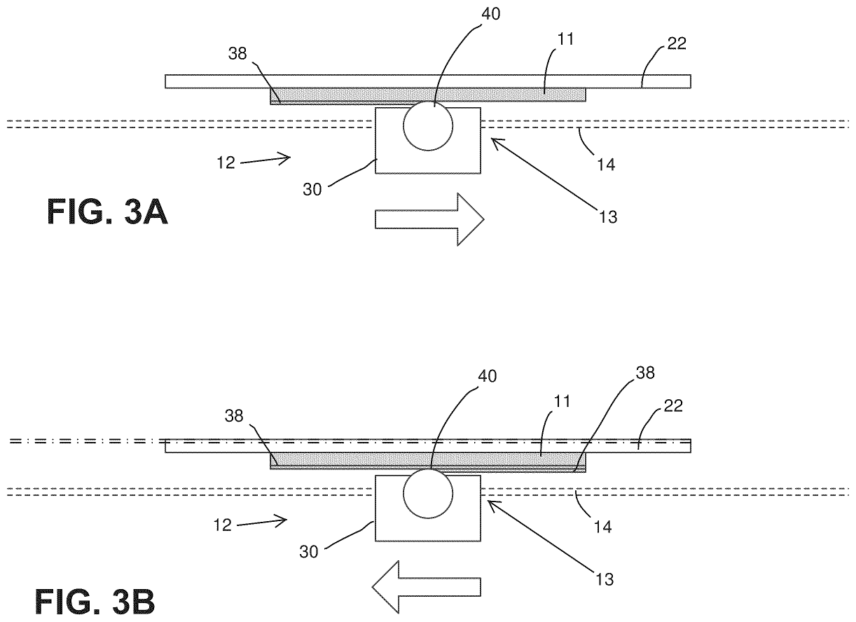

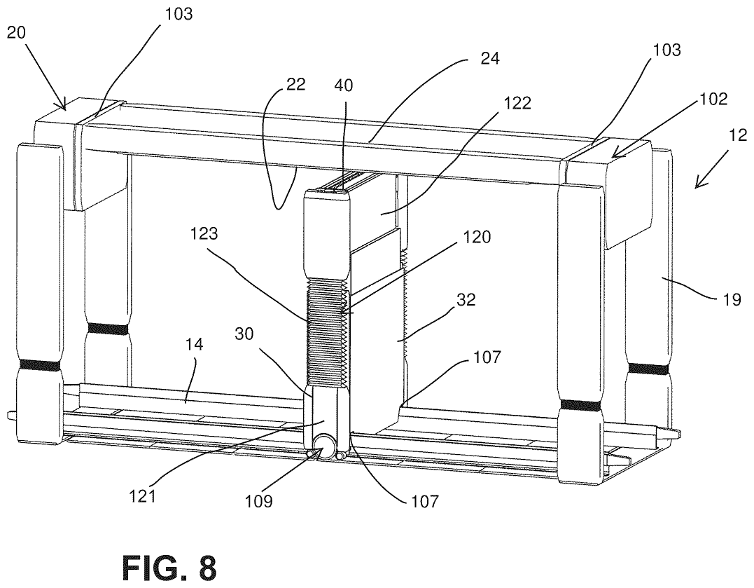

In general, the disclosure relates to systems, apparatuses, and methods for producing three-dimensional objects in a layer-by-layer technique, such as additive manufacturing, 3-D printing, stereolithography, or other rapid prototyping techniques. Referring first to FIG. 1, there is schematically shown an example embodiment of a system 10 that includes a manufacturing apparatus 12 and a computer controller 100 in communication with one or more components of the apparatus 12 and configured for controlling operation of the apparatus 12 and/or the components thereof to manufacture an object 11. The apparatus 12 includes a support assembly 20 for supporting the object 11 within a build area 13 during manufacturing, a track 14 extending through the build area 13, and a material deposition mechanism 30 mounted on the track 14 and configured for producing the object 11 within the build area 13 through layer-by-layer application of a material. The material applied by the deposition mechanism 30 may be any flowable material (e.g., liquids, powders or other particulate solids, and combinations thereof) that are capable of being solidified to manufacture the object 11, such as by polymerization, phase change, sintering, and other techniques or combinations of such techniques. In one example, the material may be or include a resin that can be polymerized by exposure to electromagnetic waves such as light (visible, IR, or UV). When using a resin-based material for manufacturing, the deposition mechanism 30 may be referred to as a “resin deposition mechanism”. FIGS. 3A-4, 6-13, and 18-27 illustrate additional schematic and/or structural embodiments of the system 10 and apparatus 12 and/or methods and configurations for operation of the system 10 and apparatus 12. Consistent reference numbers are used throughout this description to refer to structurally or functionally similar or identical components throughout the drawing figures, and it is understood that features and aspects of some embodiments that have already been described in sufficient detail may not be specifically re-described with respect to each embodiment for the sake of brevity.

Production of objects 11 through additive manufacturing often involves the production of support structure, which is formed during manufacturing and supports the object 11 during manufacturing, to be removed later. Such support structure can be formed of the same or a different material from the desired final portions of the object 11. Removal of such support structures can be accomplished using mechanical means (e.g., separation, breakage, machining), solvent-based means (e.g., use of a water-soluble polymer that can be washed away), or other means. Any support structure manufactured along with an object 11 as described herein will be considered to be part of the “object” as defined herein.

The support assembly 20 generally includes at least a build platform 22 that is configured to support the object 11 within the build area 13 during manufacturing. The build area 13 is defined in the area adjacent to the build platform 22, which is immediately below the build platform 22 in the embodiment of FIG. 1. The support assembly 20 in FIG. 1 includes a support platform 24 that is movable in the vertical (z) direction and supports a removable insert 26 that defines the build platform 22. The insert 26 may be removably connected to the support assembly 20 in certain embodiments, such as by application of vacuum suction. It is also understood that the object 11 may be removed from the build platform 22 without removal of the build platform 22, and that the build platform 22 may include no removable structure in other embodiments. Additionally, in one embodiment, the support assembly 20 and the track 14 may be partially or completely modular. This permits ease of build-out and modification of the entire apparatus 12 as desired. This also permits assembling or disassembling the apparatus 12 to move it into or out of a room, even if the apparatus 12 is significantly larger than the door to the room, which can be an issue with current stereolithography machines.

FIG. 1 schematically illustrates an embodiment of the deposition mechanism 30, which generally includes a carriage 32 engaged with the track 14 and configured for movement along the track 14 and through the build area 13, a supply 34 of a flowable material 36 mounted on or otherwise operably connected to the carriage 32, an applicator 40 in communication with the supply 34 of the flowable material 36 and configured to apply the flowable material 36 to an application site 41 within the build area 13, and an exposure device 50 configured for emitting electromagnetic waves to solidify the applied material 36 to form the object 11. The application site 41 is generally defined as the area where the material 36 contacts the deposition surface, i.e., the build platform 22 or the surface of the object 11. Various embodiments of the deposition mechanism 30 are described herein, both schematically and with regard to specific structural embodiments.

The carriage 32 is configured to move along the track 14 to move the deposition mechanism 30 through the build area 13 during manufacturing. The track 14 is generally configured for guiding the carriage 32 of the deposition mechanism 30 through the build area 13 for creation of the object 11. The track 14 and the carriage 32 may have complementary engaging structure to permit movement of the carriage 32 along the track 14. For example, the track 14 may include two parallel beams, and the carriage 32 and the track 14 may have complementary gear surfaces (not shown) that allow the carriage 32 to roll along the beams by rotation of the gear surfaces on the carriage 32. The carriage 32 may be powered for movement in various embodiments, such as by wheels or gear arrangements. In other embodiments, the power for movement may be supplied by external mechanisms which may or may not be incorporated into the track 14, such as chains, cables, belts, sprockets, pistons, etc. The speed of the carriage 32 may be adjusted depending on the properties of the material 36, as materials 36 with different viscosities and/or solidification rates may benefit from faster or slower drive speeds. The carriage 32 may be configured to support other components of the deposition mechanism 30, such that the other components move with the carriage 32. For example, in the embodiments of FIG. 1, the carriage 32 supports at least the applicator 40, the exposure device 50, and the material supply 34. It is understood that these embodiments are depicted schematically and the carriage 32 may support additional components as well, including the controller 100 and/or other components not pictured. The carriage 32 may be configured for modular connection of components as well, as described elsewhere herein. The controller 100 may be configured to control the operation, speed, elevation, and other aspects of the carriage 32 and the manufacturing process. In one embodiment, numerous parameters may be determined prior to the commencement of the manufacturing process and/or prior to a single pass and executed by the controller 100. Such parameters may be manually determined, automatically determined, or a combination of the same. For example, before a pass is made the layer thickness, the build direction, the build speed, the roller direction and speed, the material-to-roller communication level (determined based on the viscosity of the material 36), and the power output of the exposure device 50 may be determined, and the deposition mechanism 30 may be located to a predetermined starting (registration) position.

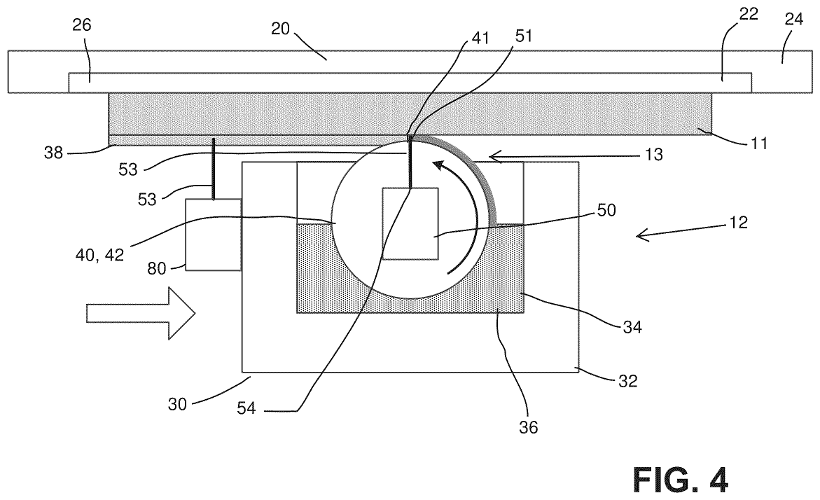

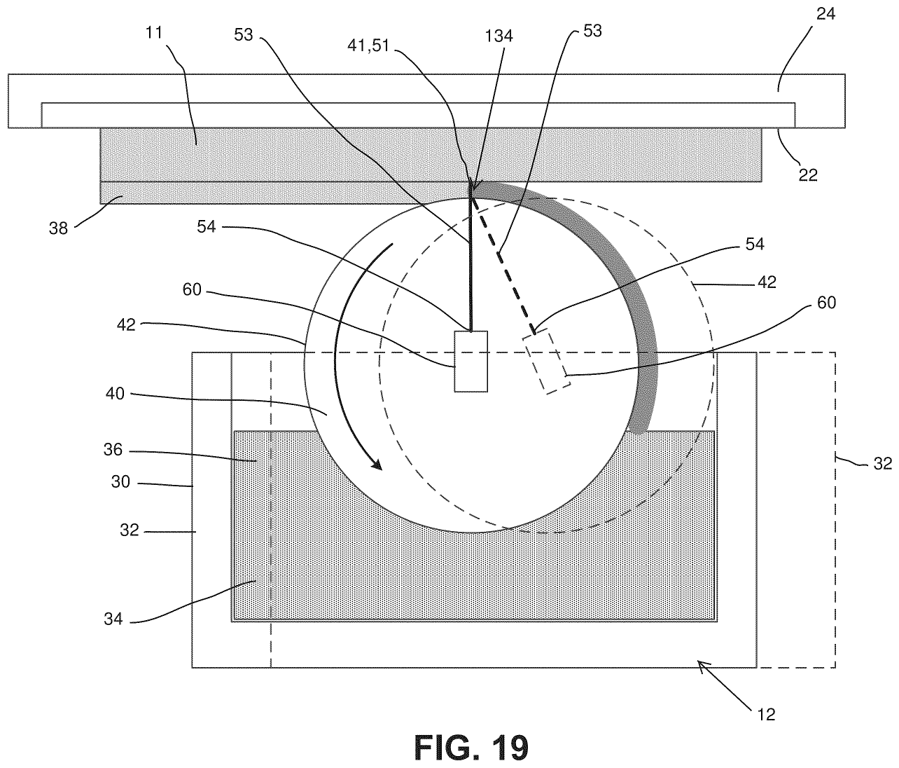

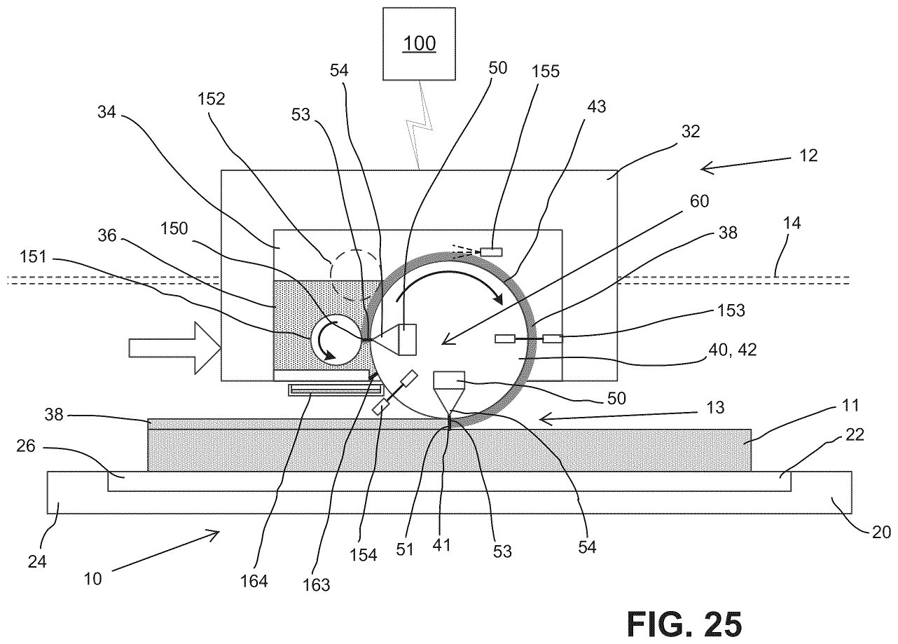

In the embodiments of FIGS. 1, 3A-4, 6-13, and 18-27, the applicator 40 includes or is in the form of a roller 42 that is in communication or contact with the material supply 34. In these embodiments, the roller 42 is cylindrical and has a cylindrical outer surface 43 in contact with the supply 34. In the embodiment of FIG. 1, as well as other embodiments herein, the roller 42 is hollow or otherwise has an inner chamber. The roller 42 rotates so that material 36 is picked up on the outer surface 43 of the roller 42 and is carried to the application site 41 for manufacturing of the object 11. The roller 42 may be powered for rotation by any of various mechanisms, such as gears, sprockets, wheels, belts, etc. In one embodiment, the roller 42 is configured to rotate in conjunction with the movement of the carriage 32, i.e., such that the top of the roller 42 is moving in the opposite direction to and at approximately the same speed as the movement of the carriage 32. This is schematically shown in FIGS. 1 and 4, as well as FIGS. 19-26, and avoids drag and/or shear on the surface of the object 11 and the applied material 36. In another embodiment, the roller 42 may be configured to rotate at a different speed, i.e., faster or slower than the translational movement speed across the deposition surface. It is contemplated that rotating the roller 42 faster than the translational movement speed can improve curing of the material 36 at the deposition surface, by increasing exposure time of the material 36 at the deposition surface relative to the material 36 on the surface 43 of the roller 42. The roller 42 may further be made from a material that is permeable to the electromagnetic waves that are emitted by the exposure device 50, such that the waves can pass through the roller 42 relatively unchanged. The application site 41 is generally defined between the outer surface 43 of the roller 42 and the deposition surface, i.e., the build platform 22 or the surface of the object 11. The spacing between the outer surface 43 of the roller 42 and the deposition surface may define the thickness of the material 36 that is deposited, and the ultimate thickness of the solidified material layer 38. It is understood that the material of the roller 42 may be customized to the specific wavelength of the electromagnetic waves to ensure sufficient permeability. The applicator 40 may have a different configuration in another embodiment, and may carry the material 36 to the application site 41 using a different mechanism. The applicator 40 may further have a different orientation relative to the build platform 22, such as shown in FIGS. 25-27.

The use of the roller 42 in certain embodiments described herein creates a moving retention area at the apex of the roller 42, and the fixed distance between the apex of the roller 42 and the build surface (i.e., the build platform or the last-deposited layer 38) determines the thickness of the layer being produced. Additionally, because the roller 42 is in communication with the supply 34 of the material 36, any non-solidified material 36 is returned to the supply 34, reducing or eliminating waste.

When the applicator 40 is configured as a roller 42, the surface of the build platform 22 and/or the surface of the roller 42 may be selected or modified for desired adhesion properties. It is beneficial for the surface of the build platform 22 and/or the surface of any applied layer 38 of the object 11 to have greater adhesion to the solidified material 36 than the surface of the roller 42. If this does not occur, material may adhere to the roller 42 and solidify there, causing flaws in the manufactured object 11. In one embodiment, the roller 42 may be made from a low-adhesion material or treated with a coating to reduce adhesion. Likewise, the surface of the build platform 22 may be made from a high-adhesion material or treated with a coating to increase adhesion. In one embodiment, the roller 42 has a lower adhesion property with respect to the solidified material 36 than the adhesion property of the bonding surface for the material 36 (i.e., the build platform 22 or the last-deposited layer 38). The adhesive properties of the flowable material 36 may be different for different materials.

In the embodiments of FIGS. 1, 3A-4, 6-13, and 18-27, the supply 34 is configured as a vat of the flowable material 36 that is in contact with the roller 42, such that rotation of the roller 42 carries the material 36 to the application site 41. In this configuration, the flowable material 36 should have sufficient viscosity that the roller 42 is able to carry a continuous layer of the uncured flowable material 36 to the application site 41. The desired viscosity of the flowable material 36 may depend on the desired build speed or rotation speed of the roller 42, or on the level of the roller 42 relative to the level of the material 36 in the supply 34. A slower rotation speed and/or a lower vat material 36 level may require higher viscosity material 36. It is understood that the power of the exposure device 50 may require a slower or faster speed, as more powerful waves 53 can solidify materials (e.g., polymerizing resins) more quickly. In another embodiment, the supply 34 may be more complex, such as by including injectors or nozzles to force the material 36 onto the roller 42. Additionally, the supply 34 of the flowable material 36 may be configured differently if the configuration of the applicator 40 is changed, and the supply 34 may be configured to be compatible with the design of the applicator 40, or vice-versa. In certain embodiments, the supply 34 may be configured to hold multiple different flowable materials 36 in multiple portions or compartments of the supply 34. It is understood that descriptions of using “different materials” as used herein may also enable usage of the same material with different colorings.

The exposure device 50 is generally configured for emitting electromagnetic waves 53 to solidify the applied material 36 to form the object 11. The wavelength and intensity of the electromagnetic waves may be selected based on the material 36 to be solidified and the speed or mechanism of solidification. For example, when a light-curable resin is used as the material 36, the exposure device 50 may be configured to emit light (visible, IR, UV, etc.) that is an appropriate wavelength for curing/polymerizing the resin to form a solid material layer 38. As another example, if a sintering process is used to solidify the flowable material 36, the waves 53 emitted by the exposure device 50 may have sufficient power to sinter the material 36 to form a solid material layer 38. The exposure device 50 may also include various components and structures to direct the emitted waves toward an exposure site 51 within the build area 13, where the material 36 is exposed to the waves at the exposure site 51. The waves may be directed so that the exposure site 51 is located approximately at the application site 41 in one embodiment, or so that the exposure site 51 is offset from the application site 41 (ahead or behind the application site 41 in the direction of travel) in another embodiment. FIG. 1 illustrates (with solid lines) the waves 53 being directed to an exposure site 51 approximately at the application site 41, and further illustrate (with broken lines) the waves 53 alternately being directed to an exposure site 51 offset behind or ahead of the application site 41.

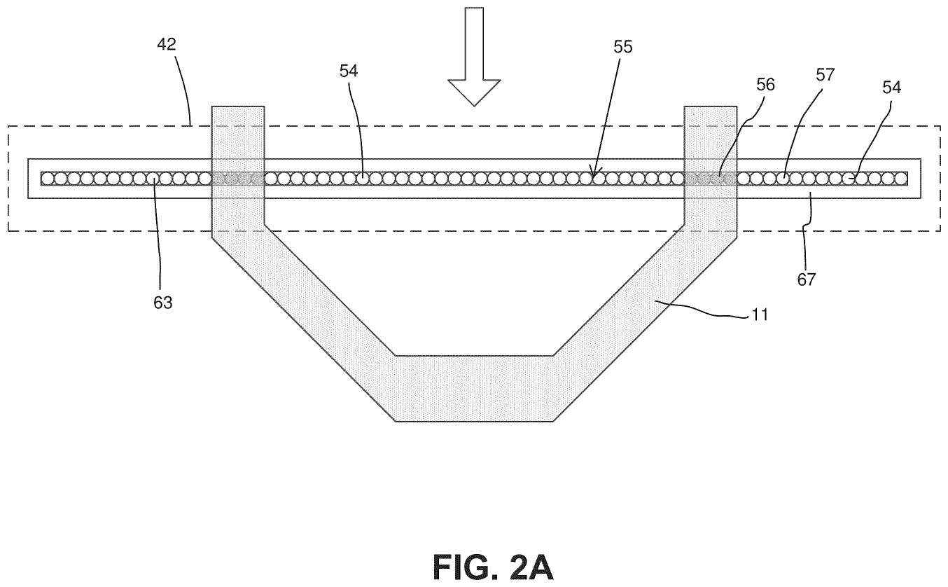

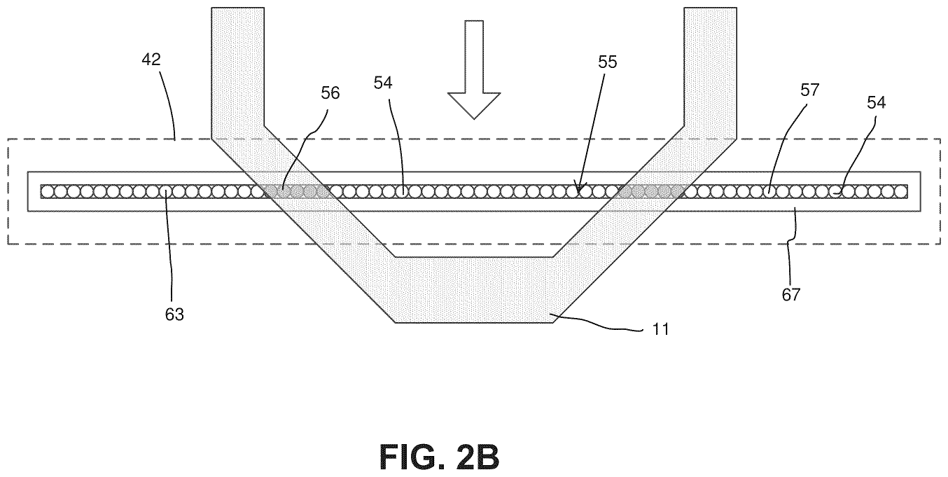

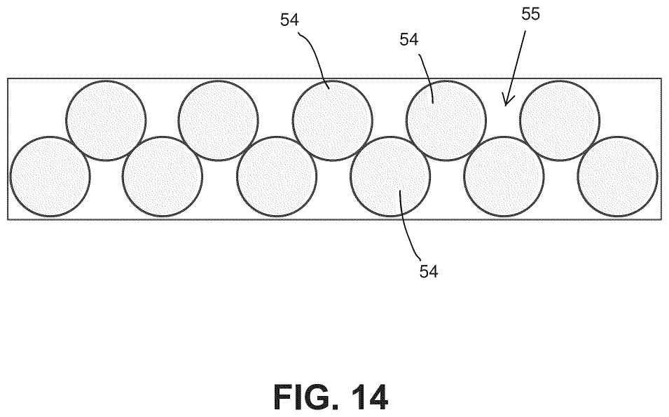

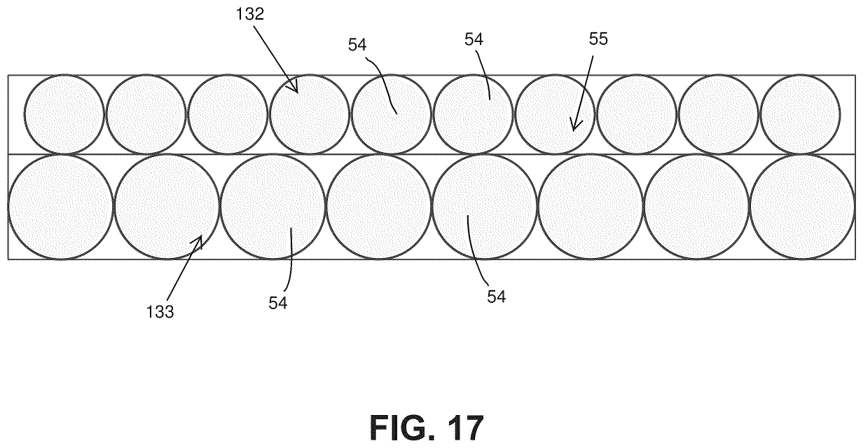

In general, the exposure device 50 is configured such that waves generated by the exposure device exit through outlets 54 and are directed toward specific areas of the exposure site 51 to permit selective solidification of the material 36 at the selected areas of the exposure site 51 as the deposition mechanism 30 passes. In one embodiment, the exposure device 50 is part of an exposure assembly 60 that includes components designed to direct and/or focus the waves 53 toward the exposure site 51. The outlets 54 may be arranged in an array 55, and specific outlets 54 along the array 55 may be selectively activated to selectively solidify portions of the material 36, as shown in FIGS. 2A and 2B. FIGS. 2A and 2B illustrate the active outlets 56 as being darkened, and the inactive outlets 57 as being light. As seen in FIGS. 2A and 2B, the active outlets 56 and inactive outlets 57 are changed when the roller 42 reaches a point where the shape or contour of the object 11 changes. The selective activation and deactivation of the outlets 54 may be controlled by the controller 100, as described herein. The array 55 in FIGS. 2A and 2B is illustrated as a single horizontal row of outlets 54. In other embodiments, the array 55 may be arranged differently, such as in multiple, offset horizontal rows. The use of multiple rows in the array 55 can permit closer lateral spacing between the outlets 54 than the use of a single row. FIGS. 14 and 17 illustrate additional configurations for arranging an array 55 of outlets 54, as described in greater detail herein.

As described above, the waves 53 may penetrate the roller 42 on their path to the exposure site 51. In the embodiment of FIG. 1, the outlets 54 are located inside the roller 42 and the emitted waves 53 penetrate the surface of the roller 42 once on their paths to the exposure site 51. In the embodiment of FIG. 1, the exposure device 50 itself may be located within the roller 42, or the exposure device 50 may be located outside the roller 42, with the outlets 54 positioned within the roller. Additional structures such as squeegees, gaskets, or other sealing structures may be used to resist resin ingress between the roller 42 and the window 44.

In one embodiment, the exposure device 50 may be a projector, such as a Digital Light Processing (DLP) projector, as the source of the waves 53, and the exposure assembly 60 may also use optical fibers to direct the waves 53 to the exposure site 51. The outlets 54 in such an embodiment are formed by the exit ends 63 of the optical fibers, and may be located inside the roller 42 and arranged as an array 55 inside the roller, as shown in FIGS. 1, 2A-4, 6-13, and 18-27. In such an embodiment, the optical fibers may extend into the roller 42 from one or both ends of the cylinder, and appropriate sealing and bracing components may be used around the optical fibers in this case. For example, the exit ends 63 of the optical fibers may be gathered and held in place by a casing or similar holding structure 67 (see FIGS. 2A-2B). The exposure assembly 60 may further use a focusing mechanism 66 to focus the light waves 53 after they exit the exit ends 63 of the optical fibers 61, as described in greater detail herein. In one embodiment, the focusing mechanism 66 may include a micro-lens array between the exit ends 63 of the optical fibers and the object 11, such as a Selfoc Lens Array (SLA) lens, that focuses the waves 53 and avoids diffraction on the path to the exposure site 51. In other embodiments, various other lenses, mirrors, and other focusing equipment may be used.

This exposure device 50 may be configured to selectively activate and deactivate the outlets 54 by use of voxel or pixel mapping. This mapping also incorporates mapping of the specific area of the exposure site 51 toward which the outlet 54 of each optical fiber is directed. This mapping may be stored in computer memory and executed by a computer processor, such as by the controller 100. In some embodiments, such voxel or pixel mapping may be stored in a data structure that minimizes the memory requirements of manufacturing apparatus 12. For example, the mapping for building the object 11 may be stored in slices or layers in controller 100, and controller 100 may transmit the slices or layers to manufacturing apparatus 12 as needed. It is understood that each slice or layer may correspond to building a single layer 38 of the object 11 as described herein. Manufacturing apparatus 12 may be configured to delete mappings after they are used and to request mappings when needed. Manufacturing apparatus 12 may also maintain a storage device, such as a first-in-first-out memory, that stores successive slices or layers of mappings. In someone embodiments controller 100 may be configured to transmit slices or layers of mappings to manufacturing apparatus 12 at a rate corresponding to a rate that manufacturing apparatus 12 builds layers 38 of the object 11.

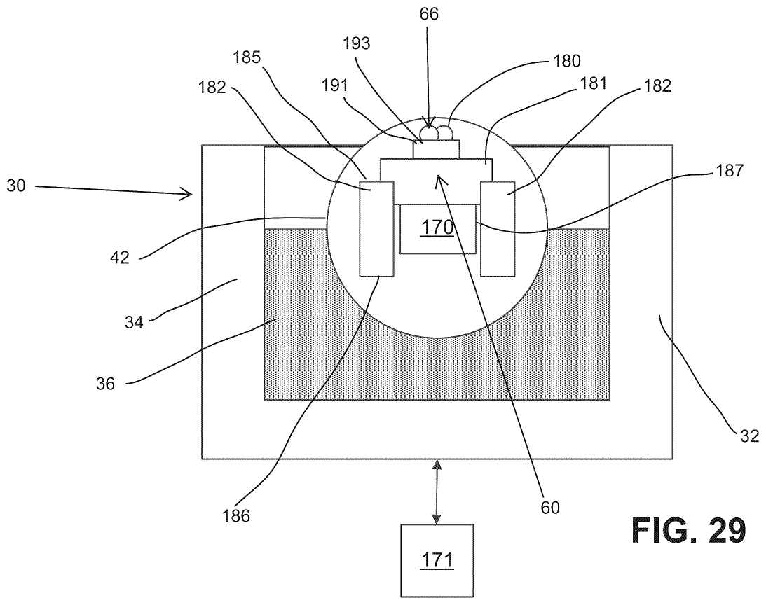

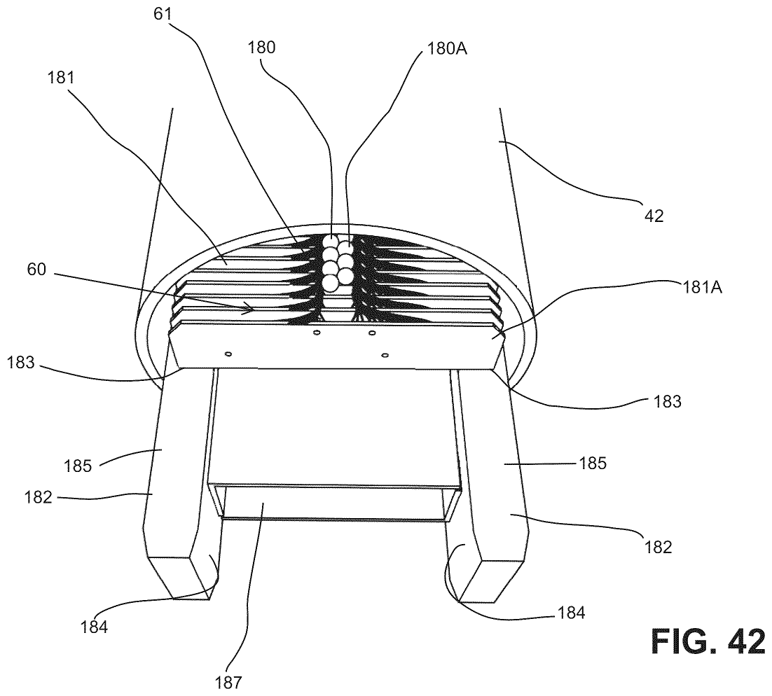

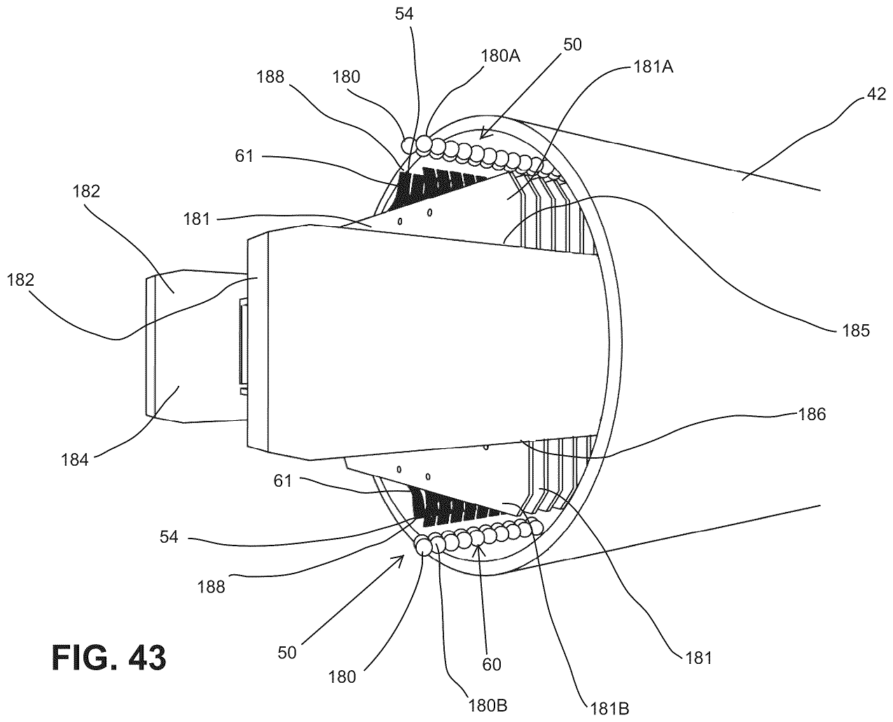

In another embodiment, the exposure device 50 is in the form of an array 55 of LEDs 59 that function as the sources of the waves 53, as shown in FIGS. 29-44. The LEDs 59 may be designed to emit waves 53 of the proper wavelength and intensity for solidifying the material 36. The arrays 55 of LEDs 59 are positioned within the roller 42 as in the embodiments of FIGS. 29-44, and may use a focusing mechanism 66 as also described herein. The embodiments of FIGS. 29-44 use an array of ball lenses 180 as described in greater detail herein as a focusing mechanism 66. In another embodiment, a micro-lens array at the outlets 54 as described above may assist in focusing the waves 53. Each of the LEDs 59 in this embodiment is connected to an individual optical fiber 61 that has an exit end 63 forming a separate outlet 54 that emits waves 63 that are focused by the focusing mechanism 66 to be directed at a specific area of the exposure site 51. The LEDs 59 can be selectively activated and deactivated to expose that specific area of the exposure site 51 to the waves 53. Each activated LED 59 corresponds to an active outlet 54, and each inactive LED 59 corresponds to an inactive outlet 54. The LEDs 59 may be mapped to the specific areas of the exposure site 51 toward which their corresponding outlets 54 are directed, and this mapping may be stored in computer memory and executed by a computer processor, such as by the controller 100. The entrance ends of the optical fibers 61 may be fixed in position relative to the LEDs 59 using various fixing and bundling structures as appropriate for the size and arrangement of the LED array 55, and it is understood that the LED array 55 may not be linearly arranged in some configurations. In one embodiment, no lens or other focusing structure may be necessary between the LEDs 59 and the entrance ends 62 of the optical fibers 61. It is understood that multiple optical fibers 61 may be mapped to each LED 59 in one embodiment.

In another embodiment, the LEDs 59 may be positioned outside the roller 42, and a plurality of optical fibers 61 may extend from the LEDs 59 into the roller 42 such that their exit ends 61 are within the roller and form the outlets 54. The outlets 56 may be configured in the same manner as shown and described herein with respect to the embodiments of FIGS. 29-44 and other embodiments, including the use of a focusing mechanism 66 and mechanisms for adjusting the direction of the waves 53 forward or rearward in the direction of travel of the deposition mechanism 30. This configuration permits the use of an array of LEDs that is larger than can be incorporated inside the applicator 40. In further embodiments, a different type of exposure device 50 may be used, and the deposition mechanism 60 may include components configured to direct the waves 53 from the exposure device to the proper areas of the exposure site 51. For example, the exposure device 50 may be in the form of a laser with a focusing mechanism 66 including lenses and/or mirrors, or in the form of an LCD source or a high-speed positionable mechanical shutter system.

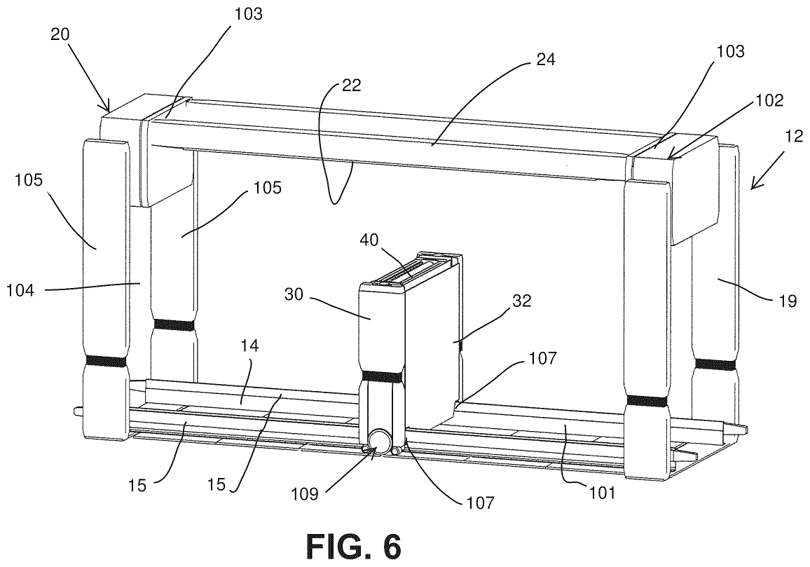

During operation of the apparatus 12, the spacing between the applicator 40 and the deposition surface must be changed for each new layer 38 of the object 11 that is deposited. The applicator 40 in the embodiments of FIGS. 1, 3A-4, 6-13, and 19-24 is oriented so that the roller 42 is positioned vertically below the deposition surface and forms the layer 38 vertically above the roller 42. In this embodiment, relative vertical translation (i.e., parallel to the layer-by-layer build direction) occurs between the applicator 40 and the deposition surface during manufacturing of successive layers 38. This vertical translation is illustrated, e.g., in FIGS. 3A and 3B, which illustrate the deposition mechanism 30 making a first pass (FIG. 3A) from left to right to deposit a first layer 38 and a second pass (FIG. 3B) from right to left to deposit a second layer 38, where the vertical translation between the first and second passes is shown in phantom lines. This relative change in positioning can be accomplished using one or more different methods and mechanisms or combinations thereof. In one embodiment, this vertical translation can be accomplished by changing the elevation of the build platform 22, using a vertical positioning mechanism as described herein. In another embodiment, this vertical translation can instead be accomplished by changing the elevation of the track 14, which may be accomplished using similar vertical positioning mechanisms. In a further embodiment, such as in FIGS. 6-13 described in greater detail herein, the deposition mechanism 30 may include a mechanism for changing the vertical position of the applicator 40 relative to the build platform 22, such as by raising or lowering the applicator 40 and/or the entire chassis 32. It is understood that the apparatus 12 may include a combination of such mechanisms for achieving vertical translation, such as using a vertically moveable build platform 22 in combination with a vertically moveable applicator 40.

The deposition mechanism 30 may include further additional components to provide additional functionality in producing a high-quality object 11. It is understood that any of the example embodiments herein may include any combination of these additional components, even if not specifically illustrated herein. For example, the deposition mechanism 30 may include one or more secondary exposure devices 80, configured to trail the applicator 40 in the direction of movement, as shown in FIG. 4. The secondary exposure device 80 emits additional electromagnetic waves 53 to further solidify the material, which waves 53 may have the same or different wavelength and intensity as the waves 53 from the exposure device 50. In one embodiment, the secondary exposure device 80 does not need to be precisely focused, as it is acceptable for the entire surface of the object 11 to be irradiated. In this configuration, the waves 53 from the exposure device 50 may be configured to only solidify the material 36 enough to form a stable layer 38 (known as a “green state”), and the secondary exposure device 80 then further solidifies the layer 38 to the desired final degree of solidification. This presents a significant efficiency advantage over existing processes, where objects 11 are typically produced in the green state and require a subsequent separate irradiation step for full curing. In one embodiment, the power levels of the exposure device 50 and the secondary exposure device 80 may be set so that each exposure device 50, 80 partially solidifies the material 36 and the combined exposure is sufficient to completely solidify the material 36. This setting avoids overexposure of the material 36, which could cause aesthetic and/or mechanical damage. The deposition mechanism 30 may include two secondary exposure devices 80, to permit secondary exposure of the layer 38 while the carriage 32 is traveling in two opposite directions without making a 180° turn. The controller 100 may control activation of the secondary exposure device(s) 80.

As another example, the deposition mechanism 30 may include one or more material removal and/or relocation mechanisms configured to remove or relocate excess and/or unsolidified material, such as one or more squeegees or one or more contactless vacuum squeegees. The material removal and/or relocation mechanisms may be configured for removing excess and/or unsolidified material 36 from the roller 42 and/or from the surface of the layer 38. Further additional components may be included in other embodiments. For example, the apparatus 12 may include a material buildup sensor configured to sense buildup of material (e.g., cured resin) on the applicator 40 and/or a leveling device (e.g., a leveling roller) to provide greater control over the thickness of the material 36 applied by the applicator 40. In one embodiment, one or more additional components may be modularly connectable to the carriage 32 and/or to each other to provide the desired functionality. Removable connections such as fasteners, clamps, interlocking structures (e.g., tabs/slots), or other structures may be used to effect these modular connections. Such additional components may also include other functional components, such as a solvent or liquid washing apparatus, mechanical wipers/cleaners, a color applicator, or an apparatus for additional material deposition. A color applicator used in this configuration can allow coloring to be applied on a layer-by-layer basis, giving the final object 11 a coloring that penetrates internally through the thickness of the object 11, instead of simply a surface coating. An apparatus for additional material deposition may include an apparatus for deposition of conductive materials or traces within the body of the object 11, providing conductivity and/or circuit functionality to the object 11.

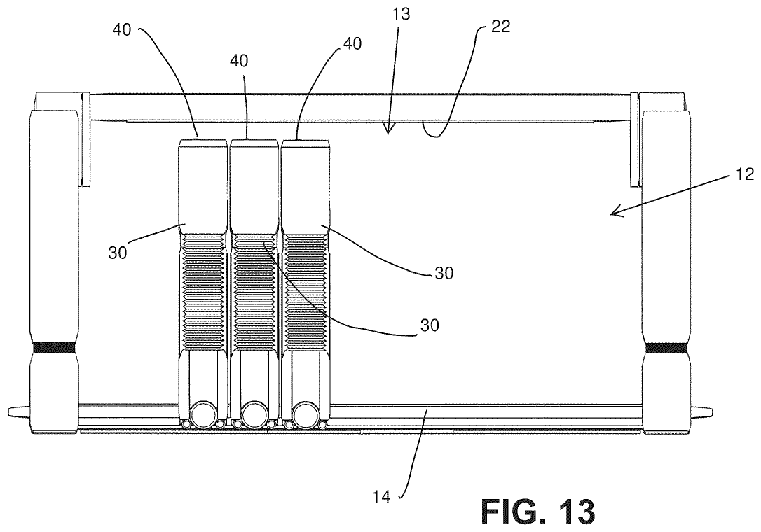

The apparatus 12 may be configured to use multiple deposition mechanisms 30 and/or multiple applicators 40 to pass through the build area 13 in sequence, such as illustrated in FIG. 13. The multiple deposition mechanisms 30 in FIG. 13 are illustrated as being connected to the same track 14, but multiple tracks 14 may be used in another embodiment. In one embodiment, multiple deposition mechanisms 30 may be configured to pass through the build area 13 sequentially, with each deposition mechanism 30 having the applicator 40 at different vertical positions. This configuration may be accomplished using vertical positioning structures described elsewhere herein. It is understood that the difference in vertical positioning among the multiple deposition mechanisms 30 may be substantially the same as the desired thickness of each applied layer 38. When multiple deposition mechanisms 30 are used, all deposition mechanisms 30 may use the same material 36, or different deposition mechanism 30 may be configured to apply different materials 36. Due to differences in properties of different materials 36, the deposition mechanisms 30 may need to pass at different speeds. A self-propelled carriage 32 as described herein permits this operation. In another embodiment, multiple deposition mechanisms 30 may be configured to pass through the build area 13 sequentially, with the deposition mechanisms 30 having the applicators 40 at the same vertical positions. This can be used to build different portions of the same layer of an object 11, and in particular, the deposition mechanisms 30 can be configured to deposit different materials 36 in the layer.

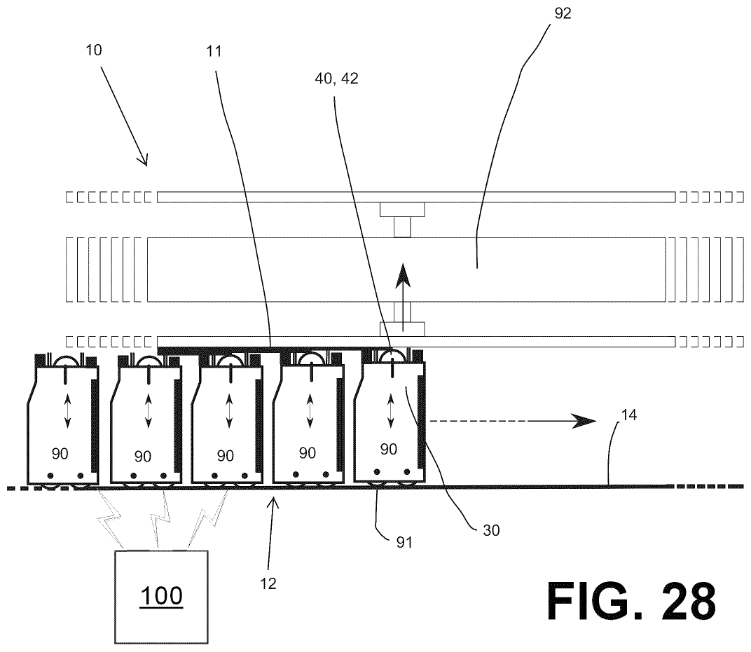

FIG. 28 illustrates an additional embodiment of a system 10 for manufacturing one or more objects 11 utilizing an apparatus 12 and deposition mechanisms 30 according to embodiments described herein. In particular, the embodiment of FIG. 28 may be configured for producing a number of objects 11 in sequence. Each deposition mechanism 30 in the embodiment of FIG. 28 may be configured as an autonomous unit 90 with an individual sub-controller, where all of the sub-controllers for all of the units 90 are integrated with the controller 100, such that the controller 100 controls the sub-controllers and thereby controls all of the units 90. Each unit 90 may further include one or more positioning systems, including a local positioning system and/or a global positioning system (GPS). Each unit 90 may further include a deposition mechanism 30 and a drive mechanism 91 configured for moving the unit 90 around during manufacturing. As shown in FIG. 28, the units 90 are all connected to a carousel 92 that moves the units 90 around to a plurality of stations. The stations may each be configured for a specialized purpose. For example, some stations may be manufacturing stations where the unit 90 makes a pass through one or more build areas 13 for manufacturing one or more objects 11 on one or more build platforms 22. Such stations may also include robotic components, such as robotic arms that hold a build platform 22 in the proper location for building by the units 90. Other stations may be maintenance stations, such as stations configured for refilling the supply 34 the unit 90. The carousel 92 may have one or more tracks 14 as described herein for guiding movement of the units 90 during building. The drive mechanism 91 may be multi-functional, such that the units 90 are autonomously powered and capable of engaging and disengaging from the track 14 and moving separately from the track 14 when not in the building process, such as for visiting refilling or maintenance stations. In the configuration illustrated in FIG. 28, each unit 90 may be loaded with a different material 36 for manufacturing different parts of a single object 11 or different objects. This configuration therefore provides the ability for rapid manufacturing of a series of objects 11, either identical objects 11 or different objects 11.

FIGS. 6-13 illustrate another embodiment of a system 10 that includes a manufacturing apparatus 12 that may be connected to a computer controller 100 in communication with one or more components of the apparatus 12 and configured for controlling operation of the apparatus 12 and/or the components thereof to manufacture an object 11. The apparatus 12 of FIGS. 6-13 includes a support assembly 20 for supporting the object 11 within a build area 13 during manufacturing, a track 14 extending through the build area 13, and a material deposition mechanism 30 mounted on the track 14 and configured for producing the object 11 within the build area 13 through layer-by-layer application of a material. Many components of the system 10 and apparatus 12 of FIGS. 6-13 are similar in structure and operation to other components described herein with respect to other embodiments, and such components may not be described again in detail with respect to the embodiment of FIGS. 6-13. It is understood that similar reference numbers may be used to indicate such similar components. The deposition mechanisms 30 in FIGS. 6-13 are configured for operation as autonomous units 90 as described herein, and each autonomous unit 90 may have onboard a processor 2604, a memory 2612, and/or other computer components necessary for executing computer-executable instructions to automate the autonomous unit 90 and/or communicate with the computer controller 100.

The support assembly 20 in FIGS. 6-13 includes a base frame 19 for supporting some or all of the track 14, the build platform 22, and other components of the apparatus 12. In the embodiment of FIGS. 6-13, the track 14 is not supported by the base frame 19 and is fixed separately to the floor, but the track 14 may be connected to and supported by the base frame 19 in another embodiment. The track 14 includes two parallel beams or rails 15 and at least one bus bar 101 configured for supplying power to the deposition mechanism 30. The bus bar(s) 101 may be part of one or both of the rails 15 in one embodiment. Additionally, the substantial entirety of one or both rails 15 may act as the bus bar(s) 101 in one embodiment. One or more bus bars 101 may be provided separate from the rails 15 in another embodiment. The track 14 may not contain any bus bar 101 in another embodiment, and the deposition mechanism 30 (i.e., the autonomous unit 90) may be self-powered for movement and operation, such as by an internal battery. It is understood that the track 14, the build platform 22, the support assembly 20, and other components may be constructed in any desired size, including lengths and widths that are significantly larger than those illustrated in FIGS. 6-13.

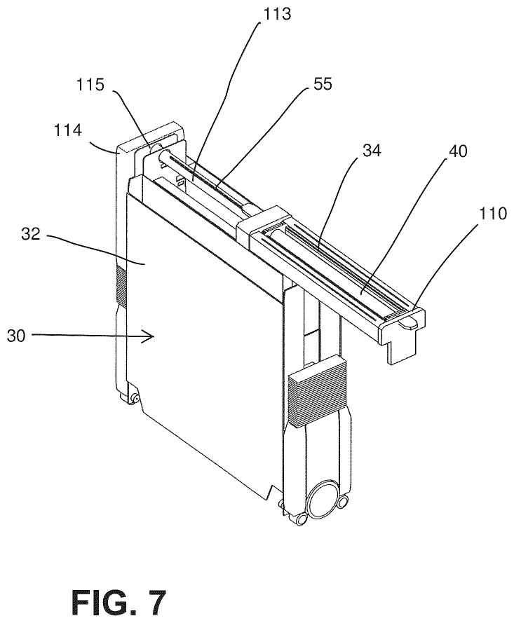

The deposition mechanism 30 in the embodiment of FIGS. 6-13 includes a carriage 32 engaged with the track 14 and configured for movement along the track 14 and through the build area 13, a supply 34 of a flowable material 36 mounted on or otherwise operably connected to the carriage 32, an applicator 40 in communication with the supply 34 of the flowable material 36 and configured to apply the flowable material 36 to an application site 41 within the build area 13, and an exposure device 50 configured for emitting electromagnetic waves to solidify the applied material 36 to form the object 11. The supply 34 of the flowable material 36, the applicator 40, and the exposure assembly 60 in the embodiment of FIGS. 6-13 are similar or identical in function and structure to the same components in the embodiment of FIGS. 1-4 and need not be re-described herein in detail. The supply 34 of the flowable material 36 and the applicator 40 in the embodiment of FIGS. 6-13 are connected so as to form an integrated application module 110, also referred to as a resin application module 110, which is removable from the carriage 32 and replaceable with a second application module 110. FIG. 7 illustrates an example of such an application module 110 and the process of removing and replacing the application module 110. In this embodiment, the supply 34 is provided in the form of a vat or reservoir with the roller 42 at least partially disposed within the reservoir to be in communication with the flowable resin 36, and the supply 34 can be removed without draining the resin 36 if so desired. The applicator 40 in this embodiment is in the form of an elongated roller 42, and one or both of the ends of the roller 42 is connected to the side walls of the vat 34. The optical fibers 61 pass through an opening extending through one of the side walls and the end of the roller 42 to pass into the interior of the roller 42 to form the array 55 of outlets 54 within the roller 42. The supporting structure 113 holding the fibers 61, the lens array 64 and other components of the exposure device 50 remain in place when the application module 110 is removed. It is understood that a side panel 114 of the carriage 32 is removed in this embodiment in order for the application module 110 to be removed, as shown in FIG. 7. The removable side panel 114 in the embodiment of FIGS. 6-13 is on the opposite side of the carriage as the drive assembly 115 that drives rotation of the roller 42. In one embodiment, either or both side panels 114 of the deposition mechanism 30 may include a resin tank connected to the supply 34 to replace used material 36 and/or keep the level of the material 36 constant. The deposition mechanisms in FIGS. 29-44 may also include a removable application module 110 as described herein.

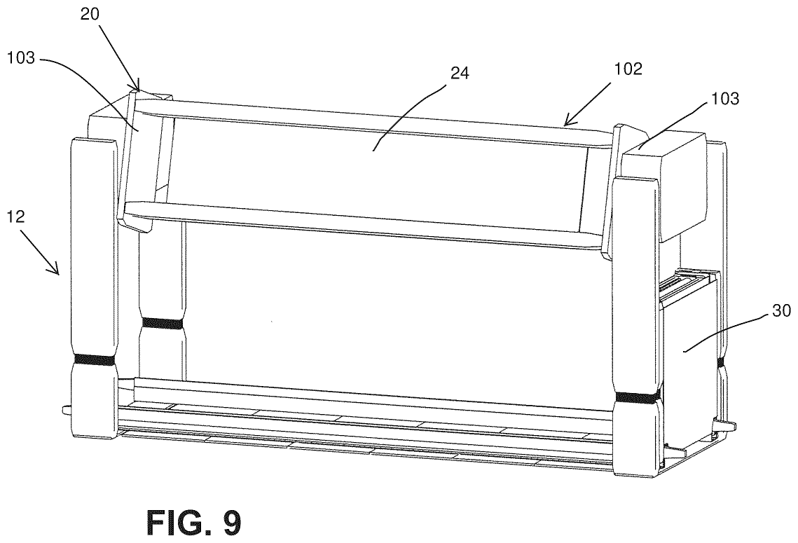

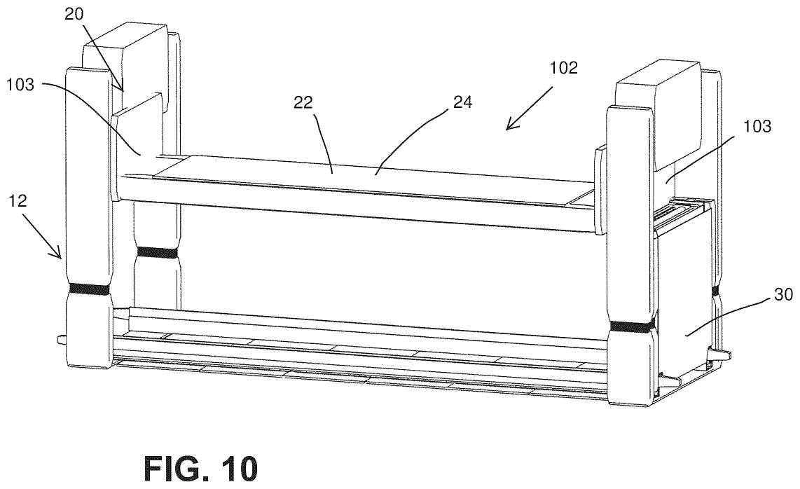

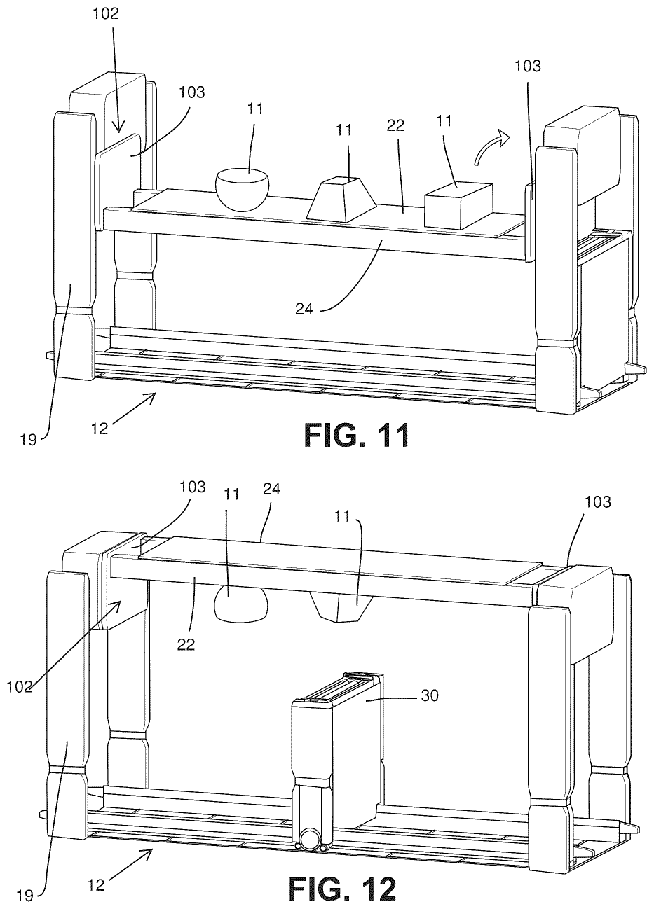

The support assembly 20 in FIGS. 6-13 further includes a mechanism 102 for moving the build platform 22 between a build position and a tending position, where the build platform 22 faces toward the track 14 for production of an object 11 in the build position, and the build platform 22 faces away from the track 14 in the tending position, to permit a tending operation to be performed on the object 11. Examples of tending operations include modifying the object 11, such as by material removal, including removal of support structure (e.g., by cutting, machining, etc.), painting, cleaning, or removing the object 11 from the build platform 22, such as if production of the object 11 is completed, or inserting or attaching functional or non-functional components previously manufactured by the same or different process (also referred to as secondary objects), such as RFID chips, magnets, added weights or structural supports, printed circuit boards, liquid tanks, etc. Such a secondary object may be connected in a configuration such that it is not exposed to the waves 53 during continuing production of the object 11 when the build platform 22 is returned to the build position. For example, the secondary object may be inserted within an internal cavity of the partially-built object 11 and/or provided with a protective casing. In one embodiment, the secondary object(s) may be other objects 11 manufactured simultaneously on the same or other build platforms 22 as described herein. In the embodiment of FIGS. 6-13, the mechanism 102 moves the build platform 22 between the build position and the tending position by rotation. FIGS. 6-8 and 12 illustrate the build platform 22 in the build position, FIG. 9 illustrates the build platform 22 being moved from the build position to the tending position, and FIGS. 10 and 11 illustrate the build platform 22 in the tending position in this embodiment.

The mechanism 102 for moving the build platform 22 in the embodiment of FIGS. 6-13 includes a support platform 24 that defines and/or supports the build platform 22 as described herein, with one or more rotating bases 103 connected to the support platform 24 and configured for rotating to move the support platform 24. As shown in FIGS. 6-12, the mechanism 102 includes two rotating bases 103 at opposed ends of the support platform 24 that are configured for rotating in unison about an axis, and the support platform 24 is fixed with respect to the rotating bases 103. In other embodiments, a different type of movement mechanism 102 may be used. FIGS. 9-12 illustrate the build platform 22 and the support platform 24 being rotated 180° between the build position and the tending position, such that the build platform 22 faces downward in the build position and upward in the tending position. In other embodiments, the build platform 22 and the support platform 24 may be oriented differently in the tending position and/or may include multiple tending positions.

In other embodiments a single or multiple deposition mechanisms 30 may be configured to build multiple objects 11 simultaneously, such as by using multiple build platforms 22 or multiple objects 11 built on the same build platform 22, with each separate object 11 having a separate build area 13 through which the deposition mechanism 30 passes. FIGS. 11 and 12 illustrate the system 10 and apparatus 12 being used to produce multiple objects 11 simultaneously, including multiple objects that are different from each other and have different build times, build requirements, and/or build heights. As described herein, the apparatus 12 and the deposition mechanism 30 according to various embodiments is capable of producing multiple objects 11 simultaneously, including multiple objects 11 on the same build platform 22 or multiple objects 11 on different build platforms 22 supported by the same support assembly 20. In the apparatus 12 of FIGS. 6-13, the multiple objects 11 can be built with the build platform 22 in the build position, as shown in FIG. 12. When a tending operation is necessary on one or more of the objects 11, the build platform 22 can be moved to the tending position, as shown in FIG. 11, and the tending operation may be performed. FIG. 11 illustrates a tending operation in the form of removal of one of the objects 11 for which building is complete, and it is understood that additional tending operations may be performed on any of the objects 11, including the objects 11 not removed at this stage. When the tending operation is complete, the build platform 22 can be returned to the build position, as shown in FIG. 12, which illustrates the apparatus 12 continuing to build the two remaining incomplete objects 11. This permits different objects to be simultaneously manufactured.

The track 14 in the embodiment of FIGS. 6-13 is configured to be “open” to allow a deposition mechanism 30 (such as the autonomous unit 90) to engage and disengage with the track 14 as desired. The track 14 may be considered to have an open end at one or both ends, where the deposition mechanism 30 can be engaged and disengaged with the track 14. In this configuration, the base frame 19 provides an opening at one or both ends of the track 14 to permit the deposition mechanism 30 to engage with the track through the base frame 19. The opening is also present between the rails 15 of the track 14. The rails 15 of the track 14 shown in FIGS. 6-13 extend outwardly beyond the opening 104 and/or beyond the adjacent portion of the base frame 19 and have ends 106 that are tapered on one or more surfaces to ease engagement of the carriage 32 with the track 14. The carriage 32 has a track engagement mechanism 109 that is configured to engage the track 14 to permit movement of the deposition mechanism 30 along the track 14. The track engagement mechanism 109 in the embodiment of FIGS. 6-13 includes slots 107 that are configured to receive the ends of the rails 15 during engagement and to further receive a portion of the respective rail 15 when the carriage 32 is engaged with the track 14. The track engagement mechanism 109 has wheels, rollers, sliders, gears, sprockets or other engagement structures positioned within the slots 107 and engaging the rails 15 on multiple surfaces, including the bottom and/or inner sides thereof. The locomotion of the carriage 32 along the track 14 is provided by the track engagement mechanism 109, which includes a locomotion mechanism that engages the track 14, such as wheels, gears, sprockets, etc. In one embodiment, the deposition mechanism 30 includes a circular gear that engages a linear gear on the or each rail 15 to drive motion of the carriage 32 along the track 14. In other embodiments, the locomotion of the carriage 32 along the track 14 may be provided by powered wheels 117 or by linear induction motors, among other mechanisms. The track engagement mechanism 109 in one embodiment further may have one or more electrical contacts (not shown) for engaging and drawing power from the bus bar(s) 101. The deposition mechanism 30 may be powered by other mechanisms, including an internal power source, a temporary umbilical power connection, and/or a contactless inductive power supply. Other track engagement mechanisms 109 may be used in other embodiments, including different locomotion mechanisms, and it is understood that the track 14 and the track engagement mechanism 109 may be designed in a complementary manner.

The deposition mechanism 30 in FIGS. 6-13 is configured to be an autonomous unit 90 that may be moveable independently of the track 14 in some circumstances, as described herein with respect to FIG. 28. As illustrated in FIG. 13, multiple deposition mechanisms 30 can be used on the track 14 simultaneously. Such multiple deposition mechanisms 30 may be configured for making multiple passes in opposite directions or for making a single pass. For example, a deposition mechanism 30 may engage with one end of the track 14, make a single pass of the build area 13, and then exit the track 14 at the opposite end to either move along to a different task (e.g., another apparatus) or to re-engage the track 14 again at the first end. It is contemplated that a continuous train of deposition mechanisms 30 could sequentially pass the build area 13, with each deposition mechanism 30 making a single pass and returning to re-engage the track 14 in order to make another pass. In a further embodiment, the apparatus 12 may use a mix of deposition mechanisms including autonomous units 90 that can be disengaged from the track 14 and non-autonomous and/or permanent deposition mechanisms 30 that cannot be readily disconnected from the track 14.

As described above, the deposition mechanism 30 may be moveable separately and independently from the track 14 in the embodiment of FIGS. 6-13, where the deposition mechanism 30 is provided as an autonomous unit 90. In this embodiment, the deposition mechanism 30 uses a ground engagement mechanism for support and locomotion independently of the track 14. The ground engagement mechanism in the embodiment of FIGS. 6-13 uses the wheels 117 for locomotion independently from the track 14, e.g., on the surface on which the apparatus 12 sits. The ground engagement mechanism in FIGS. 6-13 also includes extendible stabilizers 118 on the front and rear sides of the wheels 117 to stabilize the deposition mechanism 30 and resist tipping during movement by the wheels 117 apart from the track 14. In this embodiment, the stabilizers 118 are retractable when not needed, i.e., the stabilizers 118 are moveable between an extended position, for use in movement apart from the track 14 and a retracted position, shown in FIGS. 6-13, when the deposition mechanism 30 is engaged with the track 14. The stabilizers 118 may include additional wheels, casters, sliders, or other structures to enable ground engagement while in motion. In other embodiments, the deposition mechanism 30 may include different ground engagement mechanism(s), including tracks, moveable legs, or other such structures.

The deposition mechanism 30 in the embodiment of FIGS. 6-13 has a vertical adjustment mechanism 120 that is configured for adjusting the position of the applicator 40 and/or other components of the deposition mechanism 30 in the vertical direction, i.e., parallel to the build direction in the embodiment illustrated. This configuration differs from the configurations illustrated in FIGS. 1-4, where vertical adjustment is performed by adjusting the position of the build platform 22. The deposition mechanism 30 in FIGS. 6-13 has a bottom portion 121 that is engaged with the track 14 and/or the ground and a top portion 122 that is supported by the bottom portion 121 and is moveable in the vertical direction with respect to the bottom portion 121. The top portion 122 includes at least the applicator 40, the supply 34 of flowable material 36, and the outlets 54 in the embodiment of FIGS. 6-13, such that at least these components move in the vertical direction with the top portion 122. The vertical adjustment mechanism 120 moves the top portion 122 with respect to the bottom portion 121. In the embodiment of FIGS. 6-13, the vertical adjustment mechanism 120 includes two lifts 123 on opposite sides of the deposition mechanism 30. These lifts 123 may include telescoping structure and may be powered by a variety of different mechanisms, including hydraulic or pneumatic cylinders, jack screws, sprocket/chain drive, gears, etc. In other embodiments, the build platform 22 of FIGS. 6-13 may additionally or alternately be configured for vertical adjustment as described elsewhere herein.

The exposure device 50 and associated structures for transmission and direction of the electromagnetic waves 53 may be configured for adjustability to provide improved performance and/or versatility to the deposition mechanism 30. Such adjustability may include adjustability in the selection, arrangement, power output, aiming direction, and/or other aspects and properties of the exposure device 50 and associated structures (including the outlets 54). FIGS. 14-20 illustrate various embodiments providing such adjustability, and it is understood that aspects of the embodiments of FIGS. 14-20 may be used in combination with each other and with other embodiments described herein, including other adjustable configurations (and applications thereof) already described herein.

FIG. 14 illustrates one embodiment an arrangement of the array 55 of the outlets 54 of the exposure assembly 60 that can provide improved resolution in part production. The outlets 54 in the embodiment of FIG. 14 are staggered with respect to each other, such that each outlet 54 of the array 55 is overlapped laterally (i.e., in the y-direction) by at least one other outlet 54. As shown in FIG. 14, all outlets 54 other than the outlets 54 on opposite ends of the array 55 are overlapped on both edges by other outlets 54. This arrangement permits the lateral (y-direction) extremities of the exposure area to be more precisely selected, improving the resolution of the exposure assembly 60. The staggering of the outlets 54 also permits a greater number of outlets 54 to be placed into a given lateral width as compared to a single row, thus improving the total power output of the array 55.

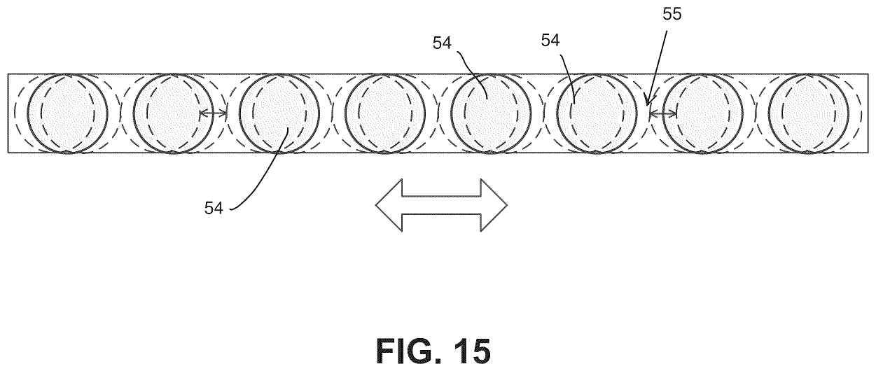

FIG. 15 illustrates an embodiment of an array 55 of the outlets 54 of the exposure assembly 60 that are configured for positional adjustment in the y-direction. In one embodiment, this positional adjustment may be accomplished by mounting the array 55 on a structure that is configured for translational/sliding movement in one embodiment, which sliding movement may be actuated by a piston, jack screw, or other structure configured for one-dimensional movement. In another embodiment, this positional adjustment may be accomplished by mounting the array 55 on a structure that is configured for angular/tilting movement, which may be actuated by a piston, jack screw, or other structure configured to raise and lower one or both lateral ends of the array 55. In a further embodiment, the outlets 54 may be adjustable individually or in discrete groups or clusters. The outlets 54 may further be configured for rapid reciprocation in the y-direction, permitting a single outlet 54 to direct waves 53 at an area that is enlarged in the y-direction. This y-direction adjustment and/or reciprocation permits the lateral (y-direction) extremities of the exposure area to be more precisely selected, improving the resolution of the exposure assembly 60. It is understood that the array 55 may include a larger number of rows and/or different offset arrangements in other embodiments.

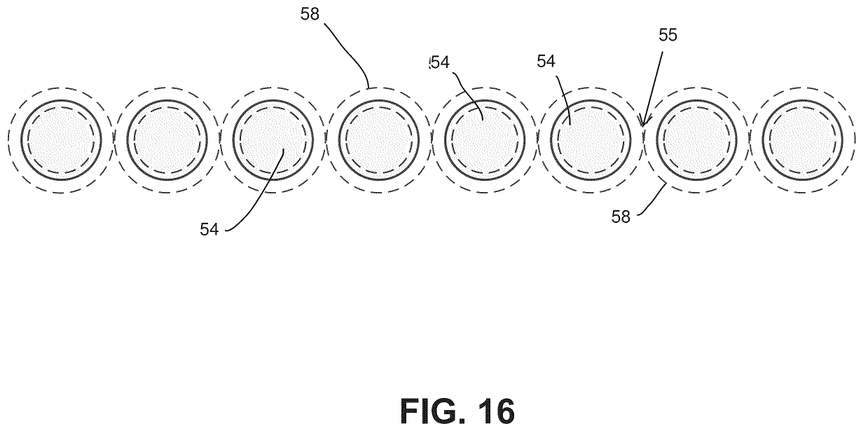

FIG. 16 illustrates an embodiment of an array 55 of the outlets 54 of the exposure assembly 60 that are configured for adjustment in output power. This adjustment in output power may be accomplished by varying the output power of the exposure device 50. In one embodiment, the adjustment in output power may be configured to adjust the size of the exposure area 58 of each outlet 54, thereby permitting the lateral (y-direction) extremities of the exposure area to be more precisely selected, improving the resolution of the exposure assembly 60. As seen in FIG. 16, the size of the exposure area 58 may be increased or decreased (indicated by broken lines) by increasing or decreasing the output power, respectively. In another embodiment, the adjustment in output power may be customized to the properties of the flowable material 36, as some materials 36 may require larger or smaller amounts of power for solidification. It is understood that other factors, such as travel speed of the deposition mechanism 30, may influence the desired output power.

FIG. 17 illustrates an embodiment of an array 55 of the outlets 54 of the exposure assembly 60 that are configured such that a first subset 132 of the array 55 is configured for emitting waves 53 having a first property and a second subset 133 of the array is configured for emitting waves 53 having a second property. In one embodiment, the first and second subsets 132, 133 may be configured for emitting waves having different power output levels, permitting significantly greater versatility in production. For example, the first subset 132 may include smaller outlets 54 (e.g., smaller diameter optical fibers 61) with relatively smaller power output levels that are more tightly packed together, to permit greater y-direction resolution for critical dimensions, and the second subset 132 may include larger outlets 54 (e.g., larger diameter optical fibers 61) with relatively larger power output levels to permit more rapid solidification for filling the body of an object. The different power outputs may be achieved by connecting the outlets 54 of the different subsets 132, 133 to different exposure devices 50, connecting the outlets 54 of the different subsets 132, 133 to a single exposure device 50 that is capable of power variation, or by the entrance ends 62 of the second subset 133 receiving waves 53 emitted by a larger number of pixels (if a DLP projector is used) due to their larger size. A combination of outlets 54 from different subsets 132, 133 (including laterally overlapping outlets 54) may be activated to permit further process variability, such as further increased exposure power and/or a combination of high power for the middle portions of the object 11 and finer resolution at the edges of the object 11. In an alternate embodiment, some of these benefits may be achieved using subsets 132, 133 of smaller and larger diameter optical fibers 61 without having any difference in power output between the two subsets 132, 133. In another embodiment, the outlets 54 of the first and second subsets 132, 133 may be connected to different exposure devices that emit different wavelengths of waves 53 that may cure different types of materials 36 or to cure one material 36 at different rates. It is understood that a larger number of subsets 132, 133 with further different properties may be used in other embodiments, and that the waves 53 emitted by each subset may have multiple properties differing from each other.

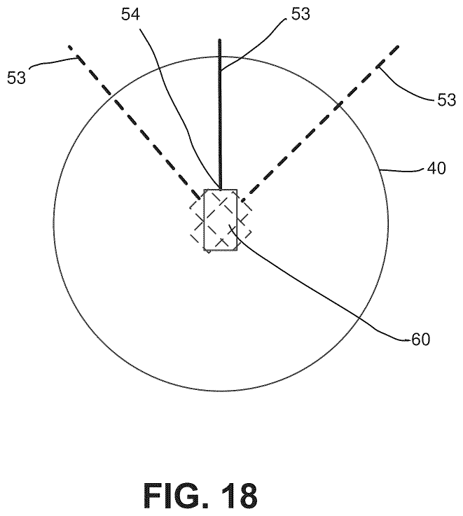

FIG. 18 illustrates one embodiment of a structure for directing the waves 53 so that the exposure site 51 is located approximately at the application site 41 in one embodiment, or so that the exposure site 51 is offset from the application site 41 (ahead or behind the application site 41 in the direction of travel) in another embodiment, as described herein and illustrated with respect to FIG. 1. In this embodiment, the aim of the outlets 54 is adjustable forwardly and rearwardly in the x-direction. As illustrated in FIG. 18, the outlets 54 of the exposure assembly 60 may be configured to be tiltable in one embodiment, such as by mounting the outlets 54 using a structure (e.g., braces 65) that is rotatable or pivotable over a range of movement to advance or retard the exposure site 51. For example, the deposition mechanism 30 may include a mounting structure for the outlets 54 that is mounted on a gimbal to permit single-axis rotation. It is understood that the degree of tilting shown in FIG. 18 may be exaggerated compared to the actual degree of tilting necessary to achieve this purpose in many embodiments. In another embodiment, the exposure device 50 may include multiple arrays of outlets 54 that are directed at different angles, where selective activation of the outlets 54 allows the exposure site 51 to be advanced or retarded. In a further embodiment, the outlets 54 may be aimed differently by translational movement in the x-direction. It is understood that the degree of offset of the exposure site 51 may depend on the properties of the flowable material 36 and the speed of the deposition mechanism 30, among other factors. Offsetting the exposure site 51 may improve bonding of the flowable material 36 to the surface and/or separation of the flowable material 36 from the roller 42. On rollers 42 having greater lengths, contraction of the material 36 as it solidifies can pull on the surface of the roller 42 if the material 36 is not properly separated from the roller 42, causing dimensional distortion (e.g., bowing outward) of the surface of the roller 42. Offsetting the exposure site 51 can therefore be particularly advantageous for such configurations.

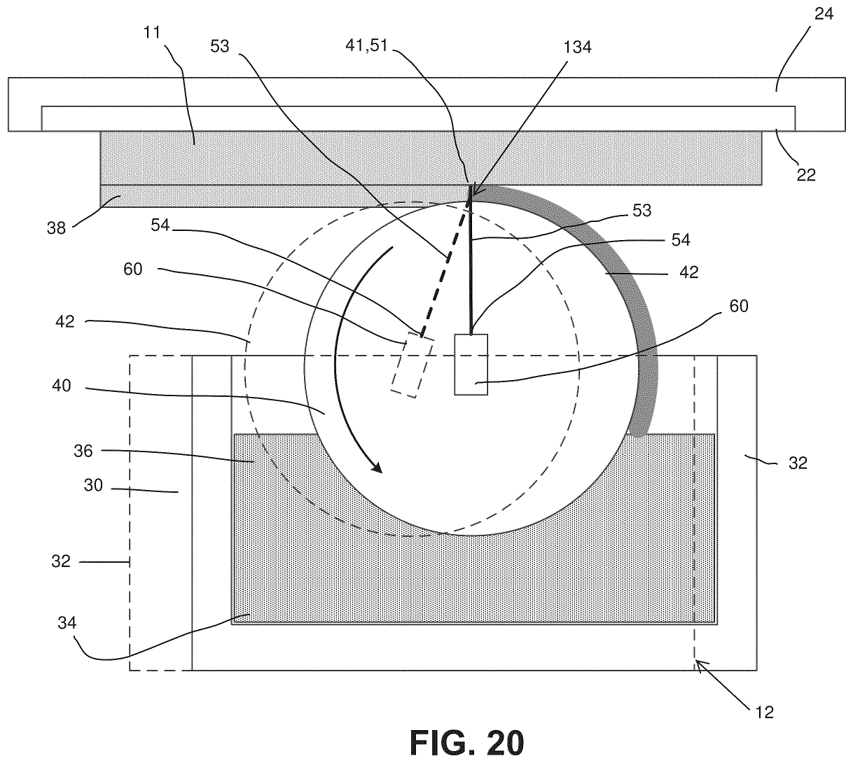

FIGS. 19 and 20 illustrate an embodiment of a deposition mechanism 30 with an exposure assembly 60 capable of directing the waves 53 offset from the application site 41. In the embodiment of FIGS. 19 and 20, the aim of the outlets 54 is adjusted along the direction of travel of the deposition mechanism as the applicator 40 passes the application site 41 to focus the waves 53 on a defined point 134 within the build area 22 as the applicator 40 passes the defined point 134, to increase the exposure time of the defined point 134. As illustrated in FIG. 19, the exposure assembly 60 is configured for continuously adjusting the aim of the outlets 54 rearwardly in the travel direction so that the aim of the outlets 54 tracks the defined point 134 and continue to focus on the defined point 134 after the applicator 40 (i.e., the apex of the roller 42 in this embodiment) passes the defined point 134. As illustrated in FIG. 20, the exposure assembly 60 is configured for continuously adjusting and re-adjusting the aim of the outlets 54 forwardly in the travel direction so that the aim of the outlets 54 tracks the defined point 134 in advance of the applicator 40 and continue to focus on the defined point until the applicator 40 (i.e., the apex of the roller 42 in this embodiment) arrives at the defined point 134. This creates moments of stationary exposure at the defined point 134, and it is understood that the start/stop aim angles may be based on factors such as build speed and the properties of the material 36. It is understood that the embodiments in FIGS. 19 and 20 may be combined so that the aim of the outlets 54 tracks the defined point 134 both in advance of and behind the arrival of the applicator 40 at the defined point 134.

In a further embodiment, an apparatus 12 as described herein may be enclosed within a sealed chamber that may be temperature controlled, pressure-controlled, humidity-controlled, and/or filled with a specific gas (including mixtures of gases). Temperature, pressure, and humidity control may be able to influence build speed and thereby improve efficiency. Additionally, the apparatus 12 has the ability to build hollow, sealed objects 11, and thus, selection of the environmental gas may permit production of a hollow, sealed object 11 filled with a specified gas. For example, such an object 11 filled with an inert gas may be useful, e.g., for aerospace applications.

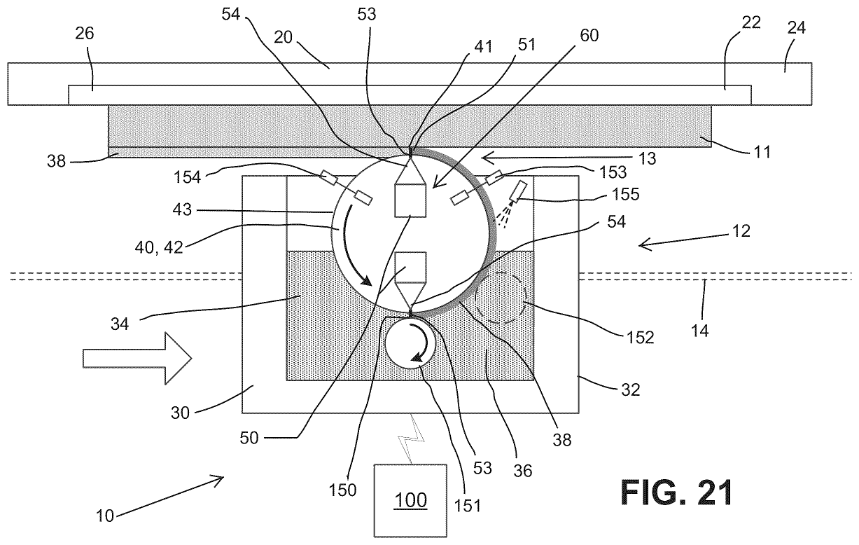

FIGS. 21-26 illustrate additional embodiments of a manufacturing apparatus 12 that is usable with a system 10 and method as described herein, and which may include any components of the system 10 and method according to any embodiments herein. For example, the apparatus 12 of the embodiments of FIGS. 21-26 may be connected to a computer controller 100 in communication with one or more components of the apparatus 12 and configured for controlling operation of the apparatus 12 and/or the components thereof to manufacture an object 11. The embodiments of FIGS. 21-26 have deposition mechanisms 30 that differ from the embodiments of FIGS. 1-20, including a supply 34 of flowable material 36, an applicator 40, an exposure assembly 60, and other components that are configured differently from other embodiments described herein. The supply 34, the applicator 40, the exposure assembly 60, and other components of the deposition mechanisms 30 illustrated in FIGS. 21-26 may be used in connection with other components and features of other embodiments described herein. The supply 34, the applicator 40, the exposure assembly 60, and other associated structures in the embodiments of FIGS. 21-26 may be incorporated into a deposition mechanism 30 and apparatus 12 as shown in FIGS. 1-4 and 6-13. For example, the supply 34, the applicator 40, and other associated structures in the embodiments of FIGS. 21-26 may be mounted on a carriage 32 and/or connected to other components of an exposure assembly 60 according to one or more of the embodiments shown and described herein to form a deposition mechanism 30, and that such a deposition mechanism 30 may be used in connection with a track 14 and/or a support assembly 20 according to one or more of the embodiments shown and described herein. It is understood that the apparatuses 12 in FIGS. 21-26 may be provided with any of the components, features, and functionality described herein with respect to other embodiments, including in particular, but without limitation, components, features, and configurations of the exposure assembly 60 and the exposure device 50, the carriage 32, various modular components, etc. Components that have already been described with respect to one or more embodiments herein may not be described again with respect to FIGS. 21-26 for the sake of brevity, and identical reference numbers may be used to reference components previously described.

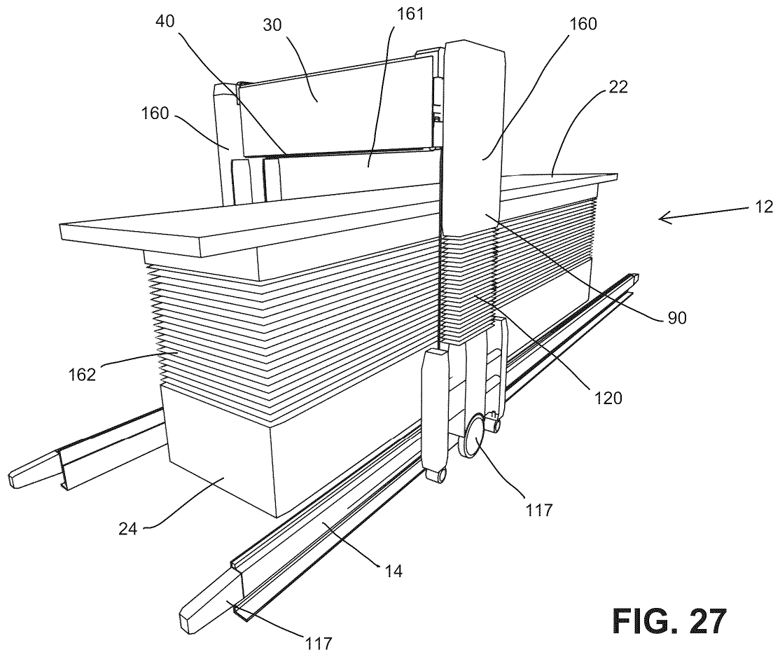

The deposition mechanisms 30 shown in FIGS. 21-26 may further be configured as part of an autonomous unit 90 according to one or more of the embodiments shown and described herein, and may have onboard a processor 2604, a memory 2612, and/or other computer components necessary for executing computer-executable instructions to automate the autonomous unit 90 and/or communicate with the computer controller 100. The deposition mechanisms 30 in FIGS. 21-26 may be incorporated into an autonomous unit 90 as shown FIGS. 6-13 with some modifications, and FIG. 27 illustrates an example of an autonomous unit 90 and associated system 10 configured to use the deposition mechanism 30 of FIG. 25, as described below.

The deposition mechanism 30 in FIG. 21 utilizes an initial exposure site 150 that at least partially forms the layer 38 prior to the material 36 reaching the application site 41, such that the exposure site 51 located at or near the application site 41 becomes a secondary exposure site 51 to bond the layer 38 to the object 11. In the embodiment of FIGS. 21-26, the initial exposure site 150 is located within the flowable material 36 (i.e., submerged). The deposition mechanism 30 in FIG. 21 includes a thickness limiter in the form of a secondary roller 151 spaced from the roller 42, such that the space between the roller 42 and the secondary roller 151 defines the thickness of the layer 38 formed at the initial exposure site 150. The apparatus 12 may include a mechanism for adjusting the spacing between the rollers 42, 151 in order to change the thickness of the layer 38, which may be a manual or automated mechanism as described herein. The secondary roller 151 in one embodiment may be made from a silicone rubber material, which generally has weak adhesion to most photo-curable resins. Other materials with weak adhesion properties to the solidified layer 38 may be used as well. In one embodiment, the material for the secondary roller 151 may be selected so as not to adhere to the layer 38 upon solidification. The secondary roller 151 may be opaque in the embodiment of FIG. 21, because the waves 53 need not penetrate the surface of the secondary roller 151. In fact, it may be desirable for the waves 53 not to penetrate the secondary roller 151 in order to avoid inadvertent solidification of the material 36. The secondary roller 151 may be configured to rotate such that the surface of the secondary roller 151 is moving in the same general direction and speed as the adjacent surface of the roller 42. The secondary roller 151 may be powered for such rotation in one embodiment or may be freely rotating in another embodiment. One or more additional secondary rollers 152 may be used in other embodiments (shown in broken lines in FIG. 21), and the additional secondary roller(s) 152 may be used to hold the layer 38 in place and/or provide an additional exposure site. The secondary roller 151 and the initial exposure site 150 are shown in FIG. 21 as being positioned at the bottom of the roller 42, opposite the application site 41, but this position may be changed in other embodiments. For example, placing the secondary roller 151 to the side of the roller 42 may reduce the necessary depth of the supply vat 34. In another embodiment, the deposition mechanism 30 in FIG. 21 may use a different type of thickness-limiting structure at the initial exposure site 150, such as a flat surface or other moving or non-moving surface. In a further embodiment, the deposition mechanism in FIG. 21 may not use any thickness-limiting structure at the initial exposure site 150, and layer thickness (depth of cure) at the initial exposure site 150 can be regulated without a thickness limiter, such as by adjusting the exposure intensity and or by using certain additives in the resin. A mechanism for adjusting the spacing between the roller 42 and the secondary roller 151 as discussed herein may also be used to move the secondary roller 151 away from the roller 42 and out of position for use at the initial exposure site 150, permitting the secondary roller 151 to be used selectively for initial exposure as desired.

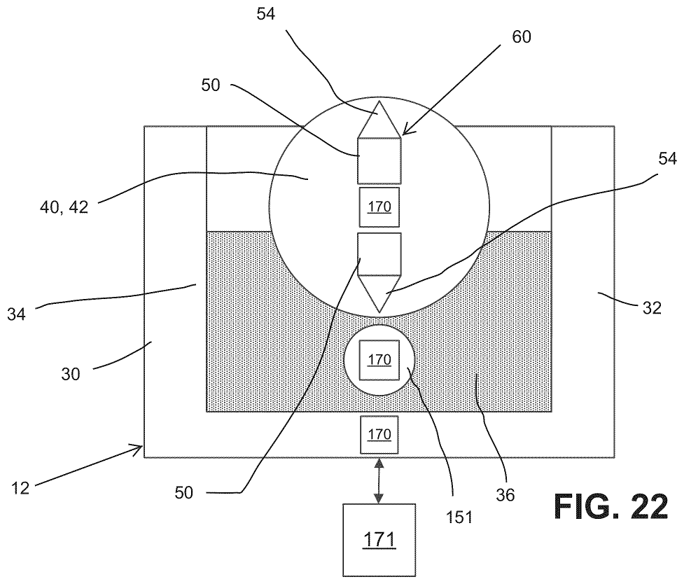

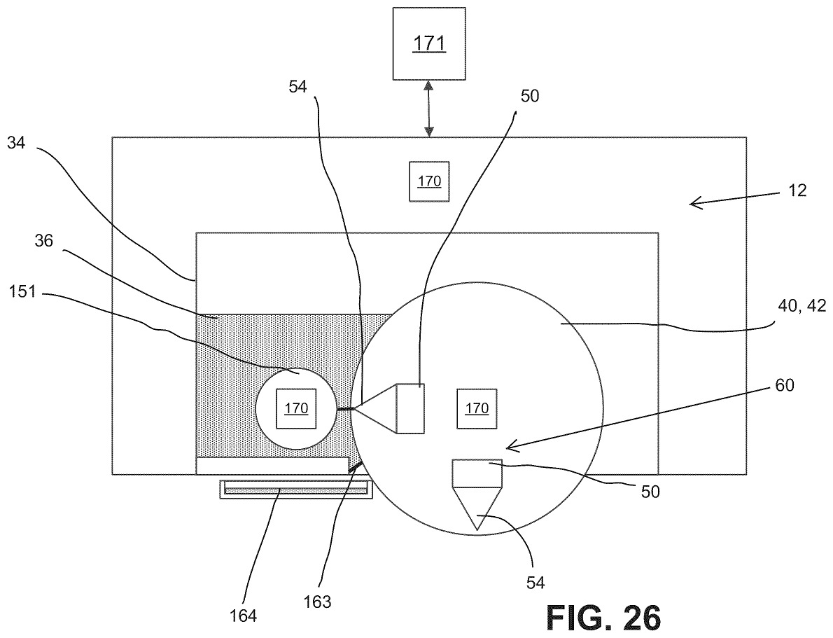

In the embodiments of FIGS. 22 and 26, the deposition mechanism 30 may include one or more temperature regulation elements 170 configured to control the temperature of the flowable material 36 in the supply vat 34. For example, some resins may function better at temperatures above ambient temperature, and the deposition mechanism 30 may include one or more heating elements to increase the temperature of the flowable material 36 to a more optimal temperature. As another example, solidification of the flowable material 36, such as by curing, may generate heat that will raise the temperature of the flowable material 36 to an undesirable level, particularly when the initial exposure site 150 is submerged beneath the flowable material 36. In this example, the deposition mechanism 30 may include one or more cooling elements to limit the temperature increase of the flowable material 36 and/or to cool the flowable material 36 to a more optimal temperature. The temperature regulation element(s) 170 may be placed in various locations, including within the supply vat 34, within or adjacent the walls of the supply vat 34, or within the roller 42 and/or the secondary roller 151. An example of such a temperature regulation element 170 is a fluid conduit circulating a heating or cooling fluid which may be supplied from an external source 171 of heating and/or cooling fluid, but other temperature regulation elements 170 may be used in other embodiments. The same conduit(s) may be used to selectively circulate heating or cooling fluid as desired. The deposition mechanism 30 in one embodiment may further include separate temperature regulation elements 170 configured for heating and cooling. In one embodiment, the temperature regulation element(s) 170 may initially be used to raise the temperature of the flowable material 36 to a suitable or optimal temperature for production of the article 11, but after heat builds up from extended solidification/curing, the temperature regulation element(s) may be used to reduce the temperature of the flowable material 36 and/or limit temperature increase to maintain a suitable or optimal temperature.

The exposure assembly 60 in FIG. 21 includes two exposure devices 50 each having its own outlet 54, such that one exposure device 50 emits waves 53 toward the initial exposure site 150 and the other exposure device 50 emits waves 53 toward the secondary exposure site 51 at the application site 41. In one embodiment, the exposure assembly 60 includes two arrays 55 of outlets 54 as described herein, each of which may be provided by an exposure device 50 in the form of an array 55 of LEDs 59 directed toward the exposure site 51, 150 or an array 55 of optical fibers 61 connected to an exposure device 50 in the form of a DLP projector or an array of LEDs 59. The exposure assembly 60 may further include focusing mechanisms 66 to focus the waves 53 between the outlets 54 and the exposure site 51, 150, as also described herein. The exposure devices 50 may be configured to selectively solidify portions of the flowable material 36 as described herein in order to produce each layer 38, such as by selective activation of specific outlets 54 and other techniques. In one embodiment, the exposure device 50 for the initial exposure site 150 may be configured to selectively activate outlets 54 to solidify the same portions of the layer 38 as the exposure device 50 for the secondary exposure site 51. In a further embodiment (not shown), some or all of the outlet(s) 54 for the initial exposure site 150 may be located inside the secondary roller 151, such that the secondary roller 151 has a structure similar to the roller 42 shown and described herein, e.g., as shown in FIGS. 1, 3A-4, and 6-13. It is understood that the exposure assembly 60 may be configured to advance or retard the exposure sites 51, 150 as desired, as described herein.

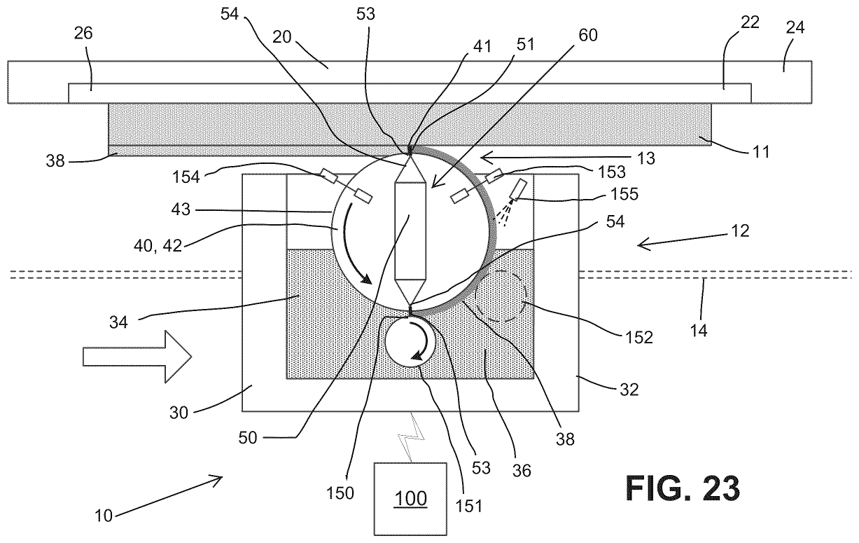

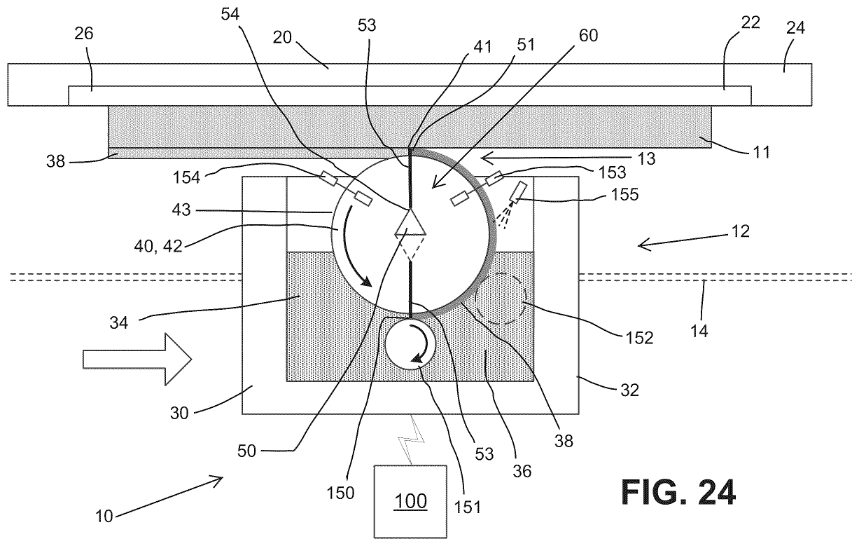

In other embodiments, the apparatus 12 and deposition mechanism 30 of FIG. 21 may be provided in a similar or identical configuration with an exposure assembly 60 having a different configuration. FIGS. 23-24 illustrate such similar or identical apparatuses 12 and deposition mechanisms 30 with different exposure assemblies 60, and it is understood that the embodiments of FIGS. 23-24 may include any of the components and features described herein with respect to FIG. 21. As with other embodiments described herein, the exposure device(s) 50 are schematically depicted as being located inside the roller 42 in FIGS. 21-24, but in many configurations, the exposure device(s) are located outside the roller 42 with the outlet(s) 54 located inside the roller 42. In the embodiment of FIG. 22, the exposure assembly 60 includes a single exposure device 50 that has two outlets 54 or arrays 55 of outlets 54 directed toward the two exposure sites 51, 150. For example, the exposure assembly 60 may include a single exposure device 50 in the form of an array of LEDs 59 or a DLP projector, with optical fibers 61 arranged and directed to form two arrays 55 of outlets 54 within the roller 42. In the embodiment of FIG. 24, the exposure assembly 60 includes a single exposure device 50 with a single outlet 54 or single array 55 of outlets 54, where the outlets 54 are moveable to direct the waves 53 at a desired exposure site 51, 150. For example, the outlets 54 (e.g., exit ends 63 of optical fibers 61 or LEDs 59) may be mounted on a gimbal or other rotatable structure and may use alternating strobing to achieve this functionality. In a further embodiment, the focusing mechanism 66 may include one or more moveable mirrors configured to reflect and/or direct the waves 53 toward the desired exposure site 51, 150, which may be moveable by mounting on a gimbal or other rotatable structure and may use alternating strobing to achieve this functionality. It is understood that other configurations of exposure assemblies 60 may be used in connection with the embodiments of FIGS. 21-24, including any configuration described herein with respect to another embodiment.

The deposition mechanism 30 in FIG. 21 operates by at least partially or completely solidifying the layer 38 at the initial exposure site 150, beneath the surface of the flowable material 36, at the desired thickness. The layer 38 is then carried upward to the application site 41 by the roller 42, and is then bonded to the object 11 and (if necessary) further solidified at the secondary exposure site 51. It is understood that the apparatus 12 may further include one or more additional secondary exposure devices 80, such as in FIG. 4, for further solidification of the layer 38. In one embodiment, the deposition mechanism 30 may be configured to encourage proper adhesion of the layer 38 at the proper time. For example, the secondary roller 151 may have an outer surface that has a lower adhesion property to the material forming the layer 38 than the outer surface 43 of the roller 42, to encourage the layer 38 to adhere to the roller 42 to be carried to the application site 41 rather than adhering to the secondary roller 151. Likewise, the outer surface 43 of the roller 42 may have a lower adhesion property to the material forming the layer 38 than the surface of the object 11 to encourage the layer 38 to adhere to the object 11 and/or the build platform 22, rather than adhering to the roller 42. The apparatus 12 in FIG. 21 also includes a removal device 155 for removal of excess uncured flowable material 36, which is in the form of an air wiper in FIG. 21 but may additionally or alternately include a squeegee or other mechanical removal device in other embodiments. The removal device 155 is configured to remove most, but not all, of the flowable material 36 from the layer 38, leaving a small amount of unsolidified material 36 on the layer 38 for bonding of the layer 38 to the object 11. The characteristics of the removal device 155, e.g., the angle and power of an air wiper, may be configured in order to ensure proper removal of the flowable material 36 without damaging or detaching the layer 38 from the surface(s) to which it is adhered. The removal device 155 may further be configured to direct removed material 36 back into the supply 34 to decrease waste. It is understood that additional removal devices 155 may be used, including at locations to remove flowable material 36 after the layer 38 is adhered to the object 11.

The apparatus 12 in the embodiment of FIG. 21 includes sensors to confirm proper operation of the deposition mechanism 30, such as build verification sensors 153 and transfer verification sensors 154. The build verification sensor 153 is positioned to scan the surface of the roller 42 between the initial exposure site 150 and the secondary exposure site 51 to confirm that the layer 38 was created and is adhered to the roller 42. The transfer verification sensor 154 is positioned to scan the surface of the roller 42 after passing the secondary exposure site 51 to confirm that the layer 38 separated from the roller 42 and adhered to the object 11. Both the build and transfer verification sensors 153, 154 may be an array of photosensors or other sensor(s) capable of detecting presence of the layer 38. If either of the sensors 153, 154 detects that the relevant actions were not completed properly, e.g., the build verification sensor 153 does not sense the layer 38 or the transfer verification sensor 154 does sense the layer 38 present, production can be stopped in order to address the problem and avoid a manufacturing defect that may not be discovered until much later. The use of the verification sensors 153, 154 helps to ensure reliable and accurate production of the object 11.

FIG. 25 illustrates another embodiment of an apparatus 12 and deposition mechanism 30 which is configured to build an object 11 on a build platform 22 located below the applicator 40. The embodiment of FIG. 25 includes many of the same components as the embodiments of FIGS. 21-24, including the secondary roller 151, the optional additional secondary roller(s) 152, the verification sensors 153, 154, and the removal device 155. These components share the same functions as in FIGS. 21-24, although some components are relocated in FIG. 25, and these components may not be described in detail with respect to FIG. 75. It is noted that the embodiment of FIG. 25 depicts the use of two exposure devices 50 each having an outlet 54 or array 55 of outlets 54, and that any configuration of an exposure assembly 60 described herein may be used in connection with the embodiment of FIG. 25, including any of the configurations in FIGS. 22-24. In the embodiment of FIG. 25, the supply 34 of the flowable material 36 holds the flowable material 36 above the application site 41 and in communication with only one side of the roller 42. The secondary roller 151 is positioned alongside of the roller 42 and immersed in the flowable material 36 to create an initial exposure site 150 between the roller 42 and the secondary roller 151. As described above, the spacing between the rollers 42, 151 determines the thickness of the layer 38. The layer 38 is then carried by the roller 42 over the top of the roller and down toward the application site 41 and the secondary exposure site 51 for bonding to the object 11 and/or the build platform 22. The deposition mechanism in FIG. 25 further includes a containment seal 163, such as a flexible lip or gasket, which resists leakage of the flowable material 36 downward out of the supply vat 34 at the junction between the supply vat 34 and the roller 42. In case some leakage may occur, a drip pan 164 is provided below the containment seal 163 to collect any flowable material 36 that passes through the seal 163. The drip pan 164 may be configured for returning the flowable material 36 to the supply vat 34, such as by using a pump mechanism or by being removable for dumping the flowable material 36 back into the supply vat 34. It is noted that the removal mechanism 155 in FIG. 25 is an air wiper configured to blow the excess material 36 back toward the supply 34.

The embodiments of FIGS. 21-26 using the additional solidification stage present advantages over existing additive manufacturing methods. For example, building the layer 38 before bonding to the object 11 permits improved shrink control during solidification. As another example, the additional solidification step avoids buildup of heat that may be involved in a curing process using fewer steps and produces a more fully cured/solidified layer 38. As a further example, at least the embodiments in FIG. 25 permits the production of an article 11 from the bottom upward, with the article 11 resting above the build platform 22, which can present advantages for production of many articles 11. The embodiments of FIGS. 21-26 are also capable of constructing an object 11 with only the minimum desired amount of flowable material 36 being incorporated into the object 11, because excess flowable material 36 can be removed from the layer 38 before bonding to the object 11. This minimizes the use of flowable material and increases cost-efficiency of the process. In one embodiment, up to 98% of excess resin is removed, allowing the part to be cleaned with detergent, rather than harsh chemicals. This also permits creation of an object with internal porosity, without unsolidified flowable material 36 being trapped in the internal interstices. The ability to produce such porous objects permits construction of objects with decreased weight and decreased material usage, increasing the versatility of the process and decreasing the cost of production. Such porous objects may also provide increased buoyancy, thermal insulation, and sound insulation properties, among other improved properties. The embodiments of FIGS. 21-26 may also be used to build a part with an internal honeycomb configuration, i.e., hexagonal cells (not shown). It is understood that objects 11 with internal porosity may include an external “shell” layer of solid (non-porous) material to form a smoother and more rigid exterior surface and resist ingress of moisture and other contaminants.

FIG. 27 illustrates an autonomous unit 90 and a build platform 22 configured to use a deposition mechanism 30 as shown in FIG. 25. The components of the autonomous unit 90 are the same as the unit 90 described herein and shown in FIGS. 6-13, and similar or identical components are not re-described with respect to this embodiment for the sake of brevity. The autonomous unit 90 in FIG. 27 is configured to hold a deposition mechanism 30 in which the application site 41 is at the bottom of the deposition mechanism 30. The unit 90 therefore has two legs 160 forming a space 161 between the legs 160, and the applicator 40 is configured to apply the layer 38 to build the object 11 in the space 161 between the legs 160 and below the applicator 40. FIG. 27 illustrates use of the autonomous unit 90 to build an object (not shown) on the build platform 22, such that the build platform 22 passes through the gap 161 during manufacturing. The height (z-position) of the deposition mechanism 30 is adjustable using the vertical adjustment mechanism 120 of the unit 90, and the height of the build platform 22 is also adjustable using a vertical adjustment mechanism 162 on the build platform 22. The combination of these adjustment mechanisms 120, 162 permit a great deal of relative movement between the deposition mechanism 30 and the build platform 22 for production of objects 11 having large heights.

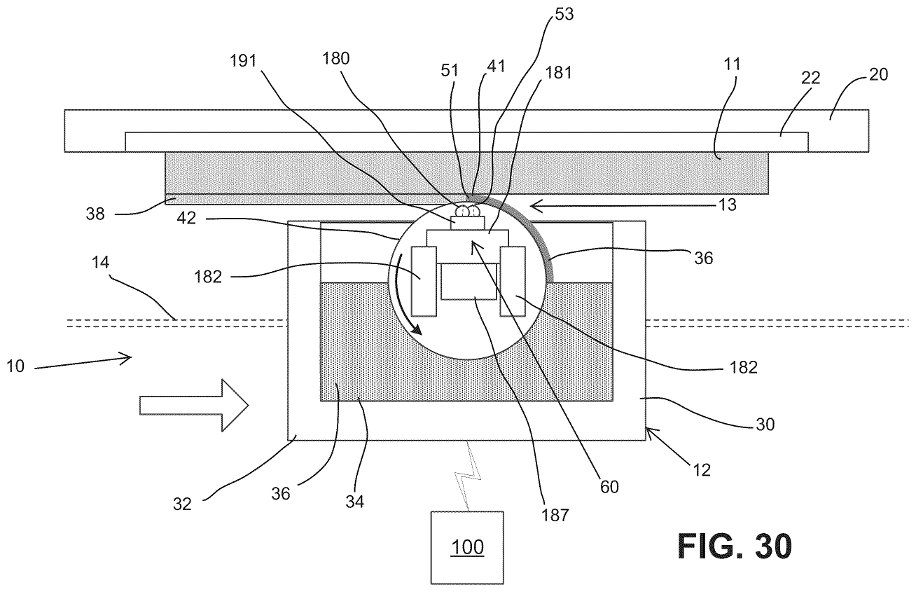

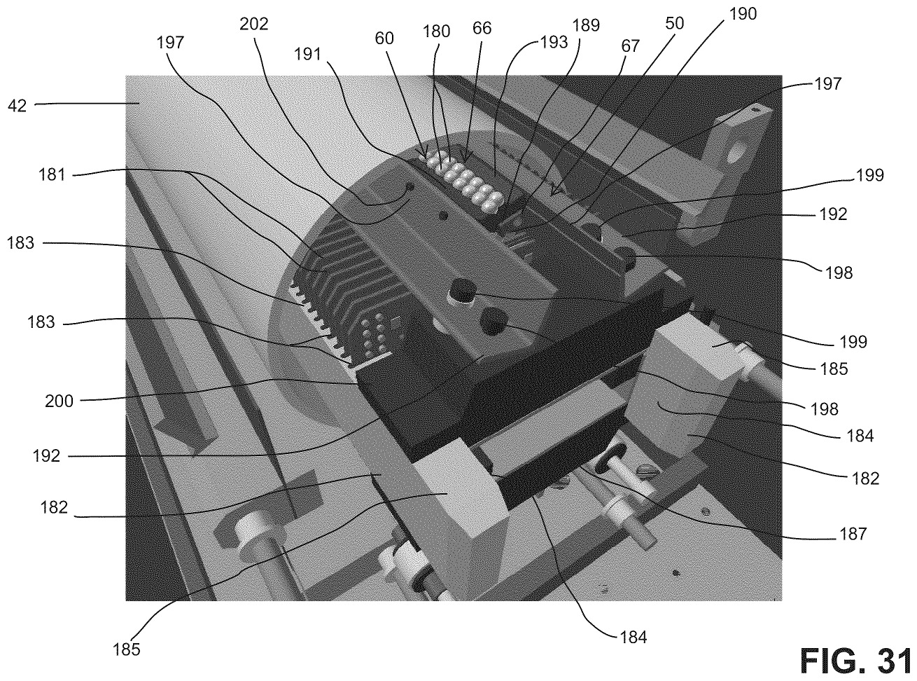

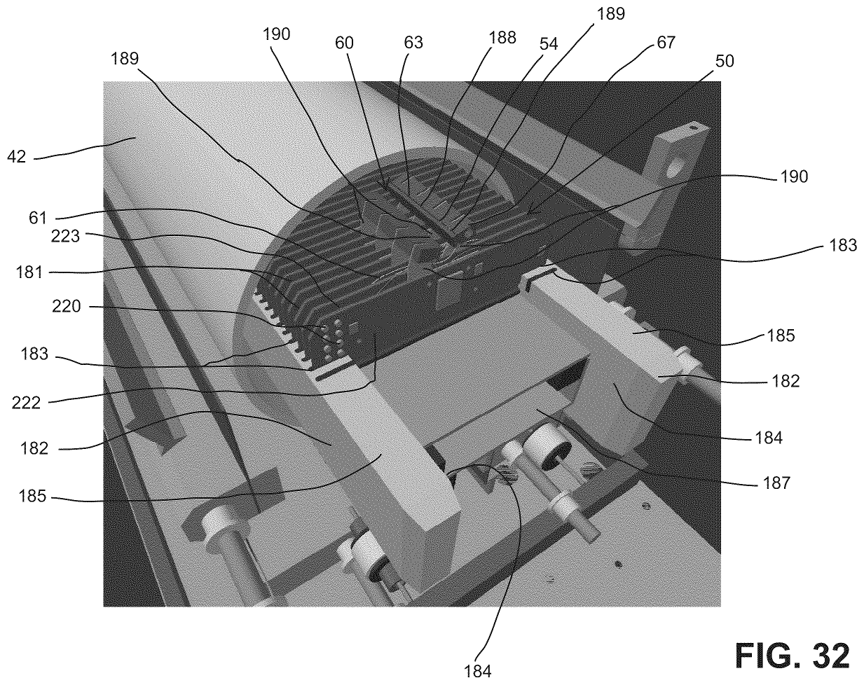

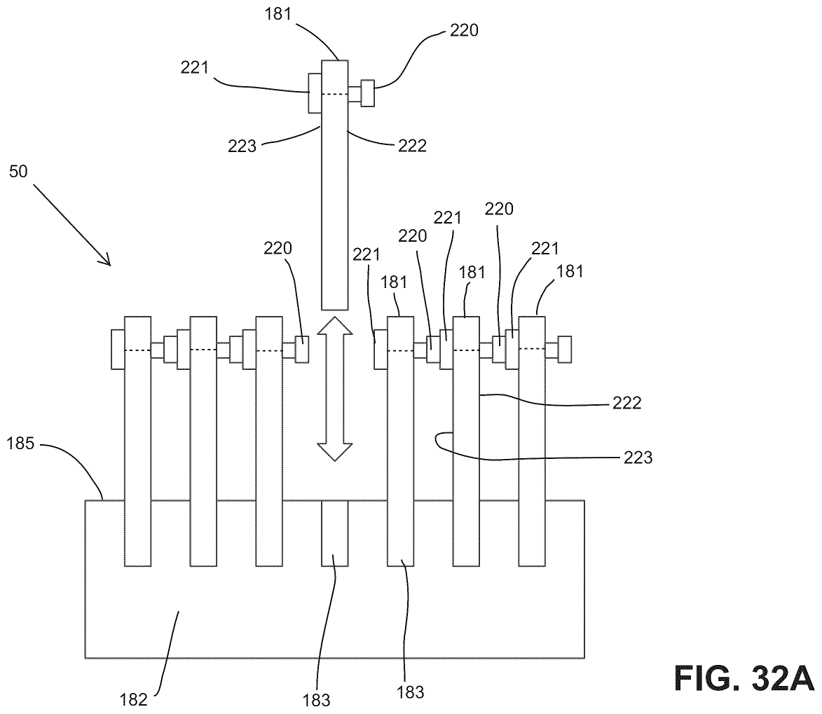

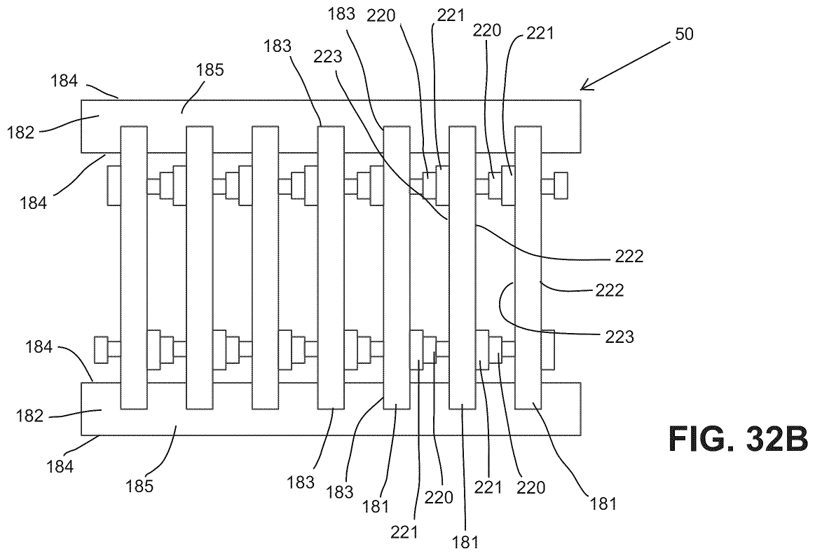

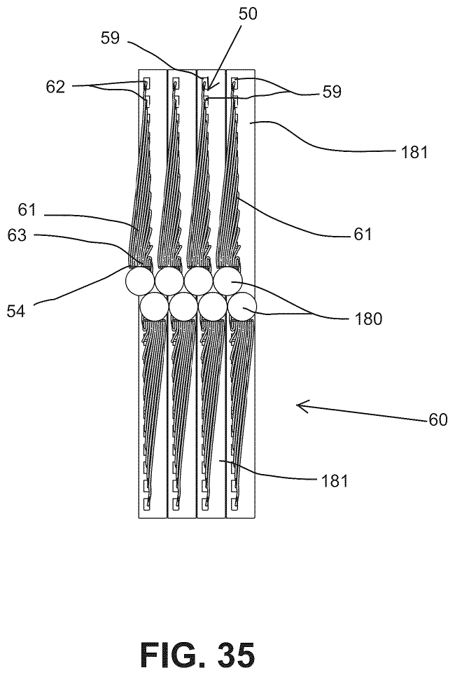

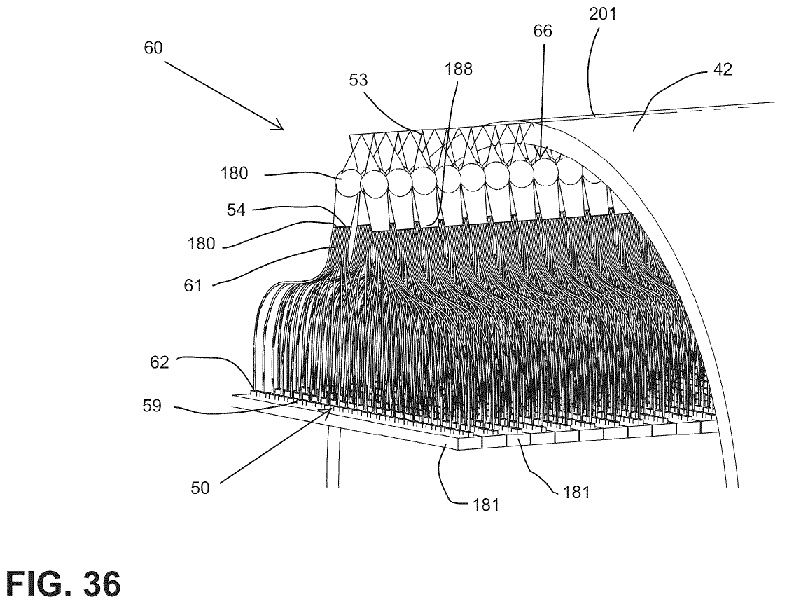

FIGS. 29-37 illustrate another embodiment of a deposition mechanism 30 that uses an exposure device 50 in the form of an array 55 of LEDs 59 with a focusing mechanism 66 that includes an array of ball lenses 180. FIGS. 29-30 illustrate the embodiment schematically, FIGS. 31-32 illustrate the embodiment in more specific technical detail, and FIGS. 32A-37 illustrate the embodiment in a partially-schematic manner. Each of the LEDs 59 in this embodiment is connected to an individual optical fiber 61 that has an exit end 63 forming a separate outlet 54 that emits waves 63 that are focused by the focusing mechanism 66 to be directed at a specific area of the exposure site 51. The LEDs 59 may function as described herein. It is understood that the LEDs 59 are not visible on the circuit boards 181 in FIGS. 31 and 32, and the LEDs 59 are illustrated schematically in FIGS. 35-36. The LEDs 59 in FIGS. 29-37 are connected to and powered by a plurality of circuit boards 181 that are positioned within the roller 42 and are mounted within the roller by a supporting structure that includes one or more supporting beams 182 extending axially within the roller 42. Each of the circuit boards 181 in FIGS. 29-37 includes twelve LEDs 59 connected to the circuit board 181 that are controlled by and supplied with power through the circuit board 181, with twelve optical fibers 61 each connected individually to one of the LEDs 59. It is understood that some or all of the LEDs 59 may be positioned outside the roller 42 in another embodiment.

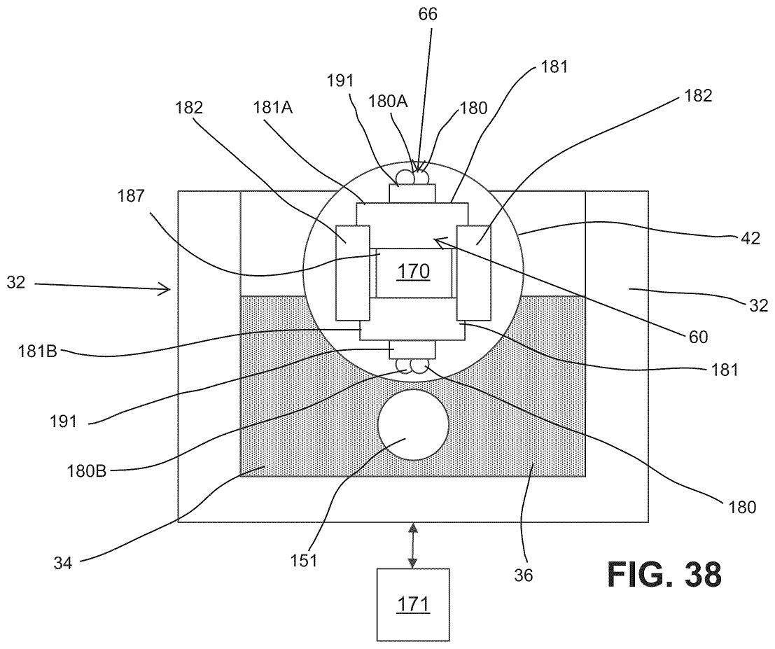

The supporting structure in FIGS. 29-37 includes a pair of spaced supporting beams 182 that each have a plurality of slots 183 on inwardly facing or confronting side surfaces thereof, such that the lateral edges of each circuit board 181 are received in opposed slots of the two beams 182. The circuit boards 181 in this configuration extend perpendicular to the direction of elongation of the beams 182, i.e., the axial direction of the roller 42. The slots 183 may also extend into the top and/or bottom surfaces of the beams 182, and may potentially extend through the beam 182 to the outward-facing side surface. In the embodiment of FIGS. 29-37, the slots 183 extend within the inward facing surfaces 184 and the top surfaces 185 of the beams 182, such that the beams 182 support a single row of circuit boards 181 between and above the beams 182. In another embodiment, illustrated in FIGS. 38-44 and described in greater detail elsewhere herein, the beams 182 may have additional slots 183 extending within the inward facing surfaces 184 and the bottom surfaces 186 of the beams 182 to support a second row of circuit boards 181 between and below the beams 182, forming upper and lower rows of circuit boards 181. It is understood that the upper and lower slots 183 may be continuous with each other, such that a single slot 183 may extend the entire height of the beam 182 and support an upper circuit board 181 and a lower circuit board 181. The beams 182 in FIGS. 29-37 are supported by the carriage 32 at their distal ends outside the axial ends of the roller 42 and extend at least the entire length of the roller 42. In the embodiment of FIGS. 29-37, the beams 182 also act as bus bars to provide power to all of the circuit boards 181. As such, each circuit board 181 includes electrical connecting structure for engaging the beams 182, and the beams 182 are electrically connected to a power source (not shown) at one or both ends. In an embodiment where the beams 182 act as bus bars, the carriage 32 may include electrically insulating supporting structure for supporting the beams 182 and/or electrical insulation structures between the beams 182 and any supporting structure. In other embodiments, the beams 182 may be used solely for support, with a different structure connected to provide power to the circuit boards 181, or a bus bar structure may be used for providing power to the circuit boards 181, with a different structure for structurally supporting the circuit boards 181. The supporting structure for the circuit boards 181 may also include internal supports positioned within the roller 42 for supporting the beams 182 at one or more points along their lengths. In other embodiments, the supporting structure may include additional or alternate structure for supporting the plurality of circuit boards 181 within the roller 42, including structures that support the circuit boards 181 in a different arrangement or orientation. In a further embodiment, the LEDs 59 may be arranged, powered, and/or controlled differently, and an arrangement of a plurality of circuit boards 181 may not be used.

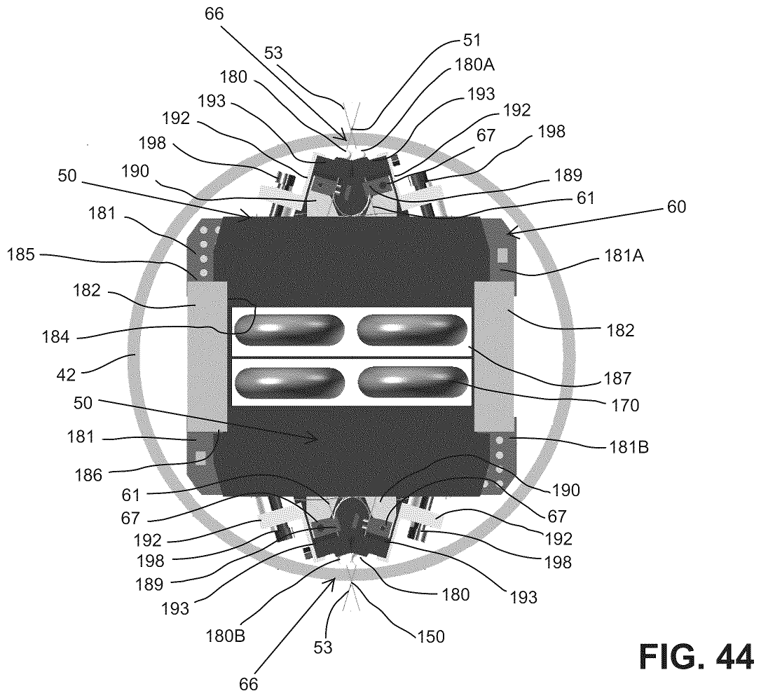

The deposition mechanism 30 may further include a compartment 187 adjacent the circuit boards 181, such as below the arrangement of circuit boards 181 in FIGS. 29-37, or between the upper and lower sets 181A, 181B of circuit boards 181 in FIGS. 38-44. The compartment 187 may include a temperature control element 170, such as a cooling element including a conduit for circulating a cooling fluid as described herein. In one embodiment, such a cooling element may assist in absorbing the heat generated by the LEDs during operation. FIG. 44 illustrates a temperature control element 170 in the form of a plurality of tubes of cooling fluid, positioned within the compartment 187. The compartment 187 is defined by one or more walls that are located between the beams 182 and may be supported by the beams 182 or by the same supporting structure that supports the beams 182 in some embodiments. The circuit boards 181 may abut or rest on the walls of the compartment 187 in one embodiment. The heating/cooling fluid may be supplied from an external source 171 of heating and/or cooling fluid, as shown in FIG. 38.

The optical fibers 61 are arranged such that each optical fiber 61 has its entrance end 62 located at one of the LEDs 59 and is configured to collect waves generated by the LED 59 to direct the waves to a desired point, e.g., the application site 41. The exit ends 63 of the optical fibers 61 are arranged in at least one row 188, and in the embodiment of FIG. 29-37, the exit ends 63 of the optical fibers 61 are arranged in two parallel rows 188 that are directed at an angle to each other such that the waves 53 emitted by the fibers 61 of each row can be focused to a single exposure site 51. The exit ends 63 of the optical fibers 61 may be gathered and held in place by one or more holders 67. In the embodiment of FIGS. 29-37, the exposure assembly 60 includes a plurality of holders 67, with each circuit board 181 having an individual holder 67 that gathers and arranged into a row 188 the exit ends 63 of the optical fibers 61 connected to the LEDs 59 on that respective circuit board 181. Each holder 67 includes a linear receiving slot 189 receiving the row 188 of optical fibers 61 in a single-file line, and the holder 67 is configured for clamping tightly against the fibers 61 received in the slot 189, such as by one or more screws or bolts that can adjust the width of the slot 189 by threaded advancement or retreat. In another embodiment, each holder 67 may hold multiple rows of optical fibers 61 in a close-packed arrangement, such as two rows of staggered or offset optical fibers 61 packed together.

Each of the circuit boards 181 in FIGS. 29-37 has an arm 190 connected to the circuit board 181 and extending upward from the circuit board 181, with a holder 67 connected at the end of the arm 190. In this configuration, each circuit board 181 forms an integrated LED assembly, with a plurality of LEDs 59, a plurality of optical fibers 61 connected to the LEDs 59, and a holder 67 for holding all of the exit ends 63 of the optical fibers 61. Each such LED assembly may be individually connected to or removed from the exposure assembly 60 by inserting the circuit board 181 into the slots 183 or removing the circuit board 181. The holders 67 and the arms 190 are positioned off center with respect to the circuit boards 181, and the circuit boards 181 in FIGS. 29-37 are similar or identical to each other and arranged in an alternating arrangement, such that each circuit board 181 is flipped (i.e., rotated 180° about the z-axis) with respect to the adjacent circuit boards 181. In this configuration, the holders 67 are arranged in two parallel rows, and each holder 67 is positioned adjacent the holder(s) 67 of the second-to-next circuit board(s) 181 in each direction along the row 188, i.e., the closest circuit board(s) 181 having the same orientation. The adjacent holders 67 in FIGS. 29-37 contact each other such that the adjacent holders 67 form a continuous row 188 of optical fibers 61, and in one embodiment, the holders 67 that contact each other may be removably connected to each other. In the configuration of FIGS. 29-37, the exit ends 63 of the optical fibers 61 form a linear row of outlets 54 of the exposure device 50.

The circuit boards 181 in FIGS. 29-37 are also electrically connected to each other in series, and the circuit boards 181 have a plurality of contact terminals for electrical connection to adjacent circuit boards 181 and/or main power connections of the deposition mechanism 30. In this embodiment, each circuit board 181 has terminals 220, 221 on opposing surfaces 222, 223, including one or more first terminals 220 on a first surface 222 and one or more second terminals 221 on a second surface 223 opposite the first surface 222. The first terminal(s) 220 of each circuit board 181 engages the second terminal(s) 221 of the adjacent circuit board 181 proximate the first surface 222, and second terminal(s) 221 of each circuit board 181 engages the first terminal(s) 220 of the adjacent circuit board 181 proximate the second surface 223. FIG. 32A illustrates this configuration schematically, with the terminals 220, 221 of adjacent circuit boards 181 contacting each other to allow transmission of power and/or data to and from each circuit board 181 in sequence. The terminals 220, 221 are in surface-to-surface abutment, so one or more circuit boards 181 may be removed and replaced easily, with the new circuit board 181 re-establishing the same connections, as shown in FIG. 32A. In one embodiment, each circuit board has a plurality of first terminals 220 in the form of spring pins arranged on the first surface 222 proximate one lateral edge, as shown in FIG. 32, and a single second terminal 221 in the form of a contact pad (not shown in FIG. 32) on the second surface 223 proximate the same lateral edge, which is configured to engage one or more of the first terminals 220. In another embodiment, each circuit board 181 may additionally have terminals 220, 221 along the opposite lateral edge, and the positioning of such terminals on the first and second surfaces 222, 223 may be the same or reversed on both lateral edges. FIG. 32B shows an embodiment where the positions of the terminals 220, 221 are reversed on the opposed lateral edges, with each circuit board 181 having one or more first terminals 220 and one or more second terminals 221 proximate opposite lateral edges of the first surface 222, and one or more second terminals 221 and one or more first terminals 220 proximate opposite lateral edges of the second surface 223. In the configurations described herein, a power source may be connected only to the front circuit board 181, or only to both the front and rear circuit boards 181, in order to power all of the circuit boards 181.

The focusing mechanism 66 in the embodiment of FIGS. 29-37 includes a plurality of ball lenses 180 that are arranged in an array along each of the rows 188 of the optical fibers 61. The ball lenses 180 in the embodiment of FIGS. 29-37 are configured to reduce the image passing through the lens 180, and the ball lenses 180 may therefore be considered to represent an embodiment of a reducing lens. Other types of reducing lenses may be used in other embodiments, such as convex lenses. In further embodiments, other types of lenses may be used, such as a rod lens or a plurality of rod lenses (which may not reduce the image). In one embodiment, as shown in FIGS. 31-32, each ball lens 180 is associated with one of the circuit boards 181, and each ball lens 180 is configured to focus all of the outlets 54 associated with the respective circuit board 181. In the configuration of FIGS. 31-32, each ball lens 180 is positioned to receive and focus waves 53 emitted from twelve different outlets 54 connected to twelve different LEDs 59 on the circuit board 181. In another embodiment, as shown in FIGS. 35-37, each circuit board 181 is associated with two ball lenses 180, with half of the outlets 54 associated with each circuit board 181 being directed to and focused by each of the two ball lenses 180. For example, each circuit board 181 may supply waves 53 to a first ball lens 180 in the first row 188 and to a second, adjacent ball lens 180 in the second row 188. This configuration is illustrated in FIGS. 35-37. In this configuration, each circuit board 181 includes two holders 67 associated with two different ball lenses 180 in opposite rows 188, and half of the optical fibers 61 connected to the circuit board 181 extend to each of the holders 67. In one embodiment, as shown in FIGS. 35-37, each circuit board 181 includes twenty-four LEDs 59, with twelve optical fibers 61 extending to each ball lens 180. It is understood that FIGS. 35-37 do not illustrate the holders 67, but it is understood that the holders 67 are configured similar or identical to the holders 67 shown in FIGS. 31-32 and described herein, with each holder 67 being mounted on an arm 190 connected to the circuit board 181 and having a receiving slot 189 that holds the exit ends 63 of the optical fibers 61. It is also understood that each circuit board 181 in the embodiment of FIGS. 35-37 may have two arms 190 connected thereto, with each arm 190 extending toward one of the rows 188 and having one of the two holders 67 mounted on the respective arm 190. In a further embodiment, each circuit board 181 may supply waves 53 to two adjacent ball lenses 180 in the same row 188, or to more than two ball lenses 180 in one or both rows 188. In any of these configurations, the exit ends 63 of the optical fibers 61 associated with each ball lens 180 are positioned beneath the respective ball lens 180.

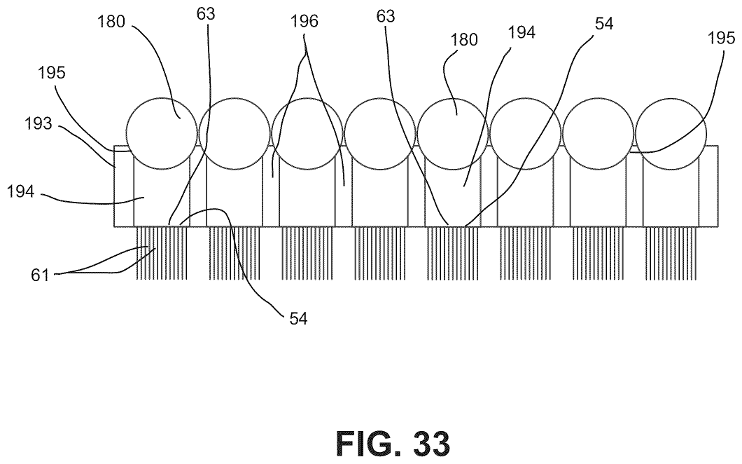

The focusing mechanism 66 includes a lens mounting structure 191 that engages and supports the ball lenses 180 and mounting beams 192 supporting the lens mounting structure 191 in an adjustable manner. The lens mounting structure 191 includes one or more bodies 193 that support the lenses 180 and guide or channel the waves 53 from the outlets 54 to the lenses 180. The lens mounting structure 191 of FIGS. 29-37 includes two parallel rows of bodies 193 positioned over the two rows 188 of optical fibers 61, with each body 193 having a plurality of receivers 195 that each receive a portion of one of the ball lenses 180 and a plurality of conduits or tunnels 194 each extending through the body 193 from the outlets 54 to one of the receivers 195. Each of the rows of bodies 193 includes a plurality of bodies 193 positioned end-to-end along the row adjacent to and/or in contact with each other, with each body 193 supporting a plurality of ball lenses 180 (e.g., 8 lenses in one embodiment). In this configuration, waves 53 exit the outlets 54 and travel through the conduit 194 aligned with the respective outlet 54 to the reach the ball lens 180 in the receiver 195, where the waves 53 are focused to the exposure site 51. FIG. 33 illustrates schematically an example of one of the bodies 193 of FIGS. 29-37, and in this configuration, the body 193 includes a plurality of internal walls 196 that separate the conduits 194. The walls 196 may have limited or no permeability to the waves 53, such that the conduits 194 are isolated from each other with regard to transmission of the waves 53. The conduits 194 are hollow in FIG. 33, but in other embodiments, the conduits 194 may be filled with a material that is permeable to the waves 53. In another embodiment, each of the two rows of bodies 193 in FIGS. 29-37 may be formed by a plurality of aligned bodies 193 that are arranged to have a single body 193 for each circuit board 181 and respective ball lens 180. In a further embodiment, the focusing mechanism 66 may include a single body 193 for each row, or a single body 193 for both rows together, that includes all of the receivers 195 and conduits 194.

The bodies 193 in FIGS. 29-37 are each mounted on one of the two mounting beams 192, which run parallel to the support beams 182 and the rows 188 of optical fibers 61 and are elevated above the tops of the circuit boards 181. The mounting beams 192 have inward-facing walls 197 that are angled with respect to the vertical (Z) direction, and the bodies 193 are mounted on the walls 197, such as by fasteners 202 that extend through the walls 197, as shown in FIG. 31. Each of the mounting beams 192 in this configuration has a plurality of bodies 193 mounted thereon and runs approximately the entire length of the supporting beams 182 that support the circuit boards 181. Each of the mounting beams 192 in FIGS. 29-37 is supported at the ends and includes an adjustment mechanism at one or both ends for adjusting the positioning of the mounting beams 192 and thereby the positions of the mounting bodies 193 and the ball lenses 180 for focusing and alignment purposes. The adjustment mechanisms shown in FIGS. 31-32 include a pair of screws, including an adjustment screw 198 that adjusts the position of the mounting beam 192 along the axis of the adjustment screw 198 and a locking screw 199 that locks the mounting beam 192 when in the proper position. The mounting beams 192 in FIGS. 31-32 are each illustrated with an adjustment screw 198 and a locking screw 199 at one end, but it is understood that a similar structure may be positioned at the other end as well. In an embodiment where the support beams 182 are used as bus bars, the mounting beams 192 may be mounted on a structure that provides electrical insulation from the support beams 182, such as the electrically insulated mounting block 200 illustrated in FIGS. 31-32.

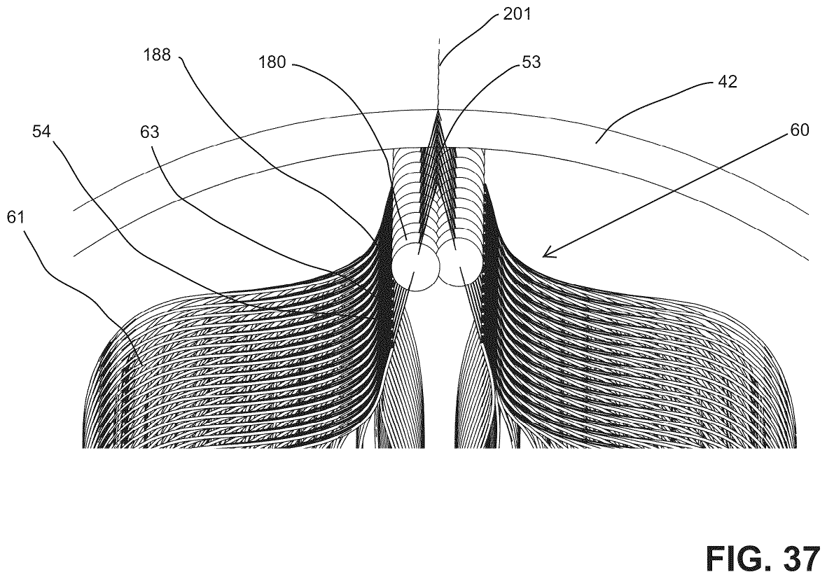

The ball lenses 180 in the embodiment of FIGS. 29-37 are arranged in a staggered or offset array, with two rows of ball lenses 180 that are offset from each other in both the x-direction and the y-direction. Each of the lenses 180 is overlapped laterally (i.e., in the y-direction) by at least one other lens 180, and each lens 180 (other than the lenses 180 on the ends of the array) is centered in the y-direction between two adjacent lenses 180 on the opposite row of lenses 180. In other words, each of the lenses 180 as shown in FIGS. 29-37 overlaps approximately 50% of the width of the closest lenses 180 on the opposite row. The lenses 180 may overlap slightly in the x-direction as well, and in one embodiment, the lenses 180 are close-packed, such that each lens 180 contacts or is in close proximity to the lenses 180 in the same row on both lateral sides and also contacts or is in close proximity to the two overlapping lenses on the opposite row. Additionally, in one embodiment, the outlets 54 and the lenses 180 are positioned and oriented to focus the waves 53 from both of the rows 188 of outlets 54 along approximately a single exposure line 201 extending in the y-direction at the exposure site 51, as shown in FIGS. 36-37. The staggered arrangement of the ball lenses 180 enables the exposure line 201 to be created without gaps, even when the image is reduced by the ball lenses 180. The exposure line 201 in this embodiment is instantaneous, monolithic, and straight, despite the offset of the lenses 180 as described herein. It is understood that the outlets 54 and the ball lenses 180 may be configured such that the exposure line 201 is located at or outward from the outer surface of the roller 42, e.g., at the apex of the roller 42. It is also understood that the lenses 180 may be arranged and configured to create the exposure line 201 at a different location if a different type of applicator 40 is used.

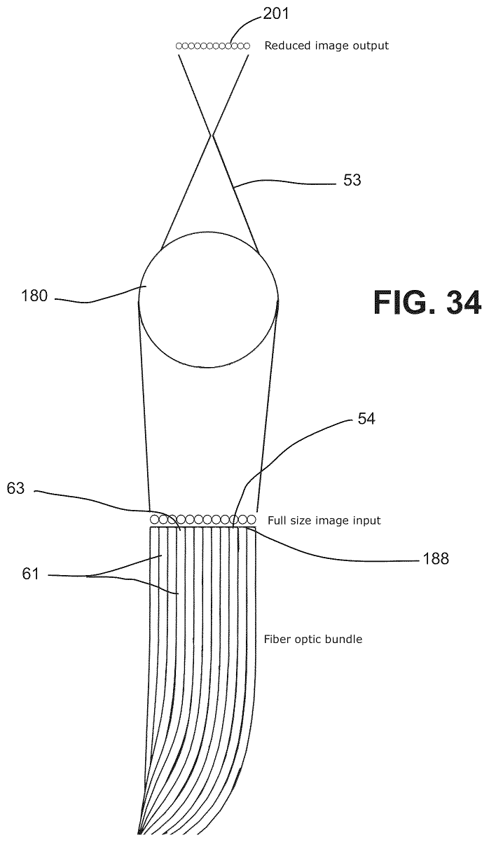

The ball lenses 180 in the embodiment of FIGS. 29-37 focus waves 53 from a plurality of linearly-arranged outlets 54 (e.g., optical fibers 61 connected to LEDs 59) into a linear image at the exposure site 51. FIGS. 34 and 36-37 illustrate the focusing of the ball lenses 180 in greater detail. As shown in FIG. 34, the ball lens 180 inverts and reduces the image emitted by the outlets 54, e.g., reducing the image by 50% in one embodiment. Reducing the size of the image emitted by the outlets 54 provides multiple benefits, including increasing the intensity of the waves 53 at the exposure site 51 and improving the resolution of the exposure device 50. This combination of benefits creates an exposure assembly 60 with both high resolution and high power for rapidly curing the material 36, improving performance of the deposition mechanism 30 significantly. It is understood that an array of ball lenses 180 configured according to the embodiments described herein may also be used with a differently-configured exposure assembly 60 to provide similar benefits.

FIGS. 35-37 schematically illustrate the roller 42, the optical fibers 61 forming the outlets 54, and the ball lenses 180, showing the waves 53 emitted by the outlets 54 and the image produced at the exposure site 51 by this structure. As seen in FIGS. 36-37, the waves 53 form the image in the form of a straight line of exposure at or near the outer surface of the roller 42. The inversion of the image by the ball lenses 180 is also illustrated in FIG. 34.

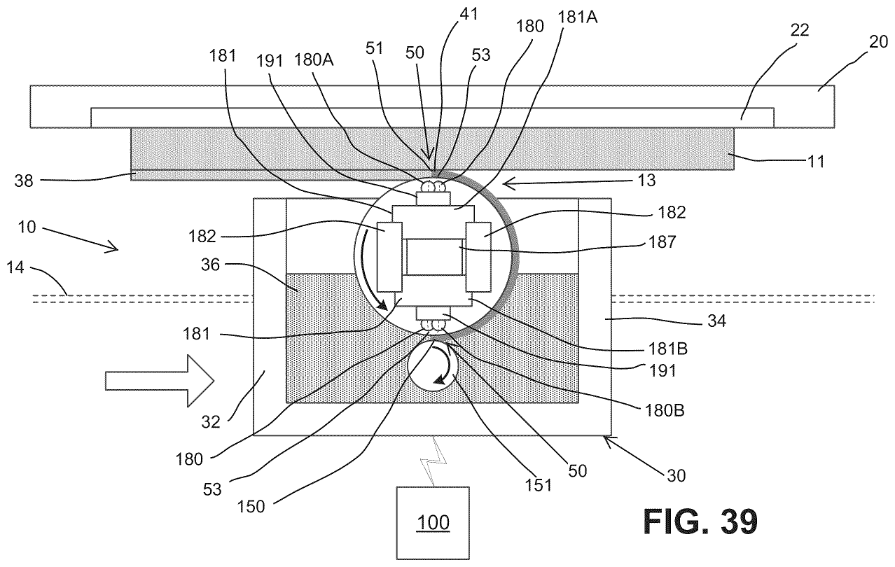

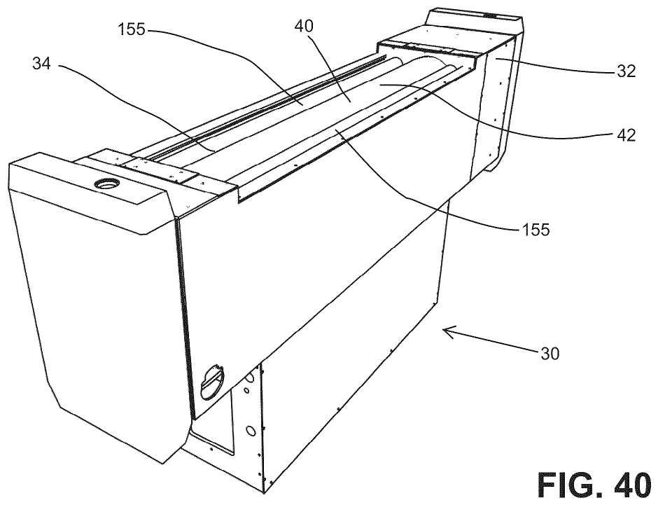

FIGS. 38-44 illustrate another embodiment of a deposition mechanism 30 that includes components and features similar to the deposition mechanism 30 of FIGS. 29-37 and the deposition mechanisms 30 of FIGS. 21-24 and is described herein using the same reference numbers for similar or identical components. It is understood that the embodiment of FIGS. 38-44 may be described, in part, with reference to the disclosure of FIGS. 21-24 and 29-37, and that such similar or identical components may not be described again for the sake of brevity. FIGS. 38-39 illustrate a schematic embodiment of this configuration, and FIGS. 40-44 illustrate a technical embodiment of this configuration.

The deposition mechanism 30 in FIGS. 38-44 includes both a primary roller 42 and a secondary roller 151 as in the embodiments of FIGS. 21-24, and the exposure assembly 60 in FIGS. 38-44 includes two different exposure devices 50 with two different outlets 54 or sets of outlets 54, similar to the embodiment of FIG. 21. The exposure devices 50 and outlets 54 in the embodiment of FIGS. 38-44 are located within the roller 42 as similarly shown in FIG. 21. Each exposure device 50 in FIGS. 38-44 is in the form of an array 55 of LEDs 59 that are connected to, controlled by, and powered through a plurality of circuit boards 181, as similarly described above with respect to FIGS. 29-37. It is understood that the embodiment of FIGS. 38-44 is described as having two exposure devices 50, although the two arrays 55 of LEDs may more broadly be considered to be a single, larger array 55 and a single exposure device 50. In the embodiment of FIGS. 38-44, the circuit boards 181 are arranged in an upper set 181A of circuit boards 181 and a lower set 181B of circuit boards 181 that are each arranged in an axially extending row. The supporting structure for the circuit boards 181 includes support beams 182 that have slots 183 as described herein that extend on the inward facing surfaces 184 of the beams 182, as well as both the top and bottom surfaces 185, 186 of the support beams 182. The slots 183 on the top surface 185 in this embodiment receive the upper set 181A of circuit boards 181, and the slots 183 on the bottom surface 186 receive the lower set 181B of circuit boards 181. The compartment 187 in this embodiment is located between the upper and lower sets 181A,B of circuit boards 181. The upper set 181A of circuit boards 181 is configured as a first exposure device 50 that is configured to emit waves 53 toward the exposure site 51, and the lower set 181B of circuit boards 181 is configured as a second exposure device 50 that is configured to emit waves 53 toward the initial exposure site 150 as described herein. In another embodiment, a single set of circuit boards 181 may control and power an array 55 of LEDs 59 that are connected to both the upper and lower arrays of optical fibers 61.

The focusing mechanism 66 for the upper set 181A of circuit boards 181 in the embodiment of FIGS. 38-44 is configured the similar to the focusing mechanism 66 described herein with respect to FIGS. 29-37. Like the embodiment of FIGS. 29-37, the focusing mechanism 66 in this embodiment uses reducing lenses in the form of ball lenses 180. The exposure assembly 60 further includes a second focusing mechanism 66 for the lower set 181B of circuit boards 181 that is also configured the same as the focusing mechanism 66 described herein with respect to FIGS. 29-37. In other words, the second focusing mechanism 66 in this embodiment includes one or more holders 67 that have linear slots 189 that collect and arrange the ends 63 of the optical fibers 61 into two parallel rows 188. These additional holders 67 are mounted on arms 190 connected to and extending from the circuit boards 181 of the lower set 181B. The focusing mechanism 66 also includes a second or lower array 180B of reducing lenses in the form of ball lenses 180 that are mounted by a lens mounting structure 191 and mounting beams 192 supporting the lens mounting structure 191 in an adjustable manner, in addition to the upper array 180A of ball lenses 180 as described herein with respect to FIGS. 29-37. The lens mounting structure 191 for the second/lower array 180B of ball lenses 180 in FIGS. 38-44 includes one or more bodies 193 that support the ball lenses 180 and guide or channel the waves 53 from the outlets 54 to the lenses 180, as similarly described herein with respect to the embodiment of FIGS. 29-37. The structure and configuration of the lens mounting structure 191 and the mounting beams 192, including any adjustment mechanisms, for the lower array 180B of ball lenses 180 may be an inverted (but otherwise identical) version of the structure and configuration of the lens mounting structure and the mounting beams 192 for the upper array 180A of ball lenses 180. The lens mounting structure 191 and mounting beams 192 of this embodiment are shown in FIG. 44, and it is understood that certain structures, including the lens mounting structure 191 and mounting beams 192, are not shown in FIGS. 38-43.

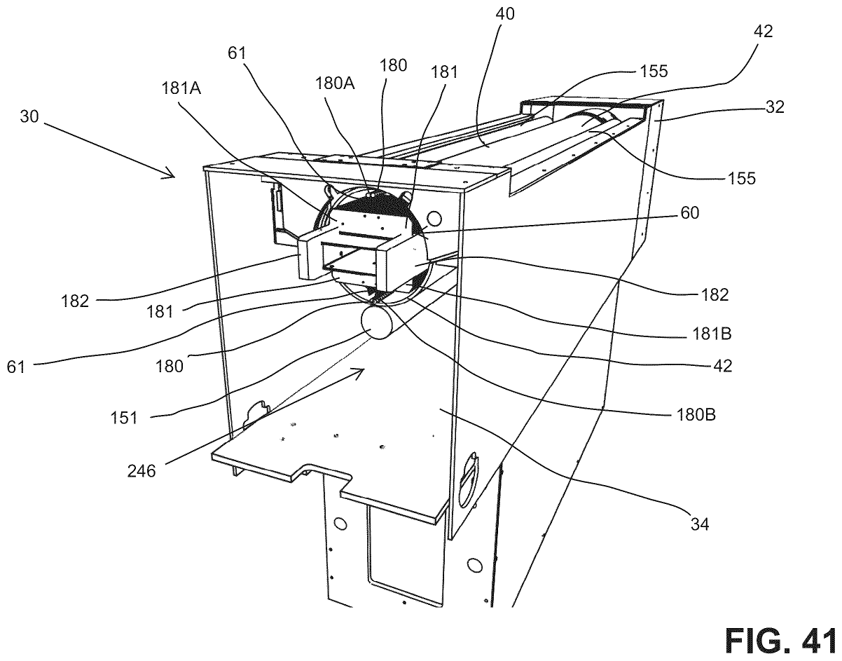

The ball lenses 180 in the embodiment of FIGS. 38-44 are arranged such that each circuit board 181 in both the upper and lower sets 181A, 181B is associated with two ball lenses 180, with half of the outlets 54 associated with each circuit board 181 being directed to and focused by each of the two ball lenses 180, as described herein with respect to FIGS. 35-37. In one embodiment, as shown in FIGS. 41-43, each circuit board 181 includes twenty four LEDs 59, with twelve optical fibers 61 extending to each ball lens 180. It is understood that FIGS. 41-43 do not illustrate the holders 67, but it is understood that the holders 67 are configured similar or identical to the holders 67 shown in FIGS. 31-32 and described herein, with each holder 67 being mounted on an arm 190 connected to the circuit board 181 and having a receiving slot 189 that holds the exit ends 63 of the optical fibers 61. It is also understood that each circuit board 181 in the embodiment of FIGS. 41-43 may have two arms 190 connected thereto, with each arm 190 extending toward one of the rows 188 and having one of the two holders 67 mounted on the respective arm 190. In another embodiment, each circuit board 181 may include a single holder 67 and be associated with a single ball lens 180, as described herein with respect to FIGS. 31-32. In a further embodiment, each circuit board 181 may supply waves 53 to two adjacent ball lenses 180 in the same row 188, or to more than two ball lenses 180 in one or both rows 188.

The circuit boards 181 in each set 181A, 181B in FIGS. 38-44 may be configured with electrically connected terminals 220, 221 as described herein with respect to the embodiment of FIGS. 29-37. Additionally, the configuration described herein with the outlets 54 of one circuit board 181 supplying waves 53 to two adjacent ball lenses 180 in opposite rows 188 may also be used in both sets 181A, 181B in the embodiment of FIGS. 38-44.

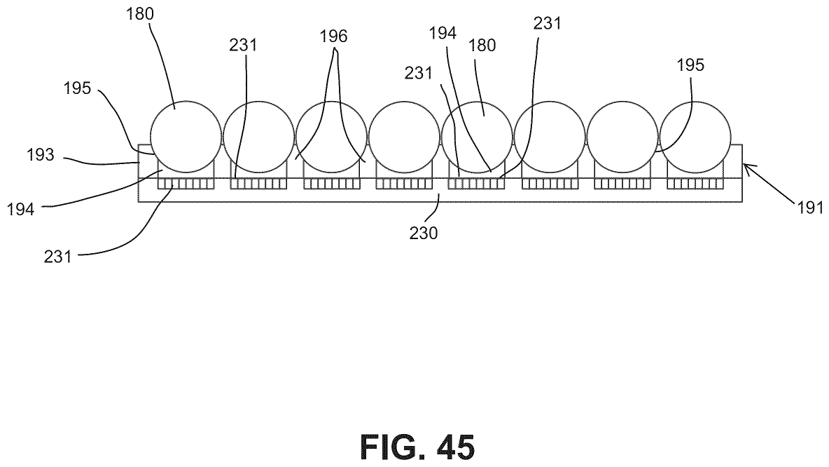

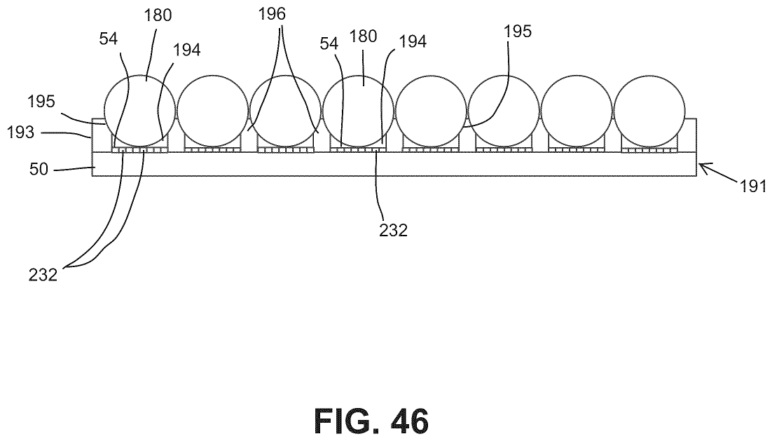

In other embodiments, the focusing mechanism 66 may be configured for use with a different type of exposure assembly 60 with one or more different exposure devices 50. For example, as shown in FIGS. 45 and 46, the focusing mechanism 66 may be used with an exposure assembly 60 that does not include optical fibers 61 directing the waves 53 to the lenses 180. In one such embodiment, as shown in FIG. 45, the focusing mechanism 66 may further include a mirror array 230 that includes a plurality of mirrors 231 for directing the waves from the outlet or outlets (not shown) of the exposure device 50 to the lenses 180. For example, the mirrors 231 may be in the form of a plurality of micro-mirrors. This embodiment may be used with or without optical fibers 61, and the mirror array 230 may be used in connection with any exposure device 50 discussed herein, including lasers or LCD. In another such embodiment, as shown in FIG. 46, the exposure device 50 may have outlets 54 that are located proximate the lenses 180 and/or are supported by the lens mounting structure 191, due to the source of the waves 53 being positioned proximate the lenses 180. For example, as shown in FIG. 46, the exposure device 50 may include an array of micro-LEDs 232 configured to emit waves 53 toward the lenses 180. While only the micro-LEDs 232 emitting waves 53 into the ball lenses 180 are illustrated in FIG. 46, it is understood that the exposure device 50 may be in the form of a light wand or similar device that includes additional micro-LEDs 232 that are not activated during use. In another example, the exposure device 50 shown in FIG. 46 may be a micro LCD display (backlit), or any other device that is capable of creating an addressable array of points of emitted waves 53 at the focal plane of the lens 180.

The focusing mechanisms 66 in FIGS. 45 and 46 include many features in common with the embodiment of FIGS. 29-37, and some of such features of FIGS. 45 and 46 may not be described in detail again for the sake of brevity. As in the embodiment of FIGS. 29-37, the lens mounting structure 191 includes one or more bodies 193 that support the lenses 180 and guide or channel the waves 53 from the outlets 54 or the mirrors 231 to the lenses 180. It is understood that the lens mounting structure 191 in FIGS. 45 and 46 can be used similarly to the lens mounting structure 191 in FIGS. 29-37, such as by including two parallel rows of bodies 193 positioned over the two rows 188 of outlets 54 or mirrors 231, with each body 193 having a plurality of receivers 195 that each receive a portion of one of the ball lenses 180 and a plurality of conduits or tunnels 194 each extending through the body 193 from the outlets 54 or mirrors 231 to one of the receivers 195. Each of the rows of bodies 193 includes a plurality of bodies 193 positioned end-to-end along the row adjacent to and/or in contact with each other, with each body 193 supporting a plurality of ball lenses 180 (e.g., 8 lenses in one embodiment). In this configuration, waves 53 exit the outlets 54 or reflect from the mirrors 231 and travel through the conduit 194 aligned with the respective outlet 54 or mirror 231 to the reach the ball lens 180 in the receiver 195, where the waves 53 are focused to the exposure site 51. The body 193 may include a plurality of internal walls 196 that separate the conduits 194, as described herein. As also noted herein, the conduits 194 may be hollow or filled with a material that is permeable to the waves 53.

The secondary roller 151 may be configured and operated in accordance with any embodiment described herein. In another embodiment, the exposure assembly 60 of FIGS. 38-44 may be used in connection with a differently configured deposition mechanism 30 configured for both initial and final exposures, including an embodiment where a secondary roller 151 is not used for the initial exposure. For example, as discussed herein, a different type of thickness limiter may be used for the initial exposure, or the initial exposure may be conducted without a thickness limiter layer thickness (depth of cure) at the initial exposure site 150 can be regulated without a thickness limiter, such as by adjusting the exposure intensity and or by using certain additives in the resin. A mechanism for adjusting the spacing between the roller 42 and the secondary roller 151 as discussed herein may also be used to move the secondary roller 151 away from the roller 42 and out of position for use at the initial exposure site 150, permitting the secondary roller 151 to be used selectively for initial exposure as desired. Likewise, the secondary roller 151 may be moved into direct contact with the roller 42, to be used for stiffening and/or reinforcement of the roller 42 (e.g., when using high viscosity resins), rather than being used for an initial exposure. It is understood that the outlets 54 and focusing mechanisms 60 may not be configured for using exposure sites 51, 150 that are oriented 180° away from each other, such as the embodiments in FIGS. 25 and 26. In a further embodiment, the outlets 54 and the focusing mechanism 66 (including the ball lenses 180) as well as any supporting and adjusting structure therefor may be positioned within the secondary roller 151, and the circuit boards 181 and/or LEDs 59 may also be positioned within the secondary roller 151. The deposition mechanism 30 may further include a position sensor (not shown) for the secondary roller 151 that can sense any position changes, which may indicate debris on the secondary roller 151, such as resin that failed to transfer to the roller 42. This may indicate a build failure, and the operation of the deposition mechanism 30 can be stopped based on movement of the secondary roller 151 detected by the position sensor, until the situation can be addressed.

The deposition mechanism 30 in FIGS. 38-44 may also include a removal device 155 for removal of excess uncured flowable material 36, as described herein. In one embodiment, the removal device 155 may be in the form of additional rollers that rotate opposite to the rotation of roller 42 to move excess flowable material 36 off of the roller 42, as shown in FIGS. 40-41. Other types of removal devices 155 may be used in the embodiment of FIGS. 38-44, including any other configurations shown and/or described herein, e.g., a wiper or air knife. Multiple different types of such removal devices 155 may be used in combination in one embodiment. It is understood that other embodiments of deposition mechanisms, including the embodiment in FIGS. 29-37, may also use one or more removal devices 155 as shown and/or described herein.

The exposure assembly 60 in FIGS. 29-37 and the exposure assembly 60 in FIGS. 38-44, including the support beams 182, the circuit boards 181, the compartment 187, the temperature control element 170, the lens mounting structure(s) 191, the mounting beams 192, and the ball lenses 180, as well as potentially additional supporting structures, are each configured as a unitary assembly that can be inserted into the roller 42 and removed from the roller 42 as a unitary piece. In one embodiment, the unitary assembly may be connected to the carriage 32 and may be removable from the roller 42 by removing the roller 42, the vat 34, the secondary roller 151 (if present), and other components as part of a removable resin application module 110 as shown in FIG. 7 and described above. In another embodiment, the unitary assembly may be removably connected to the carriage 32 such that the unitary assembly is disconnected from the carriage and removed from within the roller 42.

In one embodiment, the deposition mechanism 30 may have an exposure assembly 60 with two (or more) different exposure devices 50 that are arranged on rotatable or other moveable mechanism to permit the direction of emission of the waves 53 for each exposure device to be changed. The exposure assembly 60 may be configured similar or identical to the exposure assembly 60 of FIGS. 38-44, such as including two (or more) sets 181A, 181B of circuit boards 181 and two (or more) arrays 180A, 180B of ball lenses 180 associated with the sets 181A, 181B of circuit boards 181. The aims of the exposure devices 50 may be oriented at 180° to each other in one embodiment, or may be arranged at different angles in another embodiment. In one configuration, substantially the entire exposure assembly 60, including at least the support beams 182, the sets 181A, 181B of circuit boards 181, the lens mounting structure(s) 191, the mounting beams 192, and the sets 180A, 180B of the ball lenses 180, as well as potentially additional supporting structures, is mounted on a rotating mechanism that rotates within the roller 42 to change the direction of emission of both the upper and lower exposure devices 50 simultaneously, as described above. This assembly may be mounted on a gimbal for such rotation/tilting, as similarly described herein and shown in FIG. 18. In another embodiment, each exposure device 50 may be individually moveable, including the circuit boards 181, the accompanying ball lenses 180, and other supporting structure. Changing the direction of emission in this manner can serve multiple functions. As one example, the position of the initial exposure site 150 may be changed, such as to move the initial exposure site 150 to a different thickness limiter or to direct the initial exposure site 150 to a location without a thickness limiter. As another example, the position(s) of the exposure site 51 and/or the initial exposure site 150 may be advanced or retarded as discussed herein with respect to FIG. 18. As a further example, the aim of the exposure devices 50 may be adjusted to focus the waves 53 on a defined point 134 within the build area 22 as the applicator 40 passes the defined point 134, to increase the exposure time of the defined point 134, as described herein with respect to FIGS. 19-20. As yet another example, the exposure devices 50 may be configured for emitting waves 53 having different characteristics, e.g., different wavelength, different power, different focus or image reduction/enlargement, etc., and the mechanism can direct the exposure devices 50 so the exposure device 50 emitting waves 53 with the desired characteristics is used for the exposure site 51 and/or the initial exposure site 150. In an embodiment such as shown in FIGS. 38-44, the two exposure devices 50 could be selectively and alternately directed at the exposure site 51 or the initial exposure site 150 as desired, through the use of such a mechanism. It is understood that further functionality can be achieved by this mechanism.

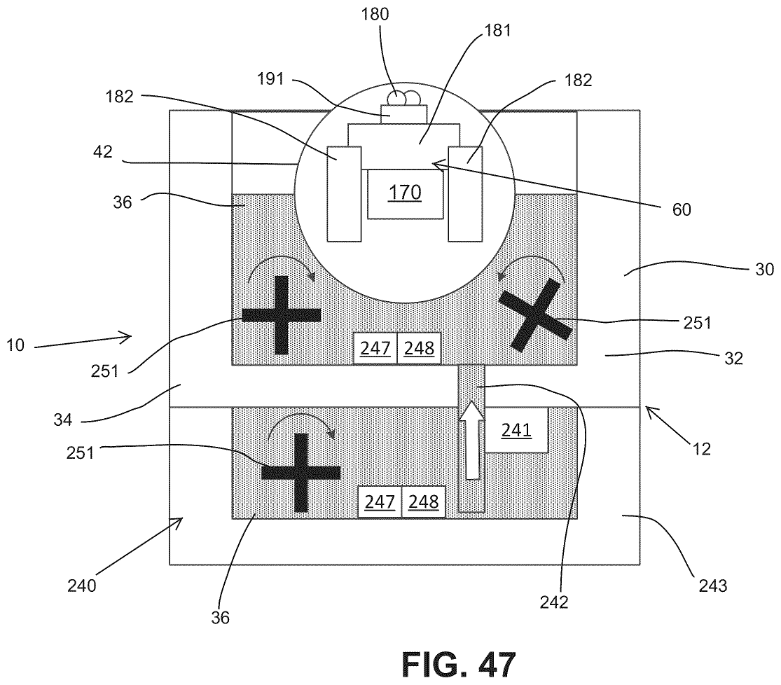

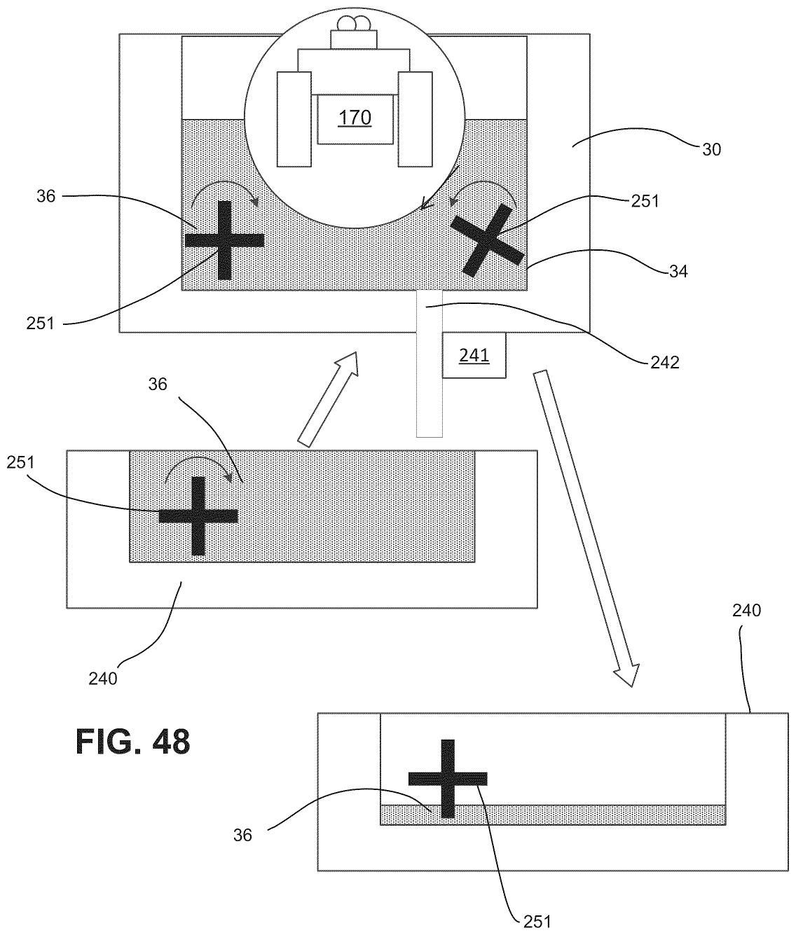

FIGS. 47-49 illustrate another embodiment of a deposition mechanism 30 that uses an applicator 40 and an exposure device 50 as shown in FIGS. 29-37, but which may use other applicators 40 and/or exposure devices 50 disclosed herein. In this embodiment, the deposition mechanism 30 has a reservoir 240 in communication with the supply 34 of flowable material 36, which is configured to transfer additional flowable material 36 to the supply 34 during use. The deposition mechanism 30 in FIGS. 47-49 is provided with a pump 241 for pumping the flowable material 36 through a conduit 242 to the supply 34. It is understood that the conduit 242 may include a one-way valve (not shown) or other structure configured to resist passage of the flowable material 36 from the supply 34 back into the reservoir 240. The reservoir 240 in FIGS. 47-49 includes a vat 243 that is removable from the supply 34 and which may also be interchangeable with other reservoirs 240, as shown in FIG. 48. The reservoir 240, the carriage 32, and/or the supply 34 may have engaging structures for mounting the reservoir 240 in place, which may include complementary engaging structures such as tab/slot arrangements, interlocking pegs or tabs, hooks, etc. This permits an empty reservoir 240 to be removed and replaced with a full reservoir 240, or removed and refilled before being reconnected to the supply 34. In another embodiment, the reservoir 240 may have an inlet (not shown) for filling the reservoir 240 while still connected to the supply 34, which permits the reservoir 240 to be permanently connected to the supply 34 if desired. It is understood that a removable reservoir 240 could also be provided with an inlet, such that removal may be optional.

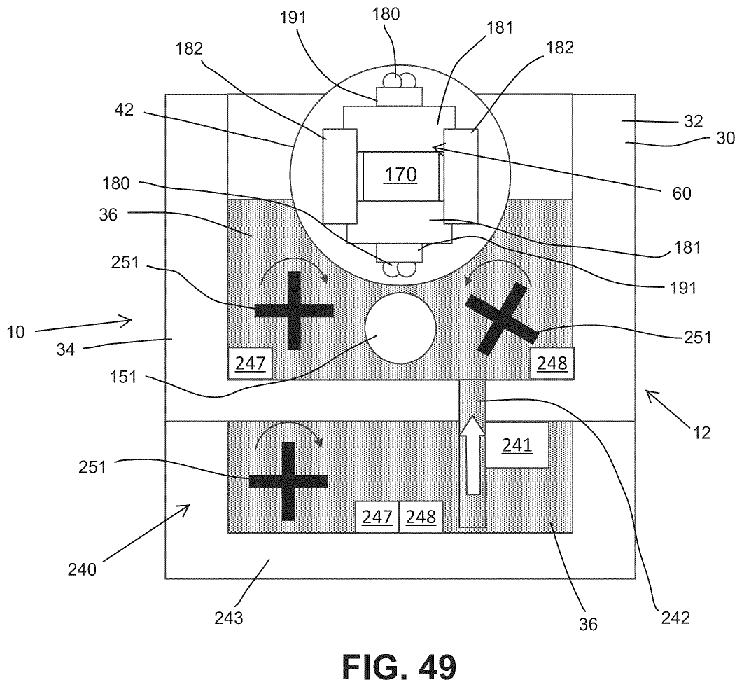

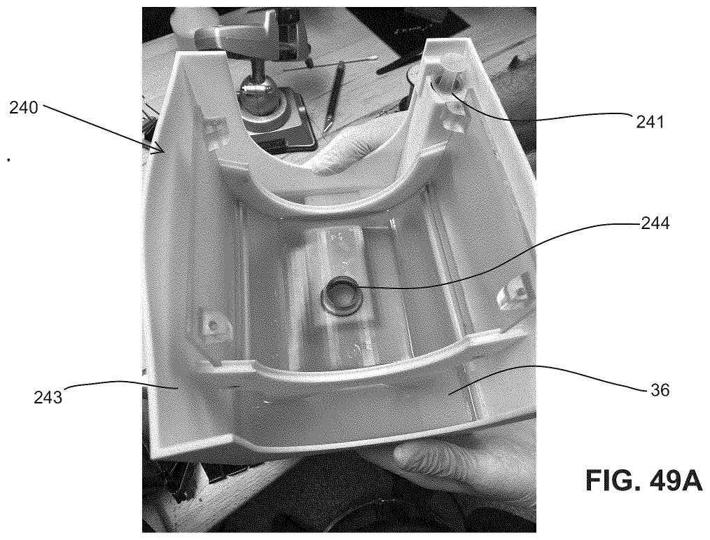

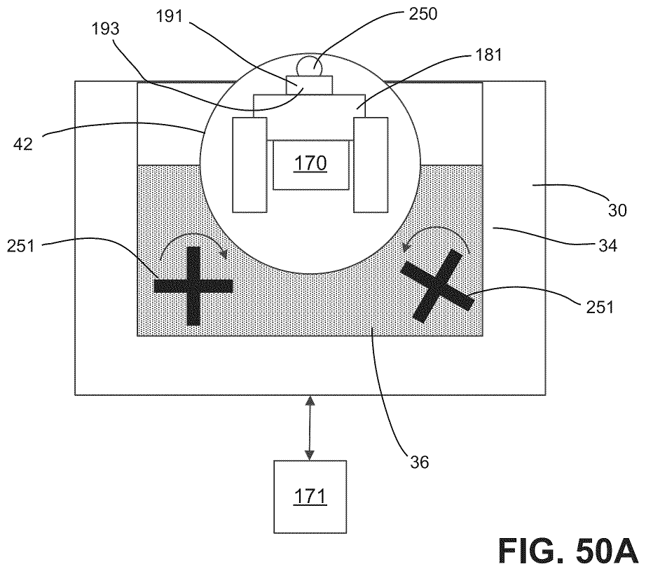

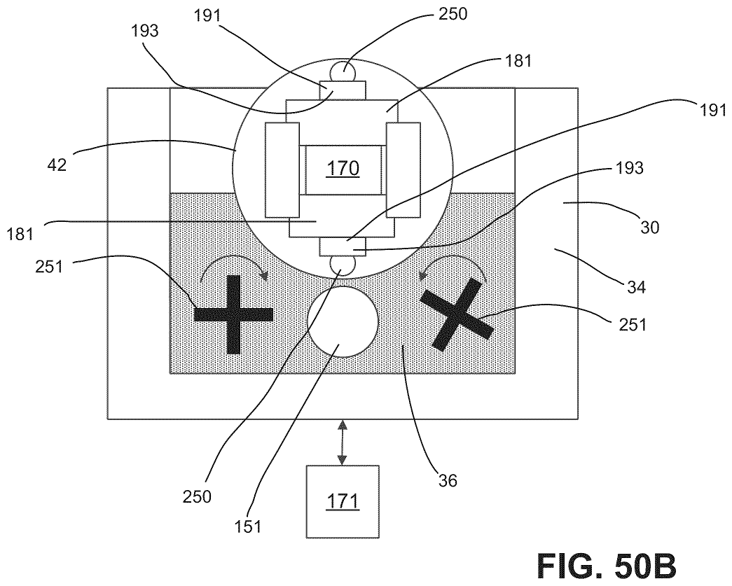

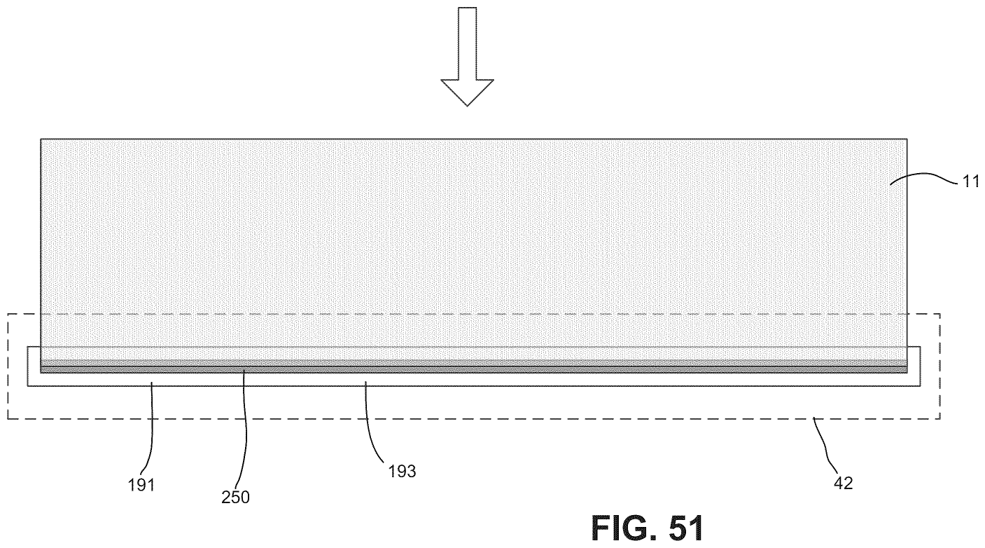

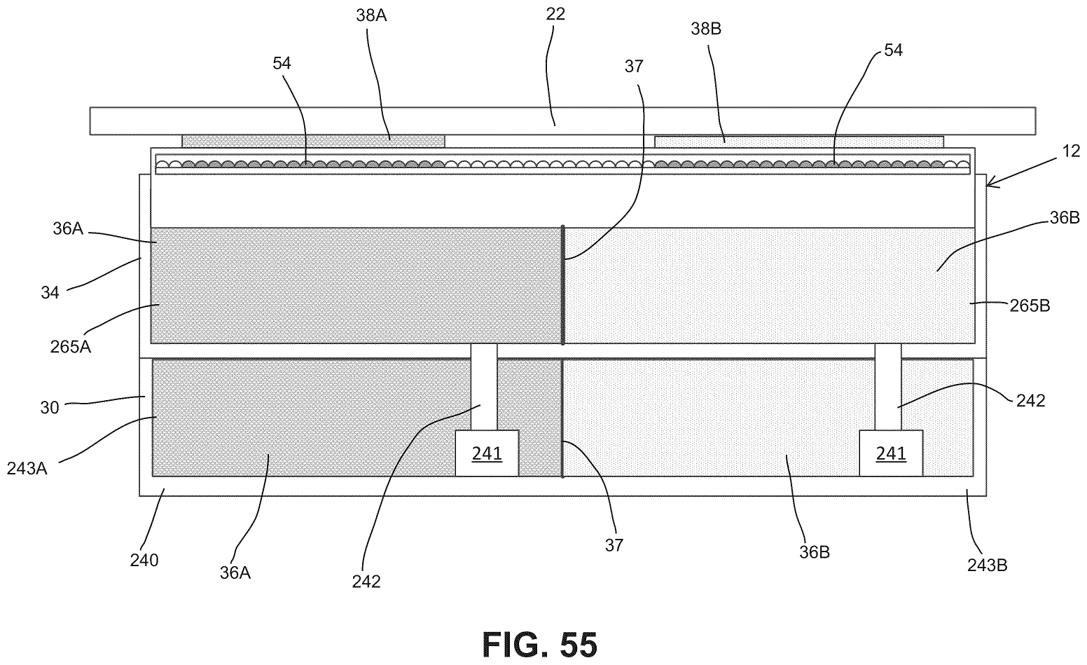

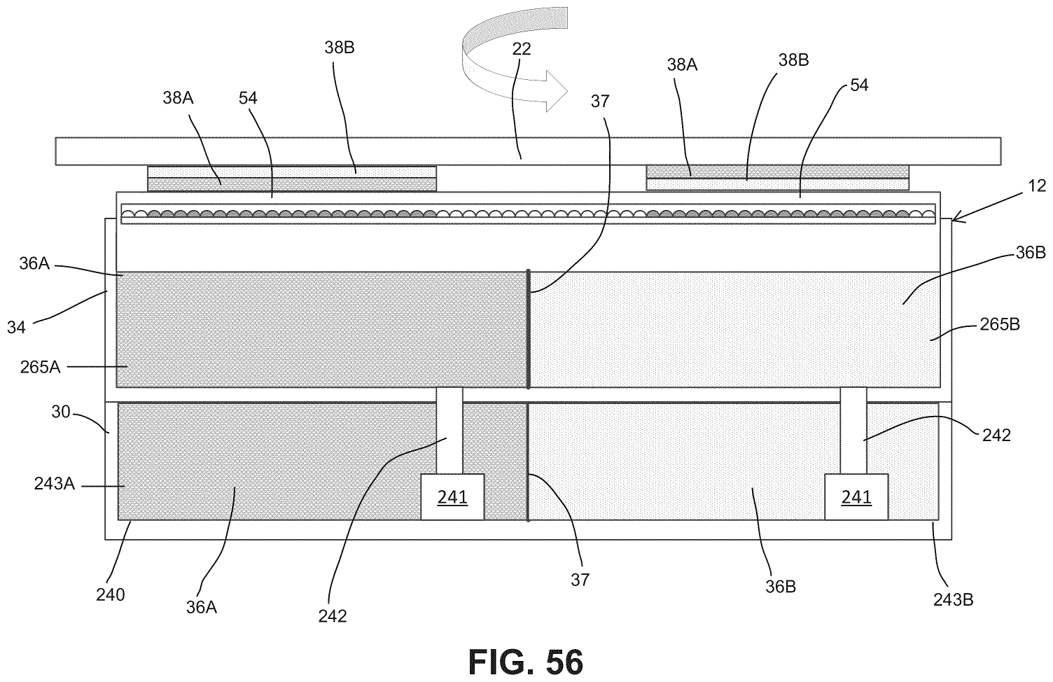

The pump 241 may be a manual pump or a mechanical/automated pump in various embodiments. The pump 241 and the conduit 242 in FIGS. 47-49 are connected to the supply 34 and/or mounted on the carriage 32, such that the pump 241 and the conduit 242 remain connected to the supply 34 when the reservoir 240 is removed. While shown schematically in FIGS. 47 and 48-49, it is understood that the reservoir 240, the supply 34, and/or the carriage 32 may have structures for mounting and placing the pump 241 and/or the conduit 242 in fluid communication with the flowable material 36 in the reservoir 240 and the supply 34. In another embodiment, the pump 241 and/or the conduit 242 may be part of the reservoir 240, such that the pump 241 and/or the conduit 242 can be removed along with the reservoir 240, as illustrated in FIGS. 55-56. It is understood that any other configuration of the pump 241 and the conduit 242 disclosed herein may be used with the embodiment of FIGS. 55-56, and that the configuration of FIGS. 55-56 may be used in connection with the embodiments of FIGS. 47-49. FIG. 49A illustrates one embodiment of a reservoir 240, which has a fitting 244 at the bottom of the vat 243 for connection to the conduit 242. This reservoir 240 may be positioned below the vat 34, such as in the area 246 indicated in FIG. 41. The reservoir 240 and/or the supply 34 may include a temperature sensor 247 for sensing the temperature of the flowable material 36, a level sensor 248 for sensing the fill level of the flowable material 36, and/or a mixing device 251 as described herein with respect to FIGS. 50-51. FIGS. 47 and 49 illustrate both the reservoir 240 and the supply 34 including a temperature sensor 247, a level sensor 248, and one or more mixing devices 251. The reservoir 240 may include a temperature regulation element (not shown) as described herein for regulating the temperature of the flowable material 36 in the reservoir. Still further, the supply 34 may have a return conduit (not shown) configured to return leakage of flowable material 36 to the reservoir 240 for recirculation, such as flowable material 36 that leaks around the ends of the roller 42. It is understood that a reservoir 240 according to any aspects disclosed herein may be used in connection with any embodiment of a deposition mechanism 30 disclosed herein.

FIGS. 50A-52B illustrate another embodiment of a deposition mechanism 30 that uses an applicator 40 and an exposure device 50 utilizing many of the components of the embodiment in FIGS. 29-37, including a plurality of LEDs (not shown) connected to and powered by a plurality of circuit boards 181 that are positioned within the roller 42 and are mounted within the roller 42 by a supporting structure. In this embodiment, the exposure device 50 uses a single rod lens 250 in place of the ball lenses 180, e.g., in the form of a single transparent cylindrical rod (e.g., glass or plastic) mounted axially along the same axial direction of the roller 42. It is understood that the supporting structure in this embodiment includes a lens mounting structure 191 with one or more bodies 193 that support the rod lens 250 and guide or channel the waves from the outlets of the optical fibers to the rod lens 250. In one embodiment, the lens mounting structure 191 includes a plurality of bodies 193 similar to the embodiment of FIGS. 29-37, with the bodies 193 combining to define a receiver 195 in the form of an elongated recess for holding the rod lens 250 above the ends of the tunnels 194.

The deposition mechanism 30 in FIGS. 50A-52B can be configured for use in producing a three-dimensional object 11 in the form of a sheet of material having a desired thickness, as shown in FIG. 51. In this embodiment, the LEDs 59 or other light emitting device(s) are activated such that a plurality of outlets 54 along a continuous line emit waves toward the application site 41, with the line being as long as the desired width of the object 11, thereby producing a continuous sheet. The rod lens 250 focuses the waves from the outlets 54 along a continuous line to produce the object 11, and repeated passes of the deposition mechanism 30 can be used to build the object 11 to the desired sheet thickness. Additionally or alternately, multiple consecutive deposition mechanisms 30 can be used to build sequential layers of the object 11 to the desired thickness, in another embodiment. It is understood that such a rod lens 250 may be utilized with other configurations of deposition mechanisms 30 as described herein, and that a rod lens 250 in a configuration as described herein may be used to produce sheet material at lower cost than other mechanisms. The length of the sheet object 11 is limited only by the length of the build platform 22 and/or the track 14 (if present). In a further embodiment, the support assembly 20 may be configured to move the object 11 with respect to the deposition mechanism 30, in addition to or instead of movement of the deposition mechanism 30. For example, the build platform 22 may be moveable, or the object 11 may be moved with respect to the build platform 22 and collected after building, such as by cutting and stacking individual sheets or spooling the sheet continuously. In additional embodiments, the deposition mechanism 30 in FIGS. 50A-52B may use other applicators 40 and/or exposure devices 50 disclosed herein. The exposure device 50 in one embodiment may control the power generated by the various LEDs 59, such that the LEDs 59 with outlets 54 near the center of the roller 42 generate less power than the LEDs 59 with outlets 54 near the edges of the roller 42. In the method of use shown in FIG. 51, this power control may avoid excessive buildup of heat near the center of the roller 42. In another embodiment, the exposure device 50 may include only a single light source that illuminates the entire length of the rod lens 250.

Examples of objects 11 that can be manufactured using the deposition mechanism 30 in FIGS. 50A-52B include various sheet-based materials, including sheets with multi-material components. For example, successive deposition mechanisms 30 can be passed through the build area 13, which may include different materials for forming different layers 38 of the object 11. In one embodiment, at least one of the layers may be added to the object 11 directly, and not by forming using the flowable material 36. For example, the deposition mechanism 30 may use a roller to directly roll a sheet of material onto the object 11, such as a layer of copper or other metal to provide a conductive (or otherwise functional) cover or a liner for a polymer component. As another example, a deposition mechanism 30 such as shown in FIGS. 29-37 could also be used in conjunction with the deposition mechanism 30 of FIGS. 50A-52B. In this configuration, the deposition mechanism 30 in FIGS. 50A-52B creates an object 11 in the form of a sheet material with a liner, a cover, or another component that is formed by the deposition mechanism 30 in FIGS. 29-37. In a further embodiment, the object 11 may include another functional material that is applied either by direct application or by layer-by-layer application. As an example, a portion of the object 11 may be formed of silver oxide, e.g., an internal layer for EMP shielding and other functionality.

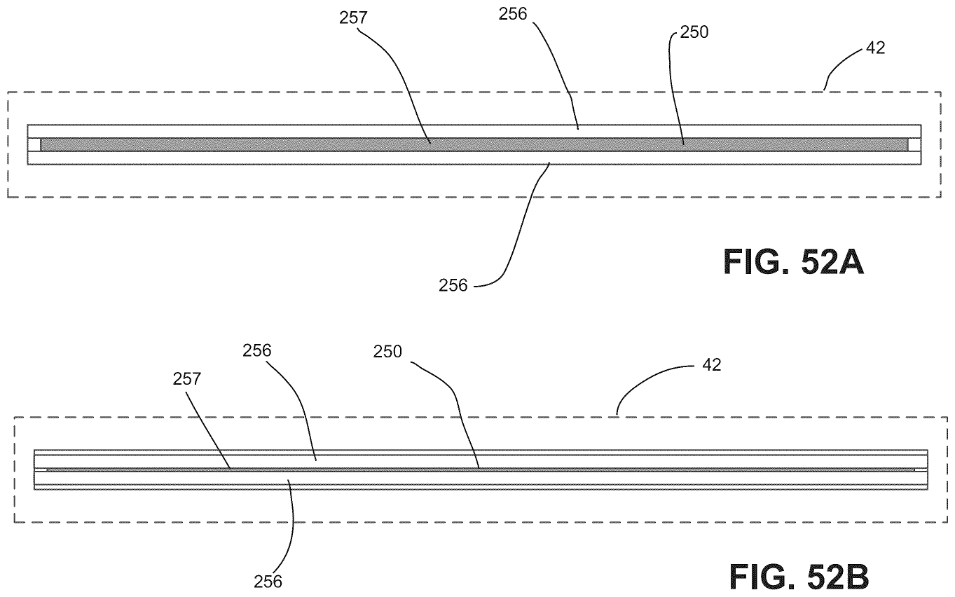

FIGS. 52A-B illustrate an embodiment of the deposition mechanism 30 in FIGS. 52A-B that includes a shutter 256 for controlling the width of a window 257 that permits the waves 53 to be emitted toward the exposure site 41. The shutter 256 may also be used for a secondary exposure device 80 if desired. The shutter 256 is a mechanical structure that can contract and expand the window 257, such as to achieve a larger or smaller exposure area, among other benefits. The structure of the shutter 256 for expanding and contracting the window 257 may include one or more plates or shields that are moveable by mechanical or electromechanical means, including gears, pulleys, threaded engagement, induction or magnetic forces, or other such techniques. Additionally, the structure of the shutter 256 may include one or more moveable pieces that move with respect to a fixed piece, or opposed moveable pieces that move with respect to each other, to expand and contract the window 257. It is understood that the shutter 256 and the moveable piece(s) thereof may be positioned within the roller 42 in the embodiment of FIGS. 50A-52B. FIG. 52A illustrates a first shutter position, where the shutter 256 is fully open, while FIG. 52B illustrates a second shutter position, where the shutter 256 is slightly closed compared to FIG. 52A. The shutter 256 may be configured to be completely closed if desired in some embodiments.

The deposition mechanism 30 in FIGS. 50-51 also include a mixing device 251 within the supply 34 of the flowable material 36, which is designed to agitate and/or mix the flowable material 36. Such mixing can be done to maintain fluidity in the flowable material 36, ensure that multiple flowable materials 36 remain mixed, maintain suspension of solid particles within the flowable material 36, and/or other purposes. In the embodiment of FIGS. 50-51 the mixing devices 251 are in the form of rotatable paddle wheels that are positioned on opposite sides of the roller 42 and are configured to rotate in opposite directions. In other embodiments, other types of mixing devices 251 may be used, including paddles, augers, jets, fans/turbines, etc. It is understood that such a mixing device 251 may be incorporated into any deposition mechanism 30 disclosed herein.

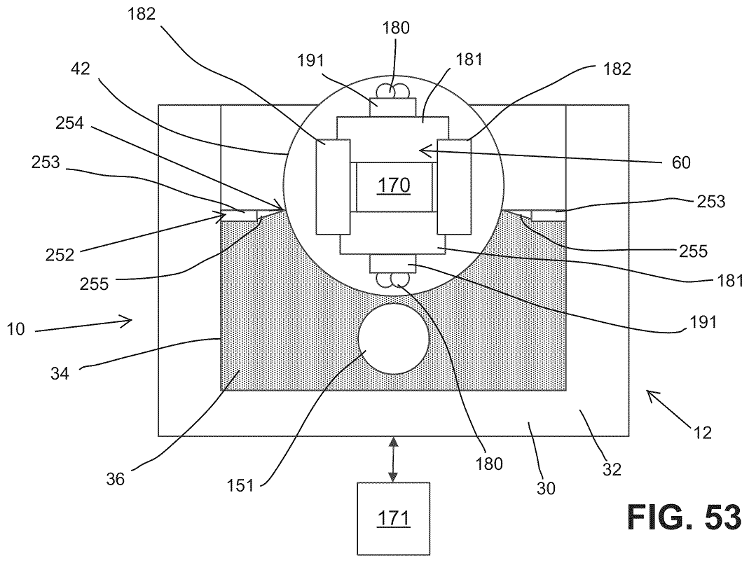

FIG. 53 illustrates another embodiment of a deposition mechanism 30 that uses an applicator 40 and an exposure device 50 as shown in FIGS. 29-37, but which may use other applicators 40 and/or exposure devices 50 disclosed herein. In this embodiment, the deposition mechanism 30 further includes a sealing structure 252 configured for sealing the supply 34 of the flowable material 36 to retain the flowable material 36 within the supply 34. In the embodiment of FIG. 53, the sealing structure 252 includes a cover 253 having an opening 254 to permit the roller 42 to be in contact with the flowable material 36, and having flexible, resilient members 255 on opposite sides of the opening to seal around the roller 42. The flexible, resilient members 255 may be formed of rubber, silicone, polyurethane, or other such material, e.g., in the form of wipers or squeegees. The deposition mechanism 30 in FIG. 53 includes a thickness limiter in the form of a secondary roller 151 spaced from the roller 42, which allows formation of the layer 38 of at least partially solidified material within the supply 34 as described herein. This layer 38 is transported by the roller 42 to the application site 41, while the sealing structure 252 retains the flowable material 36 within the supply 34. It is understood that the deposition mechanism 30 in FIG. 53 is capable of operation in both directions of movement and both directions of rotation of the roller 42. A deposition mechanism 30 with a sealing structure 252 as described herein permits production of objects 11 in a wide variety of environments. For example, the deposition mechanism 30 of FIG. 53 may be used in a zero-gravity environment (e.g., outer space), where flowable material 36 would escape from the supply 34 if not contained by the sealing structure 252. As another example, the deposition mechanism 30 of FIG. 53 may be used in a contaminating atmosphere, where contaminants that may affect the flowable material 36 are resisted against ingress by the sealing structure 252.

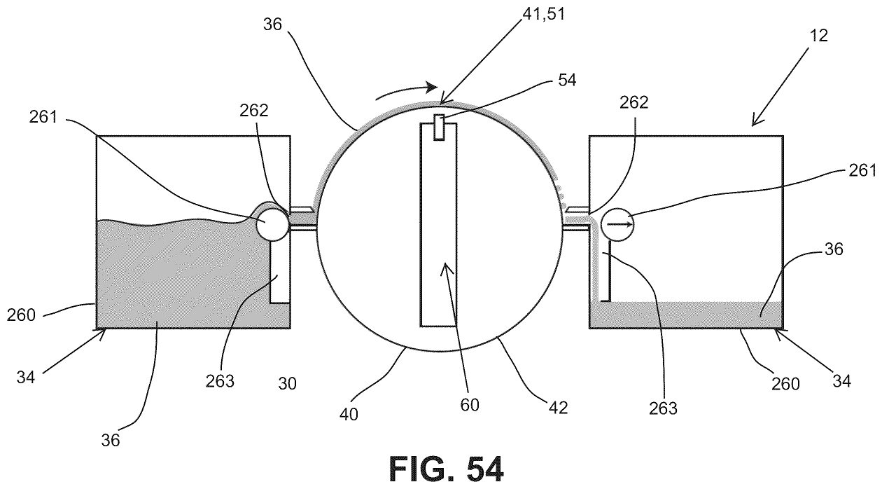

FIG. 54 illustrates another embodiment of a deposition mechanism 30 that uses an applicator 40 as shown in FIGS. 29-37, and which may use one of a variety of different exposure devices 50. The deposition mechanism 30 in FIG. 54 uses a supply 34 of the flowable material 36 in the form of one or more cartridges 260 that are mounted on the carriage 32 to dispense the flowable material 36 to the roller 42. The cartridges 260 in this embodiment may be permanently or semi-permanently mounted on the carriage 32 in one embodiment, or may be removably and/or interchangeably mounted on the carriage 32 in another embodiment. Each cartridge 260 in this embodiment includes internal mechanisms configured for feeding the flowable material 36 to the roller 42 and for collecting excess flowable material 36 from the roller 42. In the embodiment of FIG. 54, the internal mechanisms include an internal roller 261 that is rotatable and moveable by translation toward or away from an opening 262 for passage of the flowable material 36. The internal rollers 261 may be powered for rotation or freely rotatable in various embodiments.

The deposition mechanism 30 in FIG. 54 has cartridges 260 mounted on both sides of the roller 42, which may be a single cartridge 260 on each side or a plurality of adjacent cartridges 260 on each side. As shown in FIG. 54, the left cartridge 260 is configured for feeding the flowable material 36 to the roller 42, and the right cartridge 260 is configured for collecting excess flowable material 36 from the roller 42 after application. The left cartridge 260 has the internal roller 261 positioned in a feeding position adjacent to the opening 262, at a distance to establish controlled flow of the flowable material 36 through the opening 262 for feeding to the roller 42. The internal roller 261 on the left cartridge 260 may be configured to turn clockwise in this configuration, to ease feeding of the flowable material 36 to the roller 42. The right cartridge 260 in FIG. 54 has the internal roller 261 positioned in a collecting position further from the opening 262 for allowing free flow of the excess flowable material 36 from the roller 42 into the opening 262. The internal roller 261 on the right cartridge 260 may be configured to turn counterclockwise in this configuration, to ease movement of the flowable material 36 downward into the cartridge 260. The internal roller 261 can be moved between the feeding and collecting positions by left-to-right translational movement in the embodiment of FIG. 54, but may move differently in other embodiments, such as in a vertical direction, a combined vertical/horizontal direction, an arcing direction (e.g., on a pivot arm), or other movement. The cartridges 260 in FIG. 54 also have a drain 263 positioned beneath the opening 262, and translational movement of the internal roller 261 can block the drain 263 in the feeding position or open the drain 263 in the collecting position. In the configuration of FIG. 53, the deposition mechanism 30 is configured for movement to the left relative to the build area, whereby the flowable material 36 is carried up the left side of the roller 42 to the application site 41 by clockwise rotation, and the excess flowable material 36 is carried back to the right cartridge 260. The deposition mechanism 30 may be adjusted for movement to the right relative to the build area, by moving the internal roller 261 of the left cartridge 260 to the left to reach the collecting position and moving the internal roller 261 of the right cartridge 260 to the left to reach the feeding position. In this configuration, excess flowable material 36 collected by the right cartridge 260 during movement to the left can be fed to the roller 42 during movement to the right, thereby vastly decreasing waste.

In another embodiment, the cartridge 260 may be provided with an exposure device to form an initial exposure site 150. For example, the internal roller 261 and/or the height of the opening 262 may be configured as a thickness limiter for the initial exposure site 150, similar to the secondary roller 151 in FIGS. 21-26. In one configuration, the internal roller 261 may be transparent with an exposure device therein. In another configuration, the top and/or bottom surface defining the opening 262 may be transparent, with an exposure device positioned to emit waves upward or downward into the opening 262. In a further configuration, the exposure device 50 within the roller 42 may be configured to emit waves to an initial exposure site 150 located where the opening 262 meets the roller 42. Other configurations are possible as well.

FIGS. 55-56 illustrate another embodiment of a deposition mechanism 30 that uses an applicator 40 and an exposure device 50 as shown in FIGS. 1-4, but which may use other applicators 40 and/or exposure devices 50 disclosed herein. In this embodiment, the deposition mechanism 30 includes a supply 34 with a plurality of separate compartments 265A-B for holding a plurality of different flowable materials 36A-B, to permit the deposition mechanism 30 to build multiple objects 11 out of different materials 36A-B or a single object 11 out of different materials 36A-B simultaneously. While only two compartments 265A-B with two different materials 36A-B are shown in FIGS. 55-56, it is understood that a greater number of compartments 265A-B and materials 36A-B may be used. As shown in FIGS. 55-56, the supply 34 may be configured as a vat that has partitions 37 to separate the different materials 36A-B, and the partitions 37 may be adjustable to alter the ratios and boundaries of the different materials 36A-B as desired. It is understood that descriptions of using “different materials” as used herein may also enable usage of the same material with different colorings, additives, fillers, etc. In the embodiment of FIGS. 55-56, the build platform 22 is rotatable about the vertical or z-axis to enable the deposition mechanism 30 to build different parts of the object 11 from different flowable materials 36, without changing the rotational orientation of the deposition mechanism 30 or the orientation of the deposition mechanism 30 in the lateral or y-direction. For example, the build platform 22 in FIG. 56 is rotated 180° with respect to the position of the build platform 22 in FIG. 55, such that the deposition mechanism 30 can apply different materials 36A-B to different portions of the build platform 22 or the object 11 while moving along the x-axis in the same orientation. In this configuration, the deposition mechanism 30 can build layers 38A-B of different materials simultaneously. It is understood that the build platform 22 may be rotatable to a plurality of different rotational positions, in order to permit more complex techniques for building of the object 11, using multiple orientations.

The deposition mechanism 30 in FIGS. 55-56 also uses a multi-material reservoir 240, which has multiple vats 243A-B separated by one or more partitions 37 and configured to contain a plurality of different flowable materials 36A-B. In this embodiment, each vat 243A-B includes an individual pump 241 and a conduit 242 in communication with one of the compartments 265A-B of the supply 34. The pumps 241 operate separately and may be automatically and/or manually controlled as described herein. Thus, the reservoir 240 can feed different flowable materials 36A-B to the appropriate compartments 265A-B of the supply 34 as necessary.

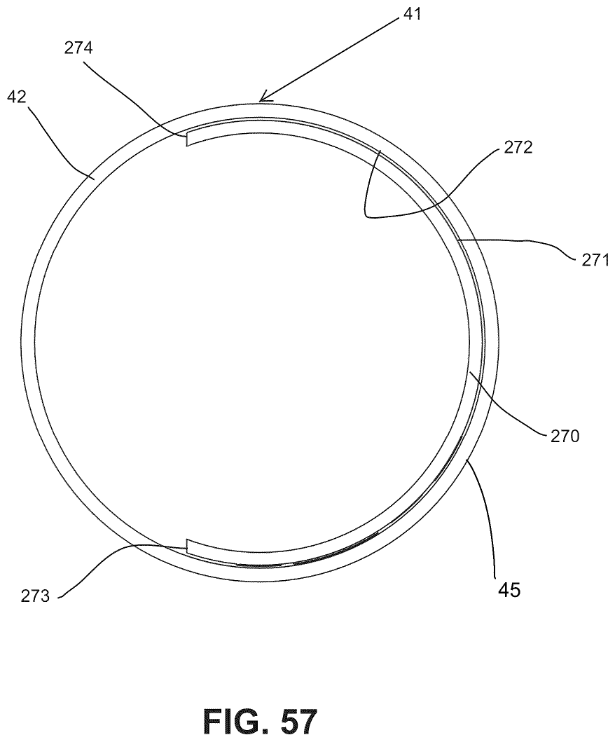

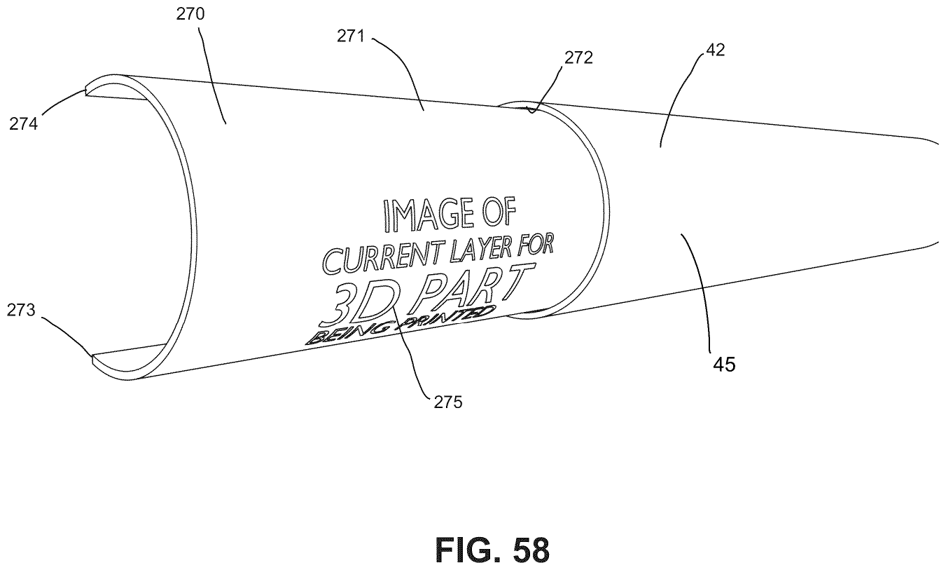

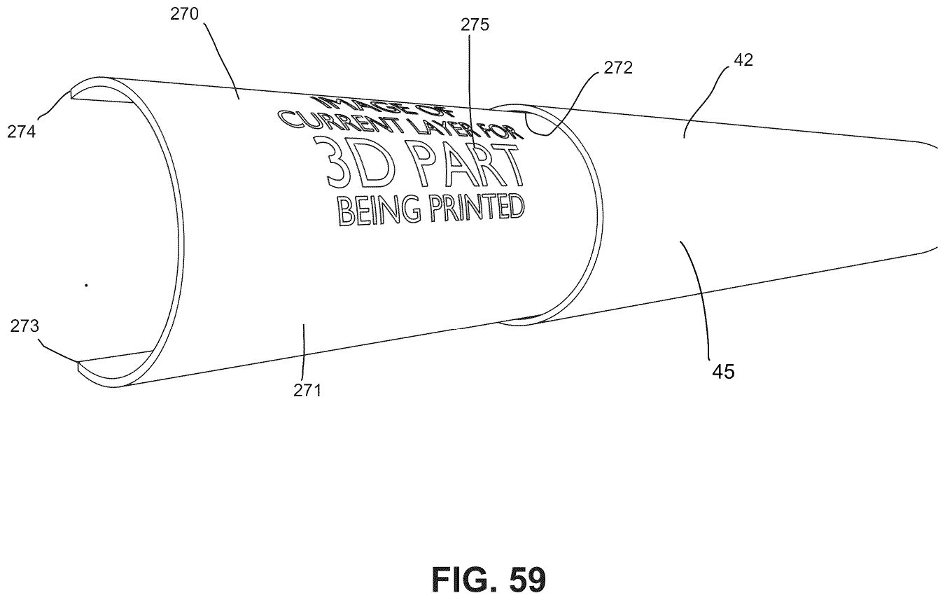

FIGS. 57-59 illustrate another embodiment of a deposition mechanism 30 that uses an applicator 40 as shown in FIGS. 29-37 and an exposure device 50 that includes a flexible or otherwise curved screen 270 configured to emit waves to the exposure site 51 for solidification of the flowable material 36. The applicator 40 in this configuration includes a roller 42 that forms a carrying surface 45 that carries the resin from the supply 34 to the application site 41. In one embodiment, the screen 270 may use organic light emitting diode (OLED) or organic liquid crystal display (OLCD) technology for generation of the waves. The screen 270 in FIGS. 57-59 is positioned within the roller 42 and has an outer surface 271 that is in contact or in close proximity with the inner surface 272 of the roller 42. In this configuration, the carrying surface 45 overlays the screen 270, and the screen 20 conforms to the shape of the carrying surface 45, in this configuration a cylindrical shape. In this arrangement, the screen 270 emits waves through the roller 42 to solidify the flowable material 36 on the roller 42. As shown in FIGS. 57-59, the screen 270 has a first end 273 located proximate the bottom of the roller 42 and a second end 274 located proximate the top of the roller 42, and the screen 270 curves around to approximately match the curvature of the inner surface 272 of the roller 42. The screen 270 may extend around at least 180° of the circumference of the inner surface 272 of the roller 42 in one embodiment. As shown in FIGS. 58-59, the screen 270 can project a scrolling image 275 that scrolls on the screen 270 at the same speed as the roller 42 is rotating, such that the image 275 follows the flowable material 36 as it is carried by the roller 42 to the application site 41. This creates an initial exposure site 150 that begins within the flowable material 36 at or near the first end 273 of the screen 270, and the waves emitted by the screen 270 can continuously expose the flowable material 36 between the initial exposure site 150 and the application site 41. In this configuration, the power of the waves emitted by the screen 270 may be lower than the power of the LEDs or other exposure devices 50 in other embodiments, due to the longer exposure time enabled by the screen 270. Additionally, the second end 274 of the screen 270 may extend rearward beyond the application site 41, and in one embodiment, the screen 270 may continue to emit waves past the application site 41 to provide additional exposure of the layer 38 after application.

In one embodiment, the screen 270 may project an image 275 that varies in intensity/power at different points in the exposure process. For example, the screen 270 may project an image 275 at low power (e.g., 10% of desired power) near the first end 273 of the screen 270 that increases in power to a maximum power (e.g., 100% of desired power) at the application site 41. The power increase may be continuous or incremental throughout this exposure. As another example, the screen 270 may provide an initial higher-powered exposure at an initial exposure site 150 and then reduce the power of the image 275 or deactivate the image 275 until at or near the application site 41. As a further example, the screen 270 may only project the image 275 at or near the application site 41. The screen 270 may also be configured for producing an image 275 in the form of a continuous sheet exposure, such as in the embodiment of FIGS. 50A-52B. In one embodiment, the screen 270 may project a linear image 275 at and around the application site 41, or two linear images 275 at an initial exposure site 150 and at the application site 41. In another embodiment, the entire screen 270 may be illuminated at least between an initial exposure site 150 and the application site 41, to create a continuous sheet of material to be applied. The screen 270 may vary the power of the illumination as described above, e.g., by increasing in power as the image 275 approaches the application site 41.

The thickness of the roller 42 the embodiment of FIGS. 57-59 may be smaller than the thicknesses of the rollers 42 in other embodiments, to place the image generation location as close as possible to the flowable material 36, thereby avoiding the necessity of focusing the waves. As such, the deposition mechanism 30 in FIGS. 57-59 may not require any lens or other focusing mechanism. In another embodiment, the screen 270 may wrap around a greater portion, or even the entirety, of the circumference of the roller 42, to provide more potential exposure locations. Multiple screens 270 may be used to create such a configuration.

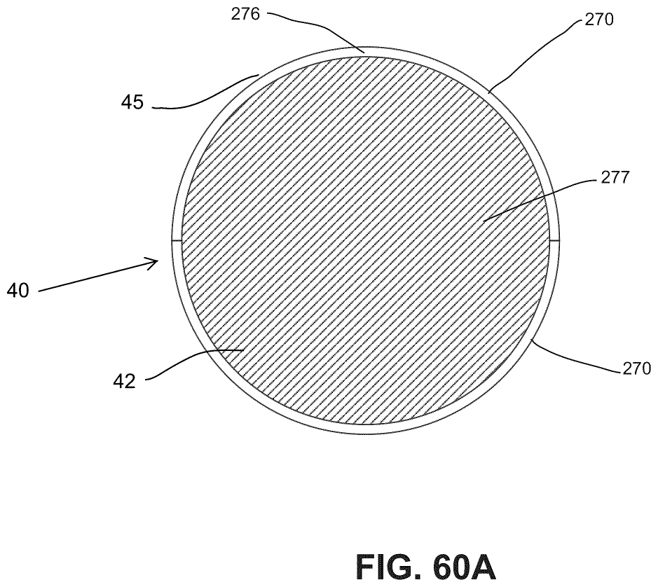

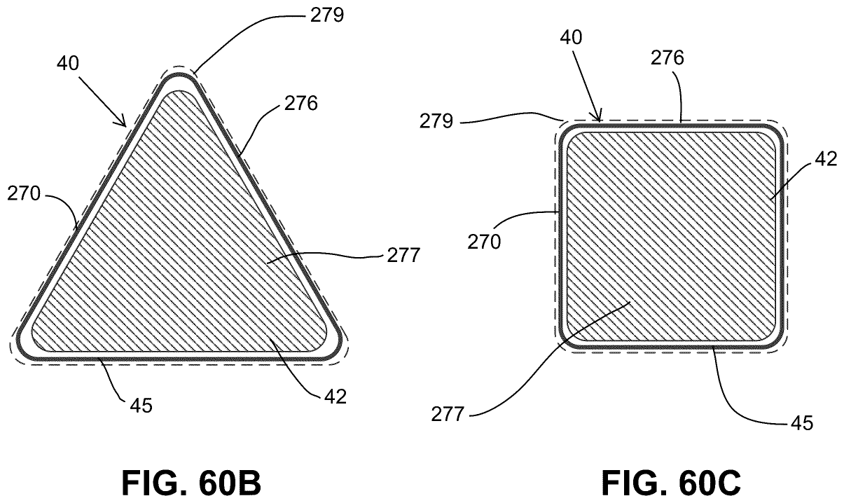

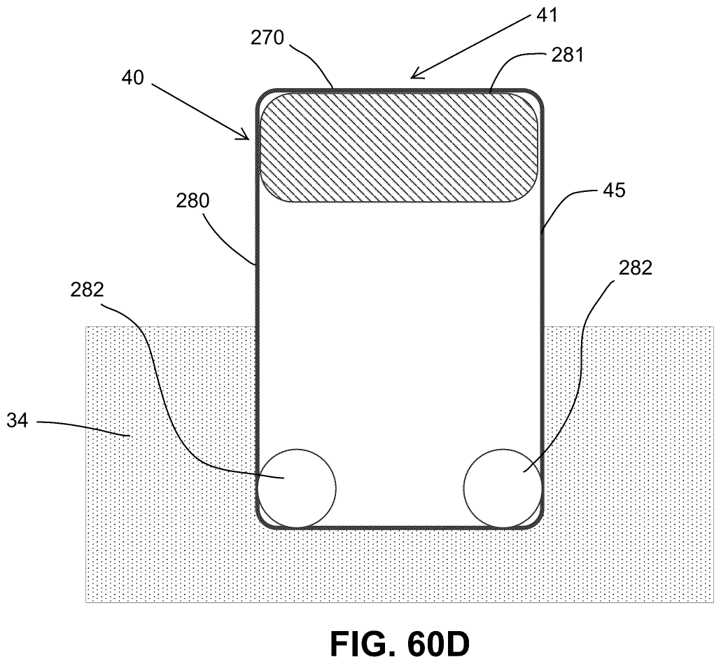

FIG. 60A illustrates a further embodiment of a deposition mechanism in which a plurality of flexible screens 270 are connected together, such that the outer surfaces 271 of the flexible screens 270 combine to form a roller screen 276 for application of the flowable material 36 as described herein. The roller screen 276 forms the carrying surface 45 in this configuration. In this embodiment, two flexible screens 270 are illustrated, but in other embodiments, three or more flexible screens 270 may be used. In a further embodiment, a single flexible screen 270 may be used. The flexible screen(s) 270 may be mounted on a rotatable support, such as a rotatable cylinder 277 as shown in FIG. 60A. In this embodiment, the image on the screen(s) 270 may not scroll, but instead may be a static image that travels by rotation of the roller screen 276. The one or more flexible screens 270 may be covered by one or more thin layers of material that may add a functional property to the carrying surface, such as a low-adhesion layer (e.g., Teflon), a barrier layer to resist liquid ingress, etc.

FIGS. 60B-C illustrate another embodiment of a deposition mechanism in which one or more flexible screens 270 form a roller screen 276 forming a non-circular carrying surface 45 in this configuration. The flexible screen(s) 270 may be mounted on a rotatable support 277 having a polygonal shape with a plurality of substantially flat surfaces 278, such as a triangular shape as shown in FIG. 60B or a rectangular shape as shown in FIG. 60C. The flexible screen 270 conforms to the shape of the support 277 and forms a carrying surface 45 having a plurality of substantially flat surfaces. The screen(s) 270 may be covered by one or more thin layers of material 279, illustrated schematically in FIGS. 60B-C.

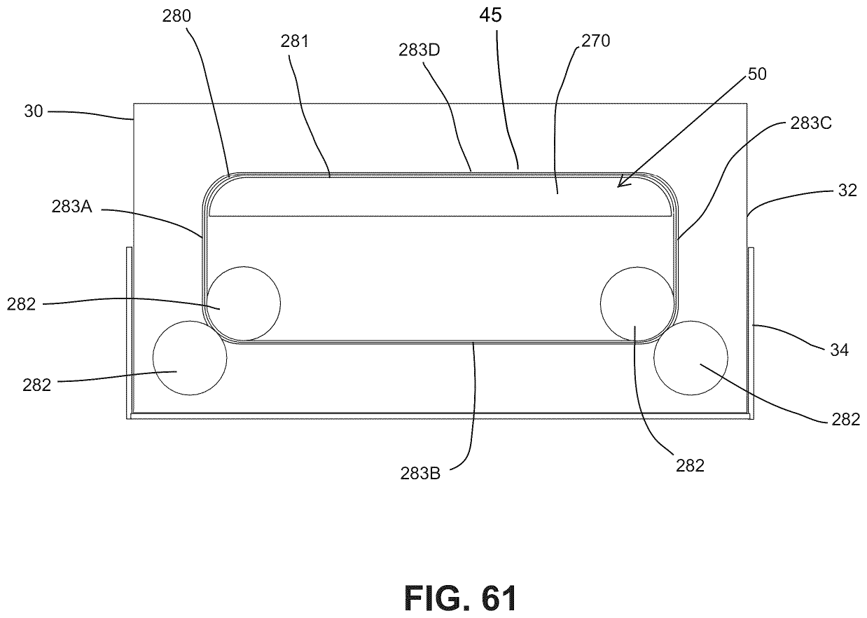

FIG. 60D illustrates another embodiment of a deposition mechanism in which one or more flexible screens 270 form a belt 280 forming a carrying surface 45 in this configuration. The belt 280 is a continuous belt that is formed in a loop and may be carried by one or more drums 282 or other structures that may be powered (e.g., pulleys), free rotating (e.g., idlers), or static cylinders, i.e., as shown in and discussed with respect to FIGS. 61-64 herein. The belt 280 passes over a static surface 281 at the application site, and the flexible screen 270 and the carrying surface 45 conform to the shape of the static surface 281. The screen(s) 270 may be covered by one or more thin layers of material, as described herein with respect to FIGS. 60A-C.

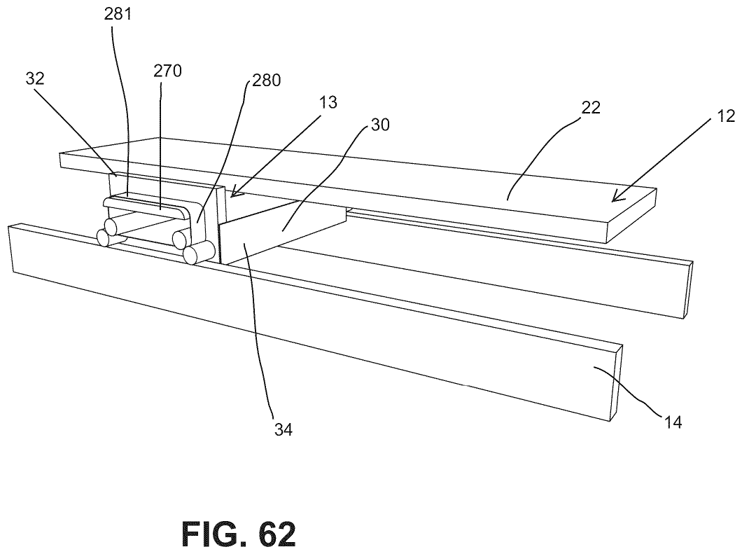

FIGS. 61-64 illustrate another embodiment of a deposition mechanism 30 that uses an applicator 40 in the form of a moveable film 280 that is in communication with the supply 34 of the flowable material 36 and carries the flowable material 36 to the application site 41 by vertical and lateral movement to form a layer 38 of the object 11. The moveable film 280 forms a carrying surface 45 in this embodiment. As shown in FIG. 62, the deposition mechanism 30 may be mounted for movement on a track 14 for application of the flowable material 36 to a build platform 22 according to other embodiments disclosed herein. In other embodiments, the deposition mechanism 30 may be configured for movement and application without a track 14, as also disclosed herein. The deposition mechanism 30 in FIGS. 61-64 has a static surface 281 that defines the location of the application site 41 and the thickness of the applied layer 38 as described above, and the film 280 carries the material 36 to the application site 41 by moving over the static surface 281. The film 280 in the embodiment of FIGS. 61-64 is in the form of a continuous belt that is formed in a loop and carried by one or more drums 282 or other structures that may be powered (e.g., pulleys), free rotating (e.g., idlers), or static cylinders. In one embodiment, at least one of the drums 282 may be powered to drive revolution of the film 280. The path of the film 280 in FIGS. 61-64 includes a descending section 283A extending down into the supply 34, a submerged lateral section 283B extending through the supply 34, an ascending section 283C extending up out of the supply 34, and a lateral application section 283D where the film 280 carries the flowable material 36 over the static surface 281. The descending section 283A of the film 280 then carries any excess flowable material 36 back into the supply 34. It is understood that the direction of revolution of the film 280 may be reversed when the movement of the deposition mechanism 30 is reversed, such that the positions of the descending section 283A and the ascending section 283C are transposed.

The deposition mechanism 30 in FIGS. 61-64 has an exposure device 50 in the form of a screen 270 configured to emit waves to the exposure site 51 for solidification of the flowable material 36, such as described herein with respect to FIGS. 57-60. The screen 270 is configured to emit waves through at least the application section 283D of the film 280 for solidification of the flowable material 36 at the application site 41. Additionally, the screen 270 may be a flexible or otherwise curved screen that curves downward at the descending section 283A and/or the ascending section 283C to allow exposure of the flowable material 36 on the film 280 prior to the film 280 reaching the application section 283D. The film 280 forming the carrying surface 45 conforms to the shape of the static surface 281 and the outer surface of the flexible screen 270 at and around the application site 41 in this configuration.

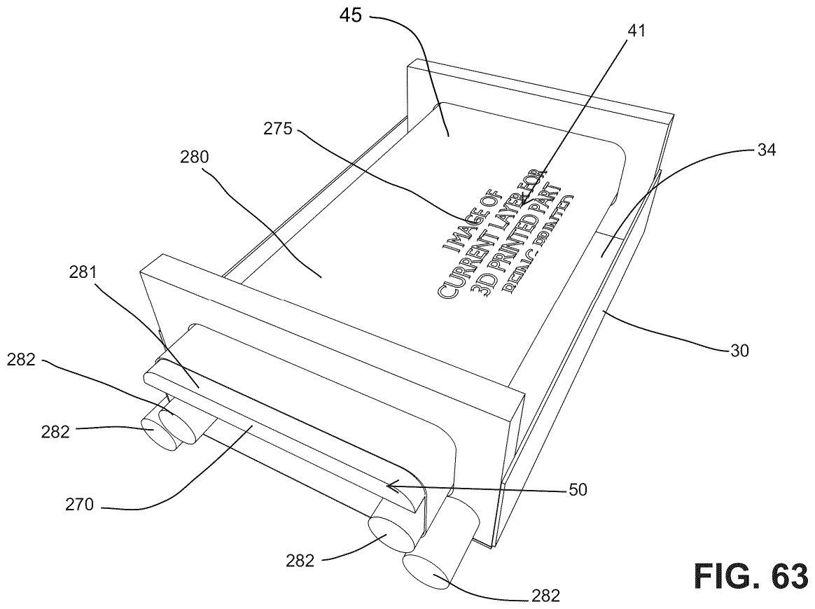

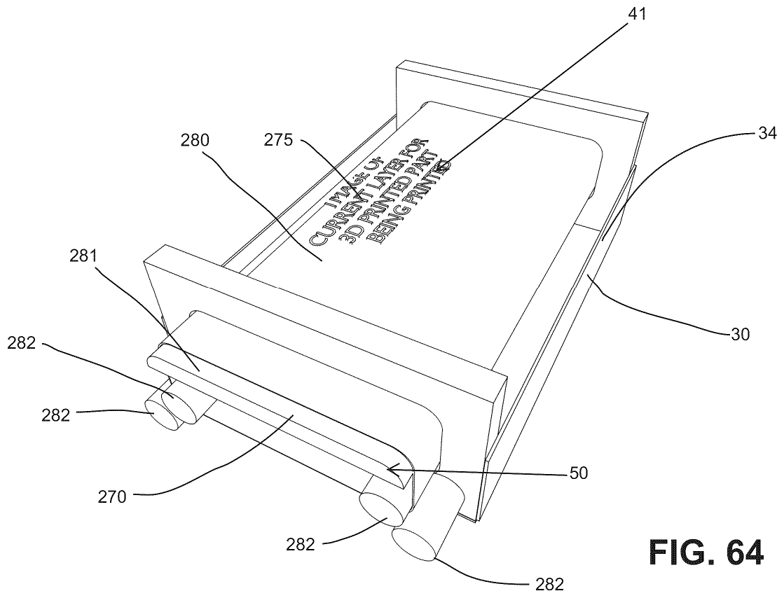

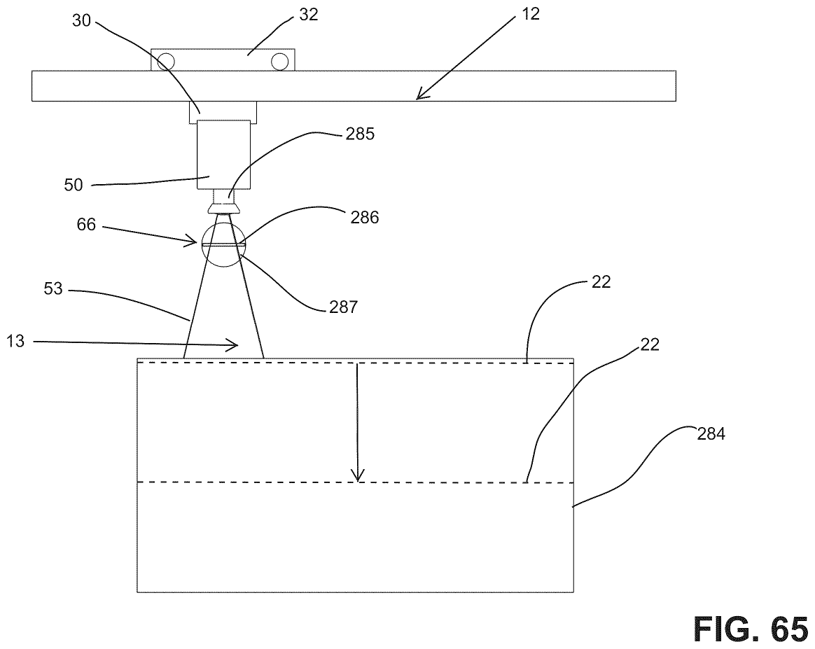

The use of a flexible screen 270 in the embodiment of FIGS. 61-64 can provide a longer exposure time as discussed herein, and the length of the static surface 281 allows for a longer exposure time directly at the exposure site 51 and the application site 41 as well. As shown in FIGS. 63-64, a scrolling image 275 is projected on the screen 270 that scrolls on the screen 270 at the same speed as the film 280 is travelling, such that the image 275 follows the flowable material 36 as it is carried by the film 280 to and/or through the application site 41. In the embodiment of FIGS. 61-64, the static surface 281 is defined by the screen 270 itself; however, the screen 270 may be positioned below the static surface 281 in another embodiment. In other embodiments, a different exposure device 50 may be used, including various embodiments of exposure devices 50 disclosed herein. Such alternate exposure devices 50 may also be configured to achieve longer exposure times along the application section 283D of the film 280, such as by using a moveable (translational and/or rotatable) exposure device 50 as discussed herein or a plurality of arrays of outlets 54 to achieve multiple consecutive exposures. For example, in one embodiment, the film 280 may be replaced by a belt including a flexible screen 270, as described herein.

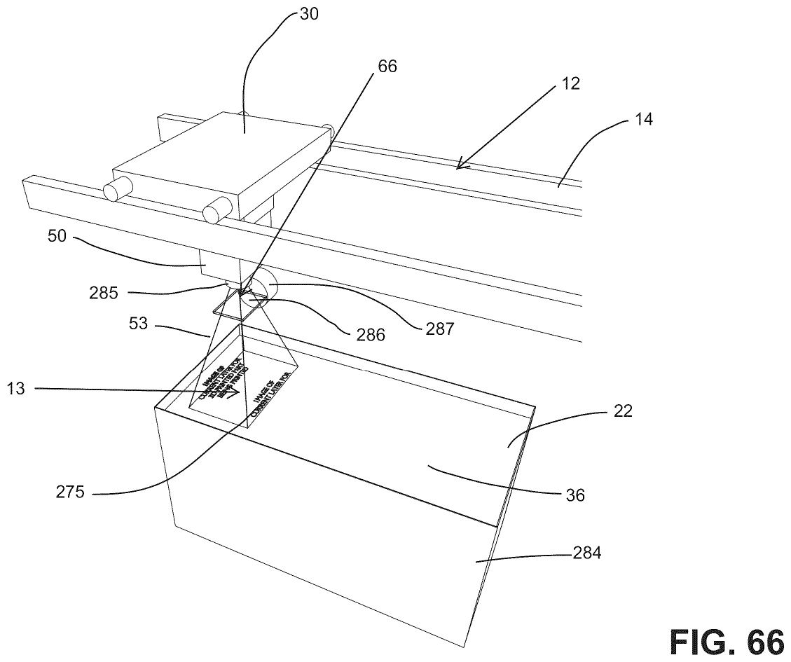

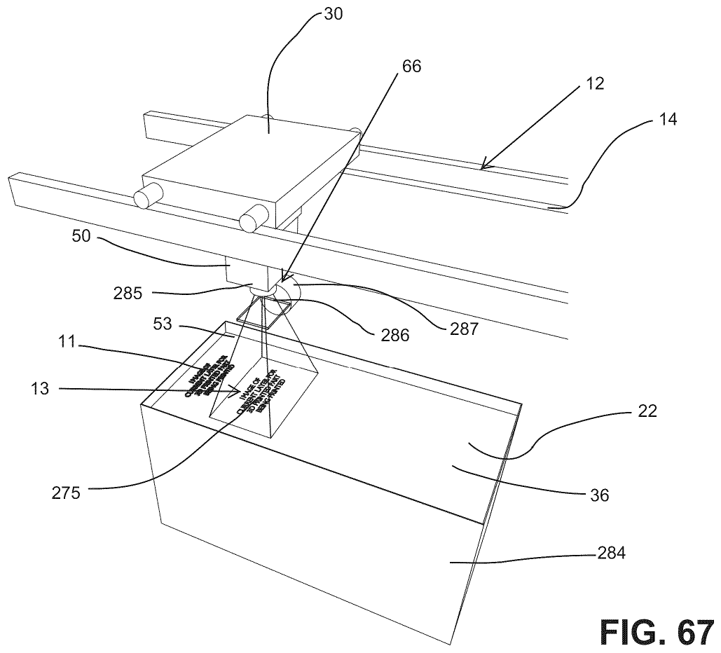

FIGS. 65-67 illustrate another embodiment of a deposition mechanism 30 that does not use an applicator, and includes an exposure device 50 that emits waves 53 directly into a build vat 284 containing the flowable material 36 to form layers 38 of the object 11 within the build vat 284. As shown in FIGS. 65-67, the deposition mechanism 30 may include a carriage 32 mounted for movement on a track 14 and carrying an exposure device 50 to emit waves 53 to an exposure site 51 located at a build platform 22 that is at least partially submerged in the flowable material 36. In this configuration, the object 11 is built by solidification of layers 38 at the surface of the flowable material 36 in the build vat 284 to create an application site 41 at (or slightly below) the surface of the flowable material 36. In other embodiments, the carriage may be configured for movement and application without a track 14, such as an autonomous unit that passes over the build vat 284, as also disclosed herein. The exposure device 50 in FIGS. 65-67 includes a projector 285 that projects a scrolling image 275 onto the surface of the flowable material 36 in the build vat 284. The scrolling image 275 scrolls at the same speed as the carriage 32 is moving, such that the image 275 remains in the same place at the surface of the flowable material 36 as the carriage 32 passes the application site 41. This creates a continuous exposure of the flowable material 36 during the duration of the time the carriage 32 is passing through the build area 13. A focusing mechanism 66 may also be used in connection with the exposure device 50, and in the embodiment of FIGS. 65-67, the focusing mechanism 66 includes a plate lens 286 (or other block lens) mounted on a swivel 287 to permit the plate lens 286 to be angled as desired with respect to the projector 285. The focusing mechanism 66 may be used to refine, enlarge, or reduce the image 275 in various embodiments. The plate lens 286 may be replaced by a mirror arrangement including one or more mirrors, in another embodiment.

In one embodiment, where the exposure device 50 includes a projector 285, the plate lens 266 and the swivel 287 are used together to momentarily stop the movement of the image 275 on the flowable material 36, from exposure frame to exposure frame. The plate lens 266 moves the image 275 at appropriate times to ensure accurate and thorough exposure and the desired amount of refraction, depending angle of the image 275 relative to the projector 285. For example, in one configuration, the plate lens 266 can spin to cause the image 275 to strobe at precisely the correct time for exposure. As another example, the plate lens 266 can slowly tilt to track the movement of the carriage 32 for a sufficient exposure time, while the projector 285 continuously projects a frame of the image 275, after which the plate lens 266 resets to project the next frame of the image 275. The image 275 can therefore be projected as a sequence of bordering frames that extend the entire width of the exposure and are arranged in sequence along the movement direction of the exposure device 50. Both of these methods of operating the plate lens 266 are configured to be in sync with the movement of the exposure device 50. These techniques for operation of the plate lens 266 can avoid “sliding” of the image 275 with respect to the surface of the flowable material 36, which results in blurring. In a further embodiment, the exposure device 50 may be different, such as an LED array or a laser as described herein.

After the carriage 32 passes the build area 13 in one direction to build a layer 38 of the object 11, the carriage 32 (or another subsequent carriage 32) can build another layer 38 of the object 11 in a subsequent pass through the build area 13. The carriage 32 may reverse direction and build the additional layer 38 in a subsequent pass through the build area 13 in the opposite direction, in one embodiment, and the scrolling image 275 is configured to scroll in the opposite direction in this configuration. It is understood that the build platform 22 may move downward into the build vat 284 between passes, in order to permit additional layers 38 to be built on top of each other.

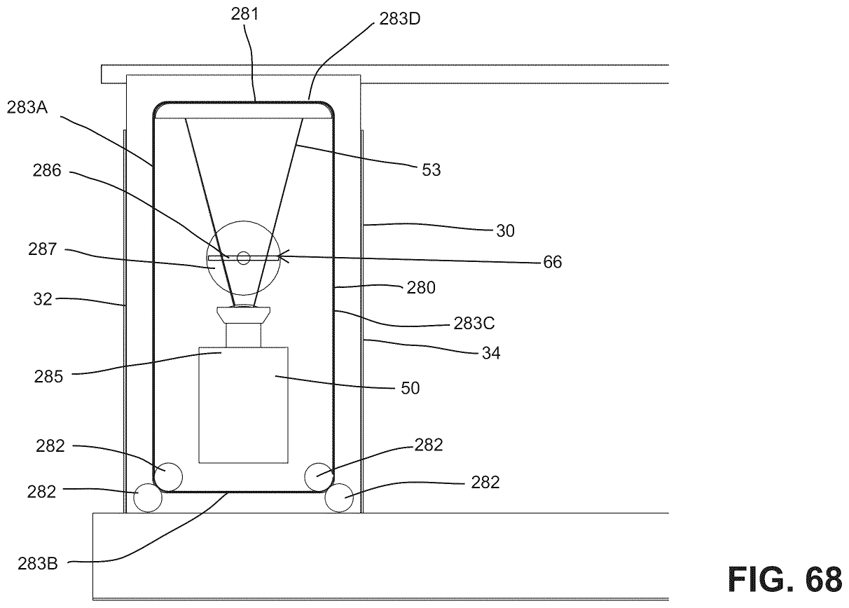

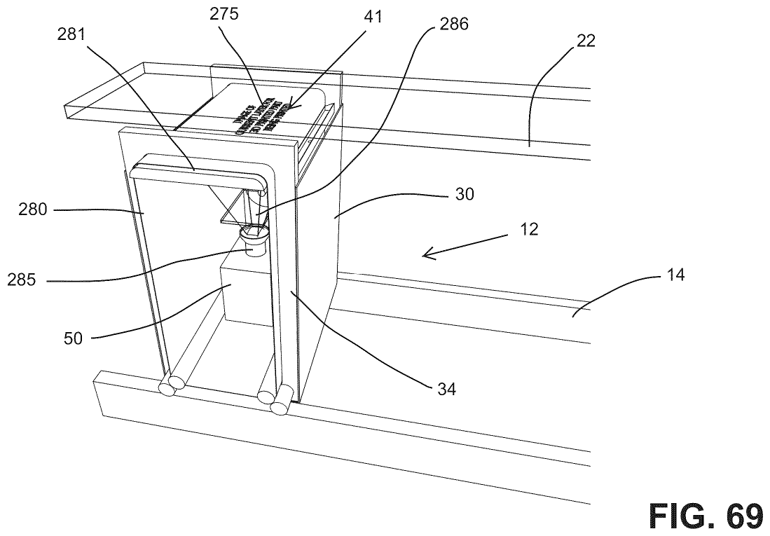

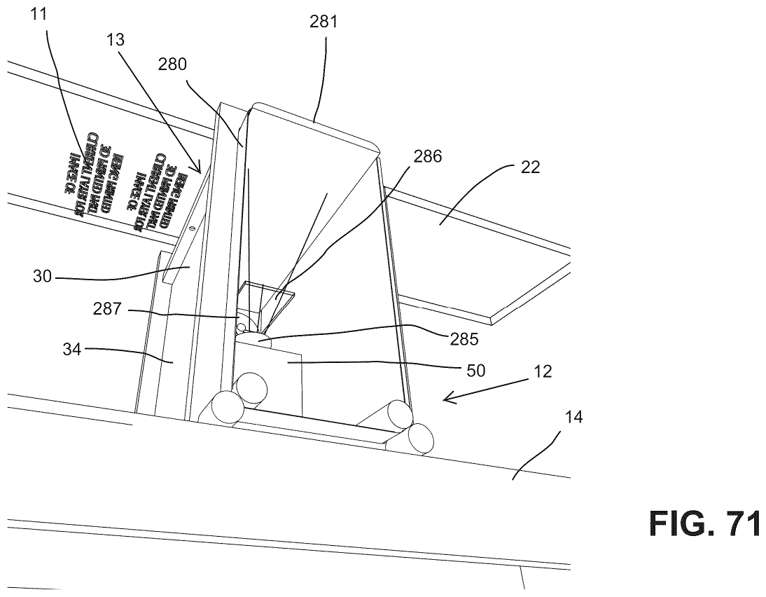

FIGS. 68-71 illustrate another embodiment of a deposition mechanism 30 that uses an applicator 40 in the form of a moveable film 280 that is in communication with the supply 34 of the flowable material 36 and carries the flowable material 36 to the application site 41 by vertical and lateral movement to form a layer 38 of the object 11. As shown in FIGS. 68-71, the deposition mechanism 30 may be mounted for movement on a track 14 for application of the flowable material 36 to a build platform 22 according to other embodiments disclosed herein. In other embodiments, the deposition mechanism 30 may be configured for movement and application without a track 14, as also disclosed herein. The deposition mechanism 30 in FIGS. 68-71 has a static surface 281 that defines the location of the application site 41 and the thickness of the applied layer 38 as described above, and the film 280 carries the material 36 to the application site 41 by moving over the static surface 281. The film 280 in the embodiment of FIGS. 68-71 is in the form of a continuous belt that is formed in a loop and carried by one or more drums 282 or other structures that may be powered (e.g., pulleys), free rotating (e.g., idlers), or static cylinders. In one embodiment, at least one of the drums 282 may be powered to drive revolution of the film 280. The path of the film 280 in FIGS. 68-71 includes a descending section 283A extending down into the supply 34, a submerged lateral section 283B extending through the supply 34, an ascending section 283C extending up out of the supply 34, and a lateral application section 283D where the film 280 carries the flowable material 36 over the static surface 281. The descending section 283A of the film 280 then carries any excess flowable material 36 back into the supply 34. It is understood that the direction of revolution of the film 280 may be reversed when the movement of the deposition mechanism 30 is reversed, such that the positions of the descending section 283A and the ascending section 283C are transposed.

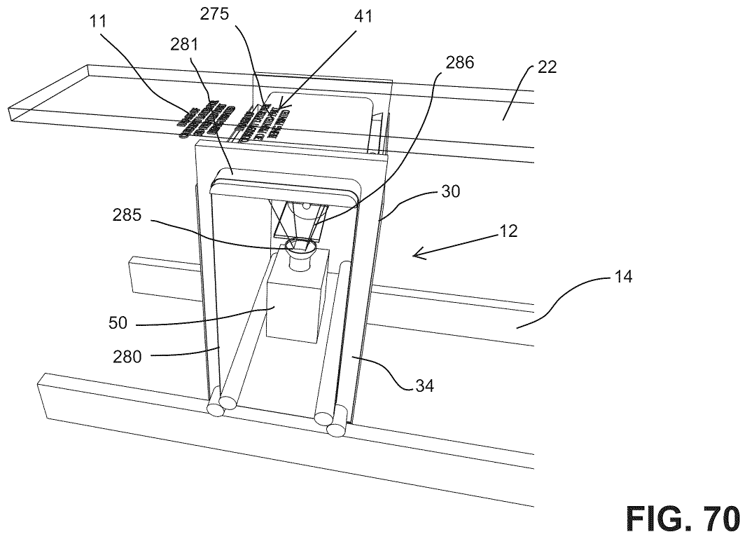

The deposition mechanism 30 in FIGS. 68-71 has an exposure device 50 that includes a projector 285 that projects a scrolling image 275 through the static surface 281 and the film 280 to expose the flowable material 36 carried on the film 280. The projector 285 is configured to emit waves through at least the application section 283D of the film 280 for solidification of the flowable material 36 at the application site 41. As shown in FIGS. 69-71, the projector 285 projects a scrolling image 275 that scrolls at the same speed as the film 280 is travelling, such that the image 275 follows the flowable material 36 as it is carried by the film 280 to and/or through the application site 41. This can provide a longer exposure time as discussed herein, and the length of the static surface 281 allows for a longer exposure time directly at the exposure site 51 and the application site 41. A focusing mechanism 66 may also be used in connection with the exposure device 50, and in the embodiment of FIGS. 68-71, the focusing mechanism 66 includes a plate lens 286 (or other block lens) mounted on a swivel 287 to permit the plate lens 286 to be angled as desired with respect to the projector 285. The focusing mechanism 66 may be used to refine, enlarge, or reduce the image 275 in various embodiments. The plate lens 286 may be replaced by a mirror arrangement including one or more mirrors, in another embodiment.

In one embodiment, where the exposure device 50 includes a projector 285, the plate lens 266 and the swivel 287 are used together to momentarily stop the movement of the image 275 on the flowable material 36, from exposure frame to exposure frame, as described above with respect to FIGS. 65-67. The plate lens 266 moves the image 275 at appropriate times to ensure accurate and thorough exposure and the desired amount of refraction, depending angle of the image 275 relative to the projector 285. For example, in one configuration, the plate lens 266 can spin to cause the image 275 to strobe at precisely the correct time for exposure. As another example, the plate lens 266 can slowly tilt to track the movement of the carriage 32 for a sufficient exposure time, while the projector 285 continuously projects a frame of the image 275, after which the plate lens 266 resets to project the next frame of the image 275. The image 275 can therefore be projected as a sequence of bordering frames that extend the entire width of the exposure and are arranged in sequence along the movement direction of the exposure device 50. Both of these methods of operating the plate lens 266 are configured to be in sync with the movement of the exposure device 50. These techniques for operation of the plate lens 266 can avoid “sliding” of the image 275 with respect to the surface of the flowable material 36, which results in blurring. In a further embodiment, the exposure device 50 may be different, such as an LED array or a laser as described herein.

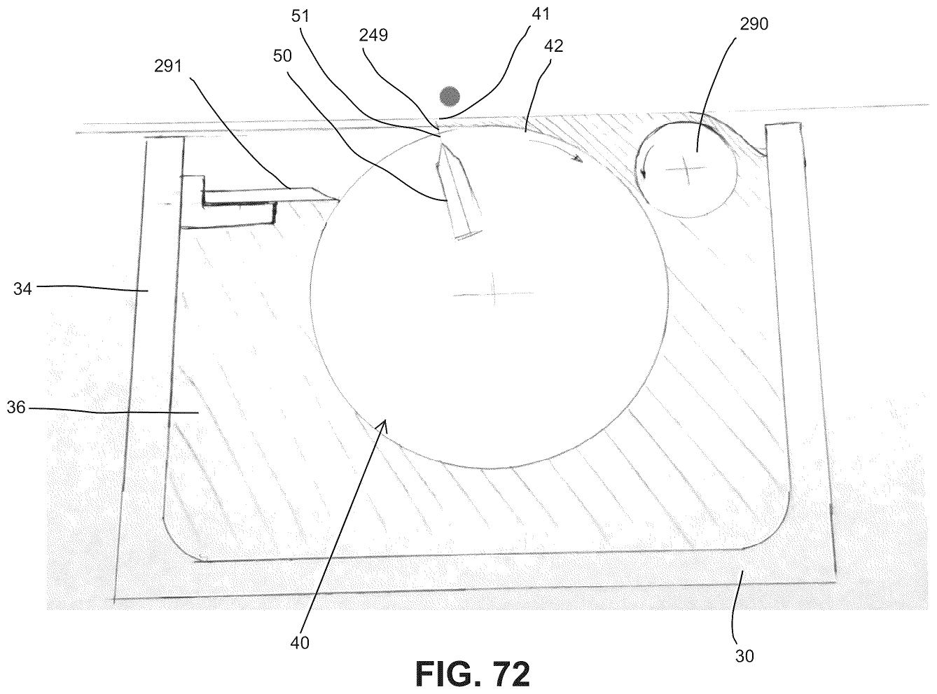

FIG. 72 illustrates another embodiment of a deposition mechanism 30 that uses an applicator 40 in the form of a roller 42 and an exposure device 50 as shown in FIGS. 29-37, but which may use other applicators 40 and/or exposure devices 50 disclosed herein. In this embodiment, the deposition mechanism 30 includes a feed drum 290 located in advance of the application site 41 in the direction of travel of the deposition mechanism 30. The feed drum 290 is configured to rotate such that the top of the feed drum 290 is traveling toward the roller 42, and in this embodiment, the roller 42 is configured to rotate in the opposite of the direction of travel of the deposition mechanism. In this configuration, the feed drum 290 and the roller 42 cause a buildup of flowable material 36 in advance of the roller 42 and between the roller 42 and the object 11 and/or the build platform 22, as seen in FIG. 72. This built-up flowable material 36 is then exposed by the exposure device 50 to build the object 11. The exposure device 50 may be directed such that the exposure site 51 slightly trails the apex of the roller 42 in one embodiment, as also shown in FIG. 72. In this configuration, an air gap 249 exists between the surface of the roller 42 and the flowable material 36, which reduces the chance of a build failure due to failure of a cured layer 38 to separate from the roller 42. The roller 42 also has a wiper 291 or other material removal member located on the opposite side from the feed drum 290, to prevent flowable material 36 from being carried from the opposite side to the application site 41 due to rotation of the roller 42.

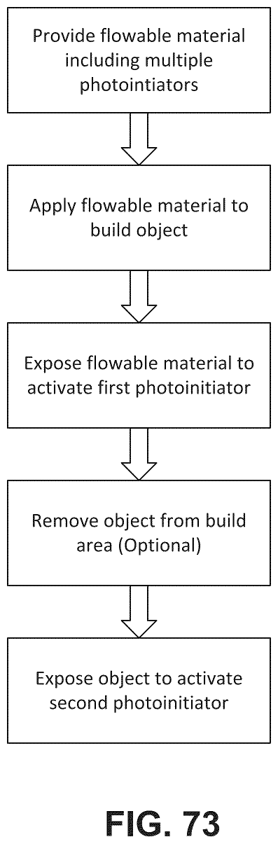

In one embodiment, the various embodiments of systems 10 and deposition mechanisms 30 described herein may be used in a method of producing an object 11 that utilizes a flowable material 36 in the form of a resin or mix of resins that can be partially solidified under first specified conditions and fully solidified under additional specified conditions. For example, the flowable material 36 may contain multiple photoinitiators that are activated under different conditions, such as by using different wavelengths of light or other energy. One embodiment of such a method 1000 is shown in FIG. 73, where a flowable material containing multiple photoinitiators is provided at step 1001, and the flowable material is applied to build an object at step 1002. During building, the flowable material 11 is exposed to conditions (e.g., a specified wavelength of light or other waves) sufficient to activate a first photoinitiator in the flowable material, at step 1003. This results in adherence of the layers of the flowable material to build the object, such that the object is partially solidified. The object may then optionally be removed from the build area at step 1004, as activation of the first photoinitiator may provide the object with sufficient strength to be moved and to support its own weight. At a later time, the object is exposed to conditions sufficient to activate the second photoinitiator and further (e.g., completely) solidify the object, at step 1005. This exposure may be done by exposing the entire object, or a plurality of objects, to the appropriate conditions for activation of the second photoinitiator, e.g., a bath of light or other waves having the desired wavelength to activate the second photoinitiator. This may be done while the object(s) 11 is/are still on the build platform 22 (e.g., as in FIGS. 11-12), or after removal of the object(s) 11. Exposure to activate the second photoinitiator may further include application of heat, chemical agents, or other conditions in addition to, or instead of, the application of waves as described herein. For example, one or more objects 11 may be placed in an oven to activate the second photoinitiator. In another embodiment, the activation of the second photoinitiator may be performed by a secondary exposure device 80 on the deposition mechanism 30, e.g., as shown in FIG. 4.

Additionally, in an alternate embodiment, the flowable material may include one or more photoinitiators that are activated to partially solidify the object (e.g., at step 1003), and the conditions to further or fully solidify the object may not be based on activation of an additional photoinitiator. For example, the full solidification may be performed by exposure to conditions such as heat, chemical agents, etc., that solidify the object without the use of a photoinitiator. It is understood that the flowable material 36 may include a catalyst or other chemical to aid such solidification. The second exposure may also be optional in a further embodiment. For example, the object may be provided to a consumer or other purchaser after solidification by activation of the first photoinitiator, and the purchaser may be given the option whether to activate the second photoinitiator along with information specifying how to do so. It is understood that more than two photoinitiators may be used in a further embodiment, and complete solidification of the object may require exposure to three or more different activation conditions.

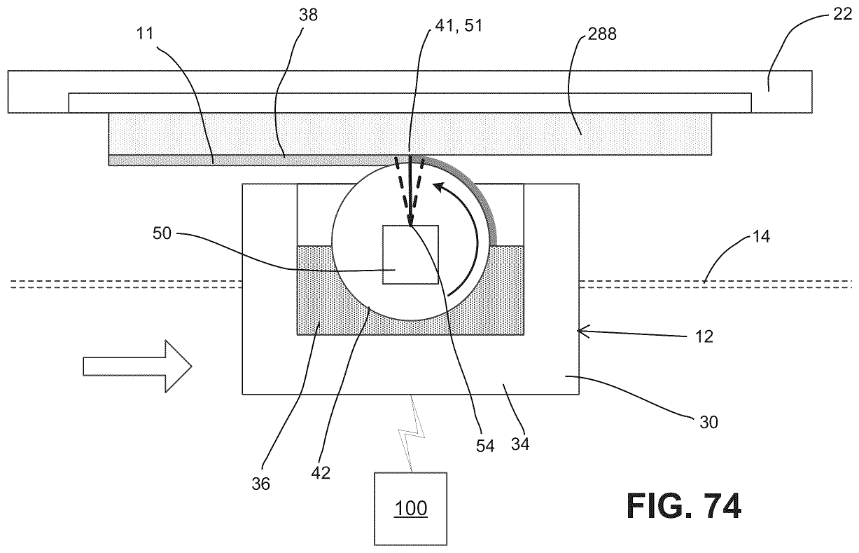

In one embodiment, illustrated schematically in FIG. 74, the various embodiments of systems 10 and deposition mechanisms 30 described herein may be used in a method of producing an object 11 that includes depositing layers 38 of material on a preexisting material 288 that forms part of the final object 11. The preexisting material 288 may be produced separately from the object 11, either by a different technique or by a similar technique, and may be formed of a different material or the same material. In the embodiment shown in FIG. 74, the preexisting material 288 is mounted on the build platform 22, but may be supported in another manner in another embodiment, such as by a clamping or other mechanical holding/locking arrangement, magnets, vacuum suction, or other techniques. It is understood that multiple articles of the preexisting material 288 may be used in one embodiment, such that the deposition mechanism 30 can deposit one or more layers 38 of material on the various articles of preexisting material 288 simultaneously and/or consecutively as described herein. This method may be used in many different applications, including depositing functional and/or ornamental components on an existing article. As one example, a conductive resin may be used as the flowable material 36, for depositing conductive components on a preexisting material 288 with low conductivity. As another example, the deposition mechanism 30 may be used to form the object 11 on various types of materials, such as metals, fabrics, or composites. As a further example, the deposition mechanism 30 may be configured for depositing layers 38 of the material 36 on a composite preform. As yet another example, the deposition mechanism 30 may be configured for depositing the material 36 on wires or other conductors. Still further examples include creating gaskets or other seals on connection parts, creating a logo that is integrally formed with the product, adding communicative indicia such as instructions (alphanumeric, diagrams, braille, etc.), or creating designated high-grip areas on a product created in another process. Still other applications are recognizable to those skilled in the art.

In another embodiment, the various embodiments of systems 10 and deposition mechanisms 30 described herein may be used in a method of producing an object 11 that includes a biological material, such as stem cells or specialized cells from a human, plant, animal, etc. The deposition mechanism 30 may utilize a flowable material 36 that includes a mixture of the biological material and a water-soluble binder and/or photoinitiator. An object 11 can be produced using this flowable material 36 and solidified by exposure to appropriate conditions (e.g., light having a specified wavelength) as described herein, and then the binder and/or photoinitiator can be removed by application of water to dissolve such components. This leaves behind the biological material to form the resultant object 11. One example of an application of this technology is manufacturing organs or tissues for grafting, implantation, etc. (e.g., skin), although those skilled in the art would readily recognize additional applications.

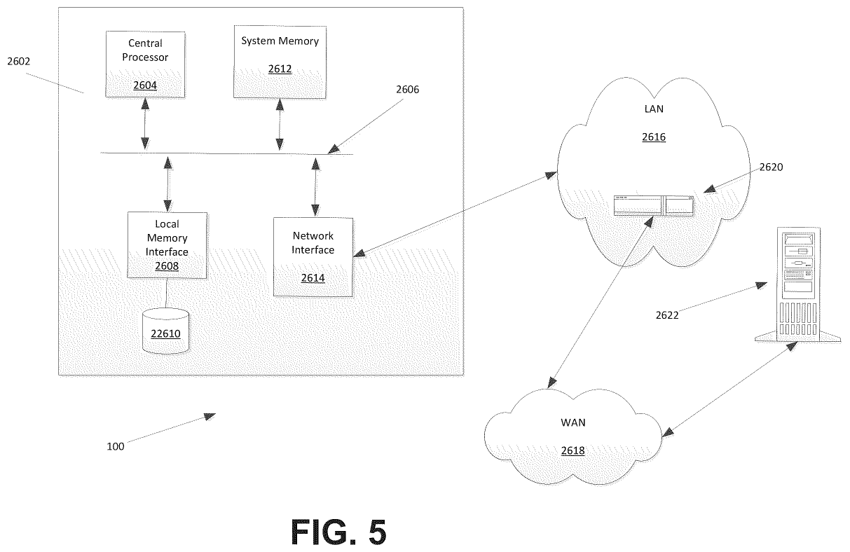

The system 10 may also include a controller 100 that is configured to control and/or monitor the operation of one or more mechanisms of the apparatus 12, including numerous examples described herein. FIG. 5 illustrates one embodiment of a controller 100 that is implemented with a computer system, such as computer 2602. Computer 2602 includes a central processor 2604 that controls the overall operation of the computer and a system bus 2606 that connects central processor 210 to the components described below. System bus 2606 may be implemented with any one of a variety of conventional bus architectures.

Computer 2602 may include a variety of interface units and drives for reading and writing data or files. For example, computer 2602 may include a memory interface 2608 coupling a memory drive 2610 to system bus 2606. Memory drive 2610 may be implemented with physical memory device, magnetic memory device, optical memory device or other type of memory device. Memory drive 2610 may store data, CAD files, and other electronic files that are used to produce three-dimensional objects as described herein. A system memory 2612 may be included and implemented with a conventional computer readable medium memory having a read only memory section that stores a basic input/output system (BIOS) and a random access memory (RAM) that stores other data and files. Memory drive 2610 and system memory 2612 may both contain computer-executable instructions designed to be executed by processor 2604. In some embodiments, one or more control programs for operating one or more apparatuses 12 and/or multiple components (e.g., multiple deposition mechanisms 30) within each apparatus 12 may be stored in memory drive 2610 and/or system memory 2612.

Computer 2602 may include additional interfaces for connecting peripheral devices to system bus 2606. For example, computer 2602 may also include a network interface 2614 that couples system bus 2602 to local area network (LAN) 2616. LAN 2616 may have one or more of the well-known LAN topologies and may use a variety of different protocols, such as Ethernet. A wide area network (WAN) 2618, such as the Internet, may also be accessed by computer 2602. FIG. 26 shows a router 2620 that may connect LAN 2616 to WAN 2618 in a conventional manner. A server 2622 is shown connected to WAN 204. Of course, numerous additional servers, computers, handheld devices, personal digital assistants, telephones and other devices may also be connected to WAN 2618. In some embodiments, server 2622 stores data, CAD files, control programs and/or other electronic files that may be accessed by computer 2602 and used to produce three-dimensional objects as described herein.

Various embodiments are described herein with various combinations of features and components. It is understood that the features and components of each of the various embodiments described herein may be incorporated into other embodiments described herein.

The use of the system and apparatus described herein provides benefits and advantages over existing technology. For example, consumable cost is greatly decreased, as the apparatus generates little waste and does not require maintaining a large vat of material to be solidified for manufacturing, as do many current technologies. Additionally, the structure of the apparatus does not dictate any specific size limits, and the apparatus may be configured to create an object that is significantly larger than existing technologies. The length of the track and the width of the applicator can be increased as desired without negatively affecting performance, and the size of the room in which the apparatus sits becomes the limit of the size of the apparatus. Further, the apparatus may be configured for manufacturing an object or multiple objects many times faster than any existing technology. The apparatus also provides the ability to manufacture objects from multiple materials, including objects that have removable support structure that is made from a material different from that of the main object. Production of objects from multiple materials that require different exposure sources is enabled as well. The apparatus further provides the ability to manufacture functional objects, such as a window or other transparent object, or a conductive object. Still further, objects manufactured using the apparatus described herein may not require draining liquid material from any internal cavities of the finished object, which may require drilling a hole for drainage. The apparatus is also capable of producing clean, dry, and fully-cured objects, which increases production efficiency. The modular configuration of the apparatus also great versatility, customizability, and other benefits.

Additional advantages are provided by the configuration of the deposition mechanism 30 as an autonomous unit 90 with a vertical adjustment mechanism 120, in combination with a track 14 that can be engaged and disengaged by the unit 90 and a build platform 22 associated with the track 14 and configured for manufacturing of an object 11 in a downward layer-by-layer technique. This configuration permits multiple deposition mechanisms 30 to operate on the same track 14 to apply multiple layers to one or more objects 11 simultaneously. Multiple deposition mechanisms 30 operating on the same track 14 may combine to build one or more objects 11 or may build multiple objects 11 separately and simultaneously on the same build platform 22. This configuration also enables building multiple objects of the same or different materials in separate locations on the same build platform 22 in a rapid manner. This configuration also facilitates maintenance of the deposition mechanism 30, as an autonomous unit 90 can be removed from the production process for maintenance quickly and easily, and may also be quickly and easily replaced with another unit 90 to achieve substantially uninterrupted production. A system including multiple such units 90 can operate with a number of different build platforms 22, such as in a large production facility, where the units 90 can be assigned and re-assigned to specific build areas 13 as needed for optimized production. Still other benefits and advantages over existing technology are provided by the systems, apparatuses, and methods described herein, and those skilled in the art will recognize such benefits and advantages.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. The terms “first,” “second,” “top,” “bottom,” etc., as used herein, are intended for illustrative purposes only and do not limit the embodiments in any way. In particular, these terms do not imply any order or position of the components modified by such terms. Additionally, the term “plurality,” as used herein, indicates any number greater than one, either disjunctively or conjunctively, as necessary, up to an infinite number. Further, “providing” an article or apparatus, as used herein, refers broadly to making the article available or accessible for future actions to be performed on the article, and does not connote that the party providing the article has manufactured, produced, or supplied the article or that the party providing the article has ownership or control of the article. Accordingly, while specific embodiments have been illustrated and described, numerous modifications come to mind without significantly departing from the spirit of the invention.

What is claimed is:

1. A deposition mechanism configured for producing a three-dimensional object on a build platform using a resin in a layer-by-layer technique, with a build area defined adjacent to the build platform, the deposition mechanism comprising:
a carriage configured for movement through the build area;
a supply of the resin in flowable form mounted on the carriage;
a carrying surface configured for moving to carry the resin from the supply to an application site within the build area for application to produce the three-dimensional object as the carriage passes through the build area; and
a flexible screen positioned below the carrying surface, such that the carrying surface overlays the flexible screen, and the flexible screen and the carrying surface have conforming shapes,
wherein the flexible screen is configured for emitting electromagnetic waves, and the carrying surface is permeable to the electromagnetic waves to permit the electromagnetic waves to at least partially solidify the resin applied by the carrying surface to produce the three-dimensional object.

2. The deposition mechanism of claim 1, wherein the carrying surface is a roller having a circular outer surface and configured to rotate to carry the resin from the supply to the application site.

3. The deposition mechanism of claim 2, wherein the flexible screen is positioned within the roller and extends around a portion of an inner circumference of the roller.

4. The deposition mechanism of claim 1, wherein the flexible screen is configured for emitting the electromagnetic waves to form an image that travels along the flexible screen at a speed of movement of the carrying surface, to continuously expose a portion of the resin on the carrying surface for at least part of a distance between the supply and the application site.

5. The deposition mechanism of claim 3, wherein the flexible screen is configured for continuously exposing the portion of the resin on the carrying surface for an entirety of the distance between the supply and the application site.

6. The deposition mechanism of claim 3, wherein the flexible screen is configured for varying a power of the electromagnetic waves forming the image as the image approaches the application site.

7. The deposition mechanism of claim 1, wherein the carrying surface is a film configured to move along a loop through the build area, wherein the flexible screen is positioned on a static surface located adjacent to the application site, and wherein the film passes over the flexible screen at the application site.

8. A deposition mechanism configured for producing a three-dimensional object on a build platform using a resin in a layer-by-layer technique, with a build area defined adjacent to the build platform, the deposition mechanism comprising:
a carriage configured for movement through the build area;
a supply of the resin in flowable form mounted on the carriage; and
a carrying surface comprising a flexible screen configured for moving to carry the resin on an outer surface of the flexible screen from the supply to an application site within the build area for application to produce the three-dimensional object as the carriage passes through the build area,
wherein the flexible screen is configured for emitting electromagnetic waves to at least partially solidify the resin applied by the carrying surface to produce the three-dimensional object.

9. The deposition mechanism of claim 8, wherein the carrying surface is a roller having a cylindrical shape and configured to rotate to carry the resin from the supply to the application site.

10. The deposition mechanism of claim 9, wherein the carrying surface further comprises a plurality of flexible screens, including the flexible screen, positioned around a circumference of the roller, wherein the outer surfaces of the plurality of flexible screens combine to form the carrying surface, and wherein each of the flexible screens is configured for emitting electromagnetic waves to at least partially solidify the resin applied by the carrying surface to produce the three-dimensional object.

11. The deposition mechanism of claim 10, wherein the flexible screens are arranged end-to-end around the carrying surface.

12. The deposition mechanism of claim 9, further comprising a rotatable cylinder, wherein the flexible screen is mounted on the rotatable cylinder and conforms to an external shape of the rotatable cylinder.

13. The deposition mechanism of claim 8, wherein the flexible screen is configured for emitting the electromagnetic waves to form an image that is static on the flexible screen as the outer surface of the flexible screen carries the resin to the application site, to continuously expose a portion of the resin on the outer surface for at least part of a distance between the supply and the application site.

14. The deposition mechanism of claim 13, wherein the flexible screen is configured for continuously exposing the portion of the resin on the carrying surface for an entirety of the distance between the supply and the application site.

15. The deposition mechanism of claim 13, wherein the flexible screen is configured for varying a power of the electromagnetic waves forming the image as the image approaches the application site.

16. The deposition mechanism of claim 8, wherein the carrying surface is a belt configured to move along a loop through the build area.

17. The deposition mechanism of claim 8, wherein the carrying surface is a roller having a polygonal shape with at least three substantially flat sides, wherein the roller is configured to rotate to carry the resin from the supply to the application site.

18. The deposition mechanism of claim 8, wherein the flexible screen has a thin coating on the outer surface thereof, the thin coating adding a functional property to the carrying surface.

19. An applicator configured for applying a resin to produce a three-dimensional object on a build platform in a layer-by-layer technique, with a build area defined adjacent to the build platform, the applicator comprising:
a carrying surface configured to be in communication with a supply of the resin, the carrying surface comprising a flexible screen configured for moving to carry the resin on an outer surface of the flexible screen from the supply to an application site within the build area for application to produce the three-dimensional object,
wherein the flexible screen is configured for emitting electromagnetic waves to at least partially solidify the resin applied by the carrying surface to produce the three-dimensional object.

20. An applicator configured for applying a resin to produce a three-dimensional object on a build platform in a layer-by-layer technique, with a build area defined adjacent to the build platform, the applicator comprising:
a carrying surface configured to be in communication with a supply of the resin and configured for moving to carry the resin from the supply to an application site within the build area for application to produce the three-dimensional object; and
a flexible screen positioned below the carrying surface, such that the carrying surface overlays the flexible screen, and the flexible screen and the carrying surface have conforming shapes,
wherein the flexible screen is configured for emitting electromagnetic waves, and the carrying surface is permeable to the electromagnetic waves to permit the electromagnetic waves to at least partially solidify the resin applied by the carrying surface to produce the three-dimensional object.
